(19) United States
(12) Patent Application Publication
(10) Pub. No.: US 2016/0235062 A1
(43) Pub. Date: Aug. 18, 2016

(54) COPOLYMERS AND COMPOSITIONS WITH ANTI-ADHESIVE AND ANTIMICROBIAL PROPERTIES

(71) Applicant: BASF SE, Ludwigshafen (DE)

(72) Inventors: Hermann BERGMANN, Osnabrück (DE); Rupert KONRADI, Ladenburg (DE); Stephan SAUM, Speyer (DE); Stefan BECKER, Seoul (KR); Catharina WOHLMUTH, Mannheim (DE); Anuradha AKELLA, Singapore (SG); Jia Le LOW, Singapore (SG); Lee May LOO, Masai (MY); Herbert PLATSCH, Mannheim (DE)

(21) Appl. No.: 15/030,463

(22) PCT Filed: Oct. 9, 2014
(86) PCT No.: PCT/EP2014/071632

§ 371 Date: Apr. 19, 2016

(30) Foreign Application Priority Data
Oct. 21, 2013 (EP) 13189575.7

(51) Int. Cl. A01N 43/36; C08F 226/10

(52) U.S. Cl. CPC A01N 43/36; C08F 226/10

(57) ABSTRACT

The invention relates to a copolymer exhibiting both antimicrobial and anti-adhesive properties as well as to a hydrogel. Said hydrogel is obtained from the inventive copolymer and a substrate. Another part of the invention is a process for making the hydrogel, as well as different uses of the inventive copolymer as well as of the hydrogel.

The invention relates to copolymers having antimicrobial and anti-adhesive properties as well as to preparations of said copolymers. Another aspect of the invention is a hydrogel made of these copolymers or copolymer preparations and a process of making same.

It is known that homo-polymers comprising cationic groups or complexes of said polymers with silver ions exhibit anti-microbial properties. However, such properties are still to be improved in order to further reduce the amount of microorganisms colonizing on surfaces or the formation of biofilms out of those microorganisms.

Copolymers consisting of N-vinyl-2-pyrrolidone (VP) and 2-(dimethylamino)ethyl methacrylate quaternized with octyl bromide are known from Deboudt et al. Macromol. Chem. Phys. 196, 291-302 (1995). However, neither quaternized monomers per se are used for polymerization nor a quantitative quaternization of the copolymer obtained is achieved (cf. tables 2 and 3). Thus still polymerized 2-(dimethylamino)ethyl methacrylate in non-quaternized form is present in the copolymer, viz. an entity resulting from a radically polymerizable α.β-ethylenically unsaturated double bond and at least one cationogenic moiety, said cationogenic moiety bearing only terminal N-alkyl chains comprising less than 3 carbon atoms. However, such kind of polymerized molecule would reduce the copolymer's ability to simultaneously act as anti-adhesive and antimicrobial means.

WO 2000/68282 A1 of Jachowicz discloses conditioning and styling terpolymers consisting of N-viny-2-pyrrolidone (VP), dimethylaminopropyl methacrylamide (DMAPMAM) and C₉-C₂₄ alkyl dimethylaminopropylmethacrylic acid quaternized monomers (QDMAPMA). In the detailed description thereof on page 2 monomers Y are also mentioned to comprise residues R₃, R₄ to represent H or C₁-C₅-alkyl, viz. which are not DMAPAM or DMAPMAM. However, upon inspecting the whole disclosure and the claims of said document, no indication is given for monomers Y having residues R₃, R₄ with more than 5 carbon atoms nor is specified a weight percentage thereof. There is also no explanation on how the length of the alkyl chains of R₃, R₄ does interact with or relate to the amount of such monomer Y used, and which properties would thus result from a copolymer formed thereof. As can be gleaned from the examples as well as from claim 2 and the subsequent claims, the main focus as well as concentration ranges are only given for a terpolymer with X being N-vinyl-2-pyrrolidone (VP), Y being dimethylaminopropyl methacrylamide (DMAPMAM) and Z being a C₁₂-C₁₈ alkyl quaternized derivative of an acrylic acid. However, copolymers comprising besides N-vinyl-2-pyrrolidone (VP), as cationogenic moiety bearing monomer a monomer Y with a short terminal N-alkyl chain like methyl in DMAPMAM are less effective in simultaneously preventing microbial adhesion and acting as antimicrobial agent. Thus the embodiments of said disclosure cannot act as powerful antimicrobial and anti-adhesive means both per se and when applied to a substrate. In fact they are rather adapted to be employed in hair styling and/or hair conditioning compositions and are tailored for providing good mechanical properties to hair treated therewith. They are not shown and in fact are not adapted for effectively killing microorganisms as well as preventing them to colonize thereon or on a surface coated with or consisting of said copolymer of the prior art.

One object of the invention thus is to overcome the drawbacks of the prior art and to provide a copolymer being capable of providing (to a surface) anti-adhesive and antimicrobial properties at the same time. A further object of the invention is to provide a copolymer preparation comprising said characteristics of simultaneously providing anti-adhesive and antimicrobial properties (to surfaces). Yet another object of the invention is to bring up a hydrogel having the properties of preventing microorganisms to stick to it simultaneously by means of antimicrobial action as well as by means of anti-adhesive action. Yet another object of the invention is to give a process of making said hydrogel. Finally different uses of such copolymer, copolymer preparation and hydrogel are claimed, which are also meant to be understood as different methods of applying said copolymer, copolymer preparation or hydrogel in distinct therapeutic or non-therapeutic fields.

All these objects are met by a copolymer with antimicrobial properties comprising 60 to 98 w % of at least one water-soluble monomer selected from the group consisting of cyclic N-vinyl amides, N-vinyl imidazoles, (meth)acrylic esters containing CH₂—CH₂—O— units and/or CH₂—CH(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 3, and said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

In fact during thorough analyses it was determined that the length of the terminal N-alkyl chain of monomer B is crucial to convey to the copolymer the ability to likewise act as antimicrobial as well as ant-adhesive means. However this alone will not be sufficient, since such ability can only be achieved if monomer B is used in an appropriate concentration as claimed. This is to say one can only come to a copolymer having both antimicrobial as well as anti-adhesive properties under the condition of having an appropriate type of monomer B and this monomer B to be used in an appropriate concentration.

If not obeying to the claimed conditions viz. by e.g. increasing the amount of monomer B and/or by not respecting the number of carbons of the terminal N-alkyl chain, one would either come to a copolymer which only exhibits an antimicrobial activity or only shows an anti-adhesive character as will be further detailed below. The degree of lowering antimicrobial or anti-adhesive properties while maintaining the other one or even both depends on how much one deviates from the embodiments as claimed.

“Anti-adhesive” means that the copolymer of the invention per se or when attached to a surface either by coating or by means of covalent bonding will show a character such that microorganisms as well as cells and cell aggregates like for instance platelets cannot stick to it or to the surface treated therewith or to the hydrogel formed therefrom (on a surface) but will rather slip away.

“Antimicrobial” means a characteristic which serves to at least stop proliferation of microorganisms and more preferably is understood to kill microorganisms coming into contact with embodiments of the invention exhibiting said antimicrobial property, i.e. with said copolymer, copolymer preparation or hydrogel of the invention.

A “hydrogel” is a water-containing, but water-insoluble polymer said polymer being optionally connected to a substrate. The hydrogel is a network of hydrophilic polymer chains in which water is the dispersion medium. Hydrogels are highly absorbent (they can contain over 99.9% water), which, due to their significant water content, generally possess a high degree of flexibility very similar to natural tissue.

“Terminal N-alkyl chain” within the scope of the invention means any alkyl chain of monomer B, which is connected to the terminal amine nitrogen of said monomer and will not have any further atom to be connected to. Thus for instance only the methyl groups in dimethylaminopropyl-methacrylamide (DMAPMAM) are considered to be terminal N-alkyl chains, but not the —CH₂—CH₂—CH₂-group making the bridge between the amide group and the amine group of DMAPMAM. The “terminal N-alkyl chain” also referred to as “C6-C22-alkyl”, “C6- to C22-alkylated” comprises “6 to 22 carbon atoms”, which is to say includes the entities n-hexyl or n-capryl, n-heptyl or n-oenanthyl, n-octyl or n-caprylyl, n-nonyl or n-pelargonyl, n-decyl or n-capryl, n-undecyl, n-dodecyl or n-lauryl, n-tridecyl, n-tetradecyl or n-myristyl, n-pentadecyl, n-hexadecyl or n-palmityl, n-heptadecyl or n-margaryl, n-octadecyl or n-stearyl, n-nonadecyl, n-eichosanyl or n-arachidyl, n-uneichosanyl having 21 carbon atoms, n-docosanyl or n-beheyl and their respective branched isomers. Consequently “C6- to C22-dialkylated” is to say that two of the previously given entities in whatever combination are connected to one atom, preferably to one nitrogen atom.

The term “cationic” within this disclosure is understood to cover any cationic entity irrespective of the type of cation to be considered. Thus “cationic” likewise comprises a positively charged entity obtained by alkylation as well as by protonation.

“Cationogenic” stands for any compound adapted to be converted into a cation by whatever means, either by alkylation or by protonation.

Contrary to that the term “quaternized” is considered to describe any positively charged compound obtained by alkylation only, not by protonation.

A non-quaternized compound within this disclosure may have no charge or is positively charged. For the latter this would mean the positive charge was obtained by means of protonation only, not by alkylation. The former would be any compound suited for being transformed into a cationic entity by means of alkylation or protonotion.

The term “(meth)acryl” or “(meth)acrylic”, when written in parenthesis is construed to be understood as meaning “methacryl” or “methacrylic” as well as “acryl” or “acrylic”. Parentheses are omitted in case “methacryl” or “methacrylic” is literally meant. “acryl” or “acrylic” is referred to meaning the proton-missing form of acrylic acid if not expressively differently stated.

Cyclic N-vinyl amides are any α,β-ethylenically unsaturated amides having a cyclic amide entity. In particular they are understood to have the following structure:

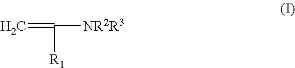

with R¹ being H, or C₁-C₄-alkyl and R², R³ together with the N-atom, they are connected to, form a 4 to 8 membered heterocycle, comprising a carbonyl group in α-position to the N-atom.

In particular said N-vinyl amide is selected from the group comprising, preferably consisting of N-vinyl-2-pyrrolidone, N-vinyl caprolactam, N-(4-morpholinyl)(meth)acrylamid, N-(4-morpholinyl)acrylamid, N-vinyl piperidone, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam.

N-vinyl imidazoles of the invention are α,β-ethylenically unsaturated nitrogen hetero cycles comprising two nitrogens and ring alkylated derivatives thereof. These entities are used in neutral, cationized or even quaternized form. The N-vinyl imidazoles are selected from the group consisting of the entity

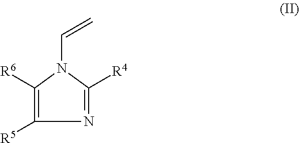

with R⁴, R⁵ and R⁶ being hydrogen, C₁-C₄-alkyl or phenyl.

In a preferred embodiment they are selected from the group of formula (II) however, with R⁴, R⁵ and R⁶ having the meaning as indicated in the table infra.

| R⁴ | R⁵ | R⁶ |
|---|---|---|
| H | H | H |
| Me | H | H |
| H | Me | H |
| H | H | Me |
| Me | Me | H |
| H | Me | Me |
| Me | H | Me |
| Ph | H | H |
| H | Ph | H |
| H | H | Ph |
| Ph | Me | H |
| Ph | H | Me |
| Me | Ph | H |
| H | Ph | Me |
| H | Me | Ph |
| Me | H | Ph |

Me = methyl
Ph = phenyl

Among those, particular N-vinyl imidazoles are selected from the group consisting of N-vinyl imidazoles with R⁴, R⁵ and R⁶ representing H only or at least one methyl group. Highly preferred are those with R⁴, R⁵ and R⁶ representing H or H and only one methyl group.

(Meth)acrylic esters containing CH₂—CH₂—O— or CH₂—CH—(CH₃)—O— units of the invention are such α,β-ethylenically unsaturated molecules, which comprise an ester moiety a part of which is a CH₂—CH₂—O— or a CH₂—CH—(CH₃)—O— entity. Said ester moiety is connected to an α,β-ethylenically unsaturated monocarboxylic acid selected from the group consisting of acrylic acid and methacrylic acid.

CH₂—CH₂—O— or CH₂—CH—(CH₃)—O units generally stem from polyetherols or from monoalkylated polyetherols. Suitable polyetherols are linear or branched substances having terminal hydroxyl groups and comprising ether bonds. In general, they have a molecular weight in the range from about 150 to 20000. Suitable polyetherols are polyalkylene glycols, selected from the group of polyethylene glycols, polypropylene glycols, polytetrahydrofurans and alkylene oxide polymers or copolymers. Suitable alkylene oxides for preparing alkylene oxide polymers or copolymers are, ethylene oxide, propylene oxide, epichlorohydrin, 1,2- and 2,3-butylene oxide. The alkylene oxide copolymers comprise the copolymerized alkylene oxide units in random distribution or in the form of blocks. Preference is given to ethylene oxide/propylene oxide copolymers.

In a preferred embodiment of the invention (meth)acrylic esters containing CH₂—CH₂—O— or CH₂—CH—(CH₃)—O— units are selected from the group of polyether acrylates of the general formula

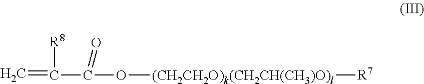

with the order of the alkylene oxide units, viz. the CH₂—CH₂—O— and/or CH₂—CH—(CH₃)—O units being arbitrary,
k and l, independently of one another, being an integer from 0 to 1000, the sum of k and l being at least 5,
R⁷ being hydrogen, C₁-C₃₀-alkyl or C₅-C₈-cycloalkyl,
R⁸ being hydrogen or C₁-C₂₀-alkyl, preferably hydrogen or C₁-C₈-alkyl.

Further preferred (meth)acrylic esters containing CH₂—CH₂—O— or CH₂—CH—(CH₃)—O— units of formula (III) are those with
k being an integer from 1 to 500, in particular from 3 to 250,
l being an integer from 0 to 100,
R⁸ being hydrogen, methyl, ethyl, n-propyl, isopropyl, n-butyl, sec-butyl, tert-butyl, n-pentyl or n-hexyl, in particular hydrogen, methyl or ethyl,
R⁷ being hydrogen, methyl, ethyl, n-propyl, isopropyl, n-butyl, sec-butyl, n-pentyl, n-hexyl, octyl, 2-ethylhexyl, decyl, lauryl, palmityl or stearyl.

Even more preferred are those (meth)acrylic esters containing CH₂—CH₂—O— or CH₂—CH—(CH₃)—O— units of formula (III) with
k being an integer from 1 to 100, in particular from 3 to 50,
l being an integer from 0 to 75, in particular from 0 to 25,
R⁸ being hydrogen, methyl, ethyl, n-propyl, isopropyl, n-butyl, sec-butyl, tert-butyl, n-pentyl or n-hexyl, in particular hydrogen, methyl or ethyl,
R⁷ being hydrogen, methyl, ethyl, n-propyl, isopropyl, n-butyl, sec-butyl, n-pentyl, n-hexyl, octyl, 2-ethylhexyl, decyl, lauryl, palmityl or stearyl.

Since the inventive copolymers are more effective, more they are slippery for microorganisms, this need is satisfied by rather hydrophilic entities, comprising (meth)acrylic esters containing CH₂—CH₂—O— or CH₂—CH—(CH₃)—O— as mentioned just before.

Suitable (meth)acrylic esters containing CH₂—CH₂—O— or CH₂—CH—(CH₃)—O— units are, for example, the polycondensation products of the above-mentioned α,β-ethylenically unsaturated monocarboxylic acids (in particular methacrylic acid or acrylic acid) or their respective acid chlorides, amides or anhydrides with polyetherols. Such polyetherols are to be prepared by reacting ethylene oxide, 1,2-propylene oxide and/or epichlorohydrin with a starter molecule, such as water or a short-chain alcohol R⁷—OH with R⁷ having the meaning given above. The alkylene oxides are to be used individually, alternately one after the other or as a mixture. The (meth)acrylic esters containing CH₂—CH₂—O— or CH₂—CH—(CH₃)—O— units are to be used on their own or in mixtures for preparing the copolymers according to the invention.

Hydroxy(meth)acrylates of the invention are the esters of (meth)acrylic acid which are selected from the group consisting of hydroxymethyl (meth)acrylate, hyroxyethyl (meth)acrylate, hydroxymethyl ethacrylate, hydroxy-n-propyl (meth)acrylate, hydroxy-isopropyl (meth)acrylate, hydroxy-n-butyl (meth)acrylate, hydroxy-tert-butyl (meth)acrylate, hydroxyisobutyl (meth)acrylate, hydroxy-sec-butyl (meth)acrylate, hydroxy-2-pentyl (meth)acrylate, hydroxy-3-pentyl (meth)acrylate, hydroxy-isopentyl (meth)acrylate, hydroxy-neopentyl (meth)acrylate, hydroxy-n-octyl (meth)acrylate, hydrox-1,1,3,3-tetramethylbutyl (meth)acrylate, hydroxy-ethylhexyl (meth)acrylate, hydroxy-n-nonyl (meth)acrylate, hydroxy-n-decyl (meth)acrylate, hydroxy-n-undecyl (meth)acrylate, hydroxy-tridecyl (meth)acrylate, hydroxy-myristyl (meth)acrylate, hydroxy-pentadecyl (meth)acrylate, hydroxy-palmityl (meth)acrylate, hydroxy-heptadecyl (meth)acrylate, hydroxy-nonadecyl (meth)acrylate, hydroxy-arrachinyl (meth)acrylate, hydroxybehenyl (meth)acrylate, hydroxy-lignocerenyl (meth)acrylate, hydroxy-cerotinyl (meth)acrylate, hydroxy-melissinyl (meth)acrylate, hydroxy-palmitoleinyl (meth)acrylate, hydroxy-oleyl (meth)acrylate, hydroxy-linolyl (meth)acrylate, hydroxy-linolenyl (meth)acrylate, hydroxy-stearyl (meth)acrylate, hydroxy-lauryl (meth)acrylate, hydroxy-phenoxyethyl (meth)acrylate, hydroxy-t-butylcyclohexyl (meth)acrylate, hydroxy-cyclohexyl (meth)acrylate, ureido (meth)acrylate, tetrahydrofurfuryl (meth)acrylate and mixtures thereof.

Preferred hydroxy(meth)acrylates of the invention are the esters of (meth)acrylic acid with C₁-C₄-alkanediols. These compounds are easily affordable and do not render the inventive copolymer to hydrophobic.

Monomer B of the invention is at least one compound comprising a radically polymerizable α.β-ethylenically unsaturated double bond and at least one cationic and/or cationogenic moiety with the cationic and/or cationogenic moiety thereof bearing at least one terminal N-alkyl chain comprising from 6 to 22 carbon atoms. Said monomer B is required to be used in an amount ranging from 2 w % to 25 w %, since only then, it is possible to convey to a copolymer formed therewith anti-adhesive and antimicrobial properties when applied onto a surface.

In a more restricted embodiment of the invention, still fitting with the inventive needs, monomer B is at least one compound comprising a radically polymerizable α.β-ethylenically unsaturated double bond and at least one cationic and/or cationogenic moiety with the cationic and/or cationogenic moiety thereof bearing at least one terminal N-alkyl chain comprising from 6 to 18 carbon atoms, and said monomer B being used in an amount ranging from 2 w % to 25 w %.

In a preferred embodiment of the invention monomer B is at least one compound comprising a radically polymerizable α.β-ethylenically unsaturated double bond and at least one cationic and/or cationogenic moiety, with the cationic and/or cationogenic moiety thereof bearing at least one terminal N-alkyl chain comprising from 6 to 22 carbon atoms, said cationic and/or cationogenic moiety being an amino group, and said monomer B being used in an amount ranging from 2 w % to 25 w %.

It is highly preferable to have the cationic and/or cationogenic moiety of monomer B to be an amino group, since those entities are likely to be readily protonated or even more preferably quaternized. Consequently α,β-ethylenically unsaturated amides without any other site to be readily cationized or quaternized as will be for instance an amino group, are not adapted for the use as monomer B.

Thus monomer B is at least one compound comprising a radically polymerizable α,β-ethylenically unsaturated double bond and at least one cationic and/or cationogenic moiety, with said cationic and/or cationogenic moiety being selected from the group consisting of a secondary or tertiary amino group or a quaternary ammonium group, said cationic and/or cationogenic moiety thereof bearing at least one terminal N-alkyl chain comprising from 6 to 22 carbon atoms and said monomer B being used in an amount ranging from 2 w % to 25 w %;

In a further defined embodiment said monomer B, viz. said at least one compound comprising a radically polymerizable α,β-ethylenically unsaturated double bond and at least one cationic and/or cationogenic moiety, with the cationic and/or cationogenic moiety thereof bearing at least one terminal N-alkyl chain comprising from 6 to 22 carbon atoms and being used in an amount ranging from 2 w % to 25 w %, is selected from the group consisting of esters of α.β-ethylenically unsaturated, mono- or dicarboxylic acids, with C2- to C12-aminoalcohols said C2- to C12-aminoalcohols being C6- to C22-alkylated on the terminal amine nitrogen.

C2- to C12-aminoalcohol means an aminoalcohol having a carbon backbone having from 2 carbon atoms to 12 carbon atoms. Preferably C2- to C12-aminoalcohol means a linear aminoalcohol having a carbon backbone having from 2 carbon atoms to 12 carbon atoms.

The term C6- to C22-alkylated means that at least one alkyl entity is connected to the terminal amine nitrogen said alkyl entity having a respective number of carbon atoms ranging from 6 to 22. Besides this at least one alkyl entity connected to the terminal amine nitrogen, said terminal nitrogen either bears protons or from 1 to 2 further C1- to C22-alkyl groups. The term C6- to C22-alkylated does not refer to the charge of monomer B, viz. said monomer B can be neutral or positively charged, as long as the other requirements of monomer B and the conditions of claim 1 are met.

Suitable α.β-ethylenically unsaturated mono- or dicarboxylic acids of these esters are selected from the group consisting of acrylic acid, methacrylic acid, ethacrylic acid, alpha-chloroacrylic acid, fumaric acid, maleic acid, itaconic acid, citraconic acid, mesaconic acid, glutaconic acid, aconitic acid, crotonic acid, maleic anhydride, monobutyl maleate and mixtures thereof. Preference is given to using acrylic acid, methacrylic acid and mixtures thereof.

In a somewhat preferred embodiment suitable monomers B are selected from the group consisting of esters of (meth)acrylic acid with C2- to C12-aminoalcohols said C2- to C12-aminoalcohols being C6- to C22-alkylated on the terminal amine nitrogen. Due to cost reasons it is still further preferred to select monomers B from the group consisting of esters of (meth)acrylic acid with linear C2- to C12-aminoalcohols said C2- to C12-aminoalcohols being C6- to C22-alkylated on the terminal amine nitrogen.

In a still further preferred inventive embodiment suitable monomers B are selected from the group consisting of esters of methacrylic acid with C2- to C12-aminoalcohols, preferably linear C2- to C12-aminoalcohols, said C2- to C12-aminoalcohols or linear C2- to C12-aminoalcohols being C6- to C22-alkylated on the amine nitrogen.

Highly preferred monomers B are selected from the group consisting of N,N-dimethylaminomethyl(meth)acrylate, N,N-dimethylaminoethyl(meth)acrylate, N,N-diethylaminomethyl(meth)acrylate, N,N-diethylaminoethyl(meth)acrylate, N,N-dimethylaminopropyl(meth)acrylate, N,N-diethylaminopropyl(meth)acrylate, N,N-dimethylaminobutyl(meth)acrylate, N,N-diethylaminobutyl(meth)acrylate, N,N dimethylaminocyclohexyl(meth)acrylate, N,N diethylaminocyclohexyl(meth)acrylate each of which respectively being quaternized at the terminal nitrogen by means of an-alkyl chain comprising from 6 to 22 carbon atoms or mixtures thereof.

Likewise highly preferred monomers B are selected from the group consisting of N,N-methyl,C6-C22-alkyl aminomethyl(meth)acrylate, N,N-methyl,C6-C22-alkyl aminoethyl(meth)acrylate, N,N-ethyl,C6-C22-alkyl aminomethyl(meth)acrylate, N,N-ethyl,C6-C22-alkyl aminoethyl(meth)acrylate, N,N-methyl,C6-C22-alkyl aminopropyl(meth)acrylate, N,N-ethyl,C6-C22-alkyl aminopropyl(meth)acrylate, N,N-methyl,C6-C22-alkyl aminobutyl(meth)acrylate, N,N-ethyl,C6-C22-alkyl aminobutyl(meth)acrylate, N,N methyl,C6-C22-alkyl aminocyclohexyl(meth)acrylate, N,N ethyl,C6-C22-alkyl aminocyclohexyl(meth)acrylate, each of which respectively being uncharged or quaternized at the terminal nitrogen by means of an-alkyl chain comprising from 6 to 22 carbon atoms or mixtures thereof.

Among those highly preferred monomers B, even more preference is given to using N,N dimethylaminoethyl(meth)acrylate or N,N-dimethylaminopropyl(meth)acrylate, each of which respectively being quaternized by means of a terminal N-alkyl chain comprising from 6 to 22 carbon atoms or mixtures thereof. Said high preference results from the ease of availability as well as their relatively low price.

In another very important embodiment said monomer B, viz. said at least one compound comprising a radically polymerizable α,β-ethylenically unsaturated double bond and at least one cationic and/or cationogenic moiety, with the cationic and/or cationogenic moiety thereof bearing at least one terminal N-alkyl chain comprising from 6 to 22 carbon atoms and being used in an amount ranging from 2 w % to 25 w %, is selected from the group consisting of amides of α.β-ethylenically unsaturated, mono- or dicarboxylic acids, with C2- to C12-diamines said C2- to C12-diamines being C6- to C22-alkylated on the terminal amine nitrogen. C2- to C12-diamine means a diamine having a carbon backbone having from 2 carbon atoms to 12 carbon atoms. Preferably C2- to C12-diamine means a linear diamine having a carbon backbone having from 2 carbon atoms to 12 carbon atoms.

The term C6- to C22-alkylated means that at least one alkyl entity is connected to the terminal amine nitrogen said alkyl entity having a respective number of carbon atoms ranging from 6 to 22. Besides this at least one alkyl entity connected to the terminal amine nitrogen, said terminal nitrogen either bears protons or from 1 to 2 further C1- to C22-alkyl groups. The term C6- to C22-alkylated does not refer to the charge of monomer B, viz. said monomer B can be neutral or positively charged, as long as the other requirements of monomer B and the conditions of claim 1 are met.

Suitable α.β-ethylenically unsaturated mono- or dicarboxylic acids of these amides are selected from the group consisting of acrylic acid, methacrylic acid, ethacrylic acid, alpha-chloroacrylic acid, fumaric acid, maleic acid, itaconic acid, citraconic acid, mesaconic acid, glutaconic acid, aconitic acid, crotonic acid, maleic anhydride, monobutyl maleate and mixtures thereof. Preference is given to using acrylic acid, methacrylic acid and mixtures thereof.

In a somewhat preferred embodiment suitable monomers B are selected from the group consisting of amides of (meth)acrylic acid with C2- to C12-diamines said C2- to C12-diamines being C6- to C22-alkylated on the terminal amine nitrogen. Due to cost reasons it is still further preferred to select monomers B from the group consisting of amides of (meth)acrylic acid with linear C2- to C12-diamines said C2- to C12-diamines being C6- to C22-alkylated on the terminal amine nitrogen.

In a still further preferred inventive embodiment suitable monomers B are selected from the group consisting of amides of methacrylic acid with C2- to C12-diamines, preferably linear C2- to C12-diamines, said C2- to C12-diamines or linear C2- to C12-diamines being C6- to C22-dialkylated on the amine nitrogen.

Highly preferred monomers B are selected from the group consisting of N,N-dimethylaminomethyl(meth)acrylamide, N,N-dimethylaminoethyl(meth)acrylamide, N,N-diethylaminomethyl(meth)acrylamide, N,N-diethylaminoethyl(meth)acrylamide, N,N-dimethylaminopropyl(meth)acrylamide, N,N-diethylaminopropyl(meth)acrylamide, N,N-dimethylaminobutyl(meth)acrylamide, N,N-diethylaminobutyl(meth)acrylamide, N,N dimethylaminocyclohexyl(meth)acrylamide, N,N diethylaminocyclohexyl(meth)acrylamide each of which respectively being quaternized at the terminal nitrogen by means of an-alkyl chain comprising from 6 to 22 carbon atoms or mixtures thereof.

Likewise highly preferred monomers B are selected from the group consisting of N,N-methyl,C6-C22-alkyl aminomethyl(meth)acrylamide, N,N-methyl,C6-C22-alkyl aminoethyl(meth)acrylamide, N,N-ethyl,C6-C22-alkyl aminomethyl(meth)acrylamide, N,N-ethyl,C6-C22-alkyl aminoethyl(meth)acrylamide, N,N-methyl,C6-C22-alkyl aminopropyl(meth)acrylamide, N,N-ethyl,C6-C22-alkyl aminopropyl(meth)acrylamide, N,N-methyl,C6-C22-alkyl aminobutyl(meth)acrylamide, N,N-ethyl,C6-C22-alkyl aminobutyl(meth)acrylamide, N,N methyl,C6-C22-alkylaminocyclohexyl(meth)acrylamide, N,N ethyl,C6-C22-alkylaminocyclohexyl(meth)acrylamide, each of which respectively being uncharged or quaternized at the terminal nitrogen by means of an-alkyl chain comprising from 6 to 22 carbon atoms or mixtures thereof.

Among those highly preferred monomers B, even more preference is given to using N,N dimethylaminoethyl(meth)acrylamide or N,N-dimethylaminopropyl(meth)acrylamide, each of which respectively being quaternized by means of a terminal N-alkyl chain comprising from 6 to 22 carbon atoms or mixtures thereof. Said high preference results from the ease of availability as well as their relatively low price.

In still another embodiment the copolymer with antimicrobial properties of the invention comprises 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least two compounds B1 and B2 comprising a radically polymerizable α,β-ethylenically unsaturated double bond and at least one cationic and/or cationogenic moiety as monomer B, with the cationic and/or cationogenic moiety of the first compound B1 bearing at least one terminal N-alkyl chain comprising from 6 to 22 carbon atoms, said first compound B1 being used in an amount ranging from 2 w % to w %; said first compound B1 being selected from amino group containing amides or esters; and with the cationic and/or cationogenic moiety of the second compound B2 bearing at least one terminal N-alkyl chain comprising from 1 to 22 carbon atoms if cationic or from 3 preferably 4 to 22 carbon atoms, if cationogenic, said second compound B2 being used in an amount ranging from 2 w % to 25 w %; such that the sum of said first compound B1 and said second compound B2 does not exceed 25 w %; said second compound B2 being selected from amino group containing amides or esters; optionally at least one monoethylenically unsaturated compound as monomer C; the sum of monomers A to C not exceeding 100 w %, with the proviso that the weight ratio of monomer A to monomer B being at least 3, and said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

The previously mentioned embodiment is further preferred if said first compound B1 being selected from amino group containing amides and said second compound B2 being selected from amino group containing esters, or vice versa, if said first compound B1 being selected from amino group containing esters and said second compound B2 being selected from amino group containing amides. Alternating amides and esters for compound B1 and B2 respectively, according to primarily obtained results which are still to be confirmed, seems to improve the simultaneous ability of the inventive copolymers to have anti-adhesive as well as antimicrobial properties when in contact or attached to a surface.

In order to fit with the required properties of simultaneously acting as anti-adhesive and antimicrobial means when applied or connected to a surface, the inventive copolymers should be either entirely cationized, preferably quaternized, or if not so, being free of any cationogenic monomers B, comprising a radically polymerizable α.β-ethylenically unsaturated double bond and at least one cationogenic moiety, said cationogenic moiety bearing only terminal N-alkyl chains comprising less than 3, preferably less than 4 carbon atoms.

The cationic and/or cationogenic moiety of monomer B is preferably a tertiary amino group. Charged cationic groups are to be produced from the amine nitrogen either by protonation, e.g. with carboxylic acids, such as lactic acid, citric acid, acetic acid or mineral acids, such as phosphoric acid, sulfuric acid and hydrochloric acid, or by quaternization, e.g. using alkylating agents such as C1- to C22-alkyl halides or sulfates. Examples of such alkylating agents are ethyl chloride, ethyl bromide, methyl chloride, methyl bromide, dimethyl sulfate and diethyl sulfate and the corresponding halides or sulfates with longer alkyl chains.

In another embodiment protection is sought for a copolymer with antimicrobial properties comprising 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 4, and said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

Yet another embodiment of the inventive copolymer with antimicrobial properties comprises 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 4, and said copolymer being free of any compound comprising a radically polymerizable α.β-ethylenically unsaturated double bond and at least one cationogenic moiety, said cationogenic moiety bearing only terminal N-alkyl chains comprising less than 4 carbon atoms.

A further developed inventive embodiment seeks protection for a copolymer with antimicrobial properties comprising 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 5, and said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

Yet another design of the inventive copolymer with antimicrobial properties comprises 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 5, and said copolymer being free of any compound comprising a radically polymerizable α.β-ethylenically unsaturated double bond and at least one cationogenic moiety, said cationogenic moiety bearing only terminal N-alkyl chains comprising less than 4 carbon atoms.

It is crucial to tune on the ratio between monomer A and monomer B and to adapt the length of the alkyl chain(s) of the cationogenic moiety of monomer B in order to come to copolymers which simultaneously show anti-adhesive and antimicrobial properties (on surfaces), which is reflected by the previous-mentioned embodiments. Further fine adjustment as given by the following embodiments also leads to good antimicrobial and anti-adhesive characteristics of said copolymers on surfaces. First results are to indicate that they are even improved and further studies in this regard are under way for confirmation.

Thus a further embodiment of the invention discloses a copolymer with antimicrobial properties comprising 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 6, and said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

Another important design of the inventive copolymer with antimicrobial properties comprises 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 6, and said copolymer being free of any compound comprising a radically polymerizable α.β-ethylenically unsaturated double bond and at least one cationogenic moiety, said cationogenic moiety bearing only terminal N-alkyl chains comprising less than 4 carbon atoms.

Still another inventive copolymer with antimicrobial properties comprises 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 7, and said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

Protection is also sought for a copolymer with antimicrobial properties comprising 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α.β-ethylenically unsaturated double bond and at least one cationic and/or cationogenic moiety as monomer B, with the cationic and/or cationogenic moiety thereof bearing at least one terminal N-alkyl chain comprising from 6 to 22 carbon atoms and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 7, and said copolymer being free of any compound comprising a radically polymerizable α.β-ethylenically unsaturated double bond and at least one cationogenic moiety, said cationogenic moiety bearing only terminal N-alkyl chains comprising less than 4 carbon atoms.

Investigations are still under way as to which any inventive copolymer being free of any compound comprising a radically polymerizable α.β-ethylenically unsaturated double bond and at least one cationogenic moiety, said cationogenic moiety bearing only terminal N-alkyl chains comprising less than 5, 6 and 7 carbon atoms are even further advanced with their ability to simultaneously act as anti-adhesive as well as antimicrobial means. Nevertheless an essential part of the invention are also all the aforementioned eight embodiments however with the proviso that the said copolymer being free of any compound comprising a radically polymerizable α.β-ethylenically unsaturated double bond and at least one cationogenic moiety, said cationogenic moiety bearing only terminal N-alkyl chains comprising less than 5, preferably less than 6 and more preferably less than 7 carbon atoms

Monomer C is selected from the group consisting of:

c1 vinyl ethers and vinyl ethers of polyols;
c2 low molecular weight hydrophilic (meth)acrylamides;
c3 (meth)acrylates;
c4 further assoziative monomers;
c5 monoethylenically unsaturated carboxylic acids.

In particular said monomer c is at least one monomer c1 selected from the group consisting of allyl vinylether, butoxyethyl vinylether, butyl-vinylether, 2-butyl vinylether, tert-butyl vinylether, butanediol vinylether, butanediol divinylether, 1-chloroethyl vinylether, 2-chloroethyl vinylether, cyclohexyl vinylether, 1,2-dichloroethyl vinylether, di(ethylene glycol) vinylether, di(ethylene glycol) divinylether, divinylether, dodecyl vinylether, ethylene glycol vinylether, ethylene glycol divinylether, ethyl vinylether, 1,2 ethanediol vinylether, 1,2 ethanediol divinylether, 2-ethylhexyl vinylether, glycerol monovinylether, glycerol divinylether, glycerin glycidyl vinylether, hexachlorodivinylether, hexadecyl vinylether, 4-hydroxybutyl vinylether, 2-hydroxyethyl vinylether, isoamyl vinylether, isobutyl vinylether, isooctyl vinylether, isopropyl vinylether, 2-(2-methoxyethoxy)ethyl vinylether, 2-methoxyethyl vinylether, methoxy diethylene glycol monovinylether, methoxy triethylene glycol monovinylether, methoxy oligoethylene glycol monovinylether with oligo representing from 4 to 50 CH₂—CH₂—O— groups, methoxy polyethylene glycol monovinyl ether with poly representing more than 50 CH₂—CH₂—O— groups, methyl vinylether, octadecyl vinylether, oligoethylene glycol vinylether with oligo representing from 4 to 50 CH₂—CH₂—O— groups, oligoethylene glycol divinylether with oligo representing from 4 to 50 CH₂—CH₂—O— groups, pentaerythrytol vinylether, perfluoropropyl vinylether, phenyl vinylether, 1-phenylethyl vinylether, propyl vinylether, trimethylolpropane vinylether, triethylene glycol vinylether, triethylene glycol divinylether, trimethylolpropane divinylether.

Both for handling and cost reasons among those, monomer c1 preferentially is selected from the group consisting of methyl vinylether, ethyl vinyl ether, butyl vinylether and dodecyl vinylether.

Said monomer C is also a monomer c2 selected from the group consisting of (meth)acrylamide, N-acetyl (meth)acrylamide, acetylphenyl-N(meth)acrylamide, N-adamantyl (meth)acrylamide, N-allyl (meth)acrylamide, N,N-diallyl (meth)acrylamide, 3-aminopropyl-N(meth)acrylamide, N-benzyl (meth)acrylamide, N,N-dibenzyl (meth)acrylamide, N-butyl (meth)acrylamide, N,N-dibutyl (meth)acrylamide, N-3-di(butyl)aminopropyl (meth)acrylamide, N-butoxymethyl (meth)acrylamide, N-tert-butyl (meth)acrylamide, N-2-cyanoethyl (meth)acrylamide, N-cyclohexyl (meth)acrylamide, N-cystamine-bis (meth)acrylamide, N-diacetone (meth)acrylamide, N,N-diallyl (meth)acrylamide, N,N-di-n-butyl (meth)acrylamide, N,N-diethyl (meth)acrylamide, N,N′-bis(diethylaminoethyl) (meth)acrylamide, 1,2-dihydroxyethylenebis-N,N (meth)acrylamide, N,N-diisopropyl (meth)acrylamide, 2,2-dimethoxyethyl-N (meth)acrylamide, 4,4-dimethoxybutyl-N(meth)acrylamide, N,N-dimethyl (meth)acrylamide, 1,1-dimethyl-2-sulfoethyl-N(meth)acrylamide, N-diphenylmethyl (meth)acrylamide, N-dodecyl (meth)acrylamide, ethylenebis-N,N′(meth)acrylamide, N-ethylhexyl (meth)acrylamide, N-ethyl (meth)acrylamide, N-diethyl (meth)acrylamide, hexamethylenebis-N,N (meth)acrylamide, N-tert-hexyl (meth)acrylamide, N-hydroxymethyl (meth)acrylamide, N-2-hydroxyethyl (meth)acrylamide, N-4-hydroxyphenyl (meth)acrylamide, N-isobornyl (meth)acrylamide, N-isobutoxymethyl (meth)acrylamide, N-isopropyl (meth)acrylamide, N,N-diisopropyl (meth)acrylamide, N-3-methoxypropyl (meth)acrylamide, N-methyl (meth)acrylamide, N,N-methylenebis (meth)acrylamide, N-methoxy (meth)acrylamide, N-methoxymethyl (meth)acrylamide, N-acetoxymethyl (meth)acrylamide, N-morpholinoethyl (meth)acrylamide, 3-(morpholino)propyl-N(meth)acrylamide, N-1-naphthyl (meth)acrylamide, N-octadecyl (meth)acrylamide, N,N′-octamethylenebis (meth)acrylamide, N-tert-octyl (meth)acrylamide, 2-(2-oxo-1-imidazolidinyl)-ethyl-N(meth)acrylamide, N-phenyl (meth)acrylamide, N-phenylethyl (meth)acrylamide, N-phthalamidomethyl (meth)acrylamide, N-propyl (meth)acrylamide, N-2,2,2-trichloro-hydroxyethyl (meth)acrylamide, tri(hydroxymethyl)-methyl-N (meth)acrylamide, 1,1,3-trimethylbutyl-N(meth)acrylamide.

Said at least one monoethylenically unsaturated compound as monomer C in another embodiment is selected from the group consisting of esters of α,β-ethylenically unsaturated mono- and dicarboxylic acids as monomer c3, also referred to as (meth)acrylates, such as, methyl (meth)acrylate, ethyl (meth)acrylate, methyl ethacrylate, n-propyl (meth)acrylate, isopropyl (meth)acrylate, n-propyl ethacrylate, ethyl ethacrylate, isopropyl ethacrylate, n-butyl (meth)acrylate, n-butyl ethacrylate, tert-butyl (meth)acrylate, tert-butyl ethacrylate, isobutyl (meth)acrylate, isobutyl ethacrylate, sec-butyl (meth)acrylate, sec-butyl ethacrylate, 2-pentyl (meth)acrylate, 3-pentyl (meth)acrylate, isopentyl (meth)acrylate, neopentyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arrachinyl (meth)acrylate, behenyl (meth)acrylate, lignocerenyl (meth)acrylate, cerotinyl (meth)acrylate, melissinyl (meth)acrylate, palmitoleinyl (meth)acrylate, oleyl (meth)acrylate, linolyl (meth)acrylate, linolenyl (meth)acrylate, stearyl (meth)acrylate, lauryl (meth)acrylate, phenoxyethyl (meth)acrylate, t-butylcyclohexyl (meth)acrylate, cyclohexyl (meth)acrylate, ureido (meth)acrylate, tetrahydrofurfuryl (meth)acrylate and mixtures thereof.

Further suitable monoethylenically unsaturated compounds as monomer C are further associative monomers c4 which are selected from the group consisting of hydrophilic macromonomers such as (meth)acryloyl-, (meth)acrylamide- and vinylether-modified hydrophilic polymers, like (meth)acryloyl-modified polyvinyl alcohol, (meth)acryloyl-modified partially hydrolyzed polyvinyl acetate, (meth)acryloyl-modified poly(2-alkyl-2-oxazoline), (meth)acrylamide-modified poly(2-alkyl-2-oxazoline), (meth)acryloyl- and (meth)acrylamide-modified poly(2-methyl-2-oxazoline), (meth)acryloyl- and (meth)acrylamide-modified poly(2-ethyl-2-oxazoline), (meth)acryloyl- and (meth)acrylamide-modified poly(vinyl pyrrolidone), (meth)acryloyl- and (meth)acrylamide-modified hydrophilic polypeptoids, (meth)acryloyl- and (meth)acrylamide-modified polyphosphorylcholine, (meth)acryloyl- and (meth)acrylamide-modified polysulfobetaines, (meth)acryloyl- and (meth)acrylamide-modified polycarbobetaines, (meth)acryloyl- and (meth)acrylamide-modified polyampholytes.

The wording “monoethylenically unsaturated carboxylic acids” as monomer c5 likewise comprises at least one entity selected from the group consisting of olefinically unsaturated, free-radically polymerizable carboxylic acids and organic as well as inorganic salts thereof.

The monoethylenically unsaturated carboxylic acid as monomer c5 is selected from the group consisting of monocarboxylic acids, dicarboxylic acids, carboxylic anhydrides or half-esters of dicarboxylic acids.

Preferably the monoethylenically unsaturated carboxylic acid as monomer c5 is selected from the group consisting of acrylic acid, methacrylic acid, ethacrylic acid, alpha-chloroacrylic acid, crotonic acid, maleic acid, maleic anhydride, itaconic acid, citraconic acid, mesaconic acid, glutaconic acid, aconitic acid, fumaric acid, half-esters of olefinically unsaturated dicarboxylic acids having 4 to 10, preferably 4 to 6, carbon atoms and salts thereof.

More preferably the monoethylenically unsaturated carboxylic acid as monomer c5 is at least one compound selected from the group consisting of acrylic acid, methacrylic acid, crotonic acid, itaconic acid, salts thereof and mixtures thereof.

In a still further embodiment of the inventive copolymer, at least one monomer C is chosen from the groups c1 through c5 as previously indicated.

Most promising results with respect to simultaneously acting as anti-adhesive and antimicrobial copolymer (when subjected onto a surface) are obtained with an entirely cationized copolymer of the invention. Elsewhere one of the required characteristics is pronounced and the other one is a little bit smaller. To achieve an equal occurrence of both characteristics, in one embodiment the copolymer of the invention is entirely cationized, preferably quaternized. This is to say, after obtaining one embodiment of the inventive copolymer, it is beneficial to entirely convert it into a fully cationized, preferably quaternized form by means of harsh protonating or alkylating conditions. Said conditions are not accessible from the prior art as can be seen from Deboudt et al. supra.

In a highly preferred embodiment of the invention monomer A is N-vinyl-2-pyrrolidone and/or N-vinyl caprolactam. These monomers confer to the copolymer of the invention a character of not only being positively charged but also having an ability to serve as a hydrogen bond acceptor by means of the carbonyl moiety. Furthermore the solubility in aqueous solutions of the copolymer is increased which overcomes the poor solubility of cationic homopolymers with terminal N-alkyl chains as claimed.

During the course of experimentation, it was found to be rather straight forward to only use cationic monomers as monomers B. Therefore, an advanced embodiment of the invention requires monomer B to be entirely in a cationized preferably quaternized form. Upon using such cationic monomers, no further alkylation or protonation step is required thus circumventing the difficulties of completely converting the inventive copolymer in a completely cationized form.

In a further embodiment monomer B comprises a counter ion, said counter ion being selected from the group consisting of iodide, bromide, chloride, hydrogensulfate, methyl sulfate and ethyl sulfate. Upon subjecting one and the same copolymer of the invention or a hydrogel comprising one and the same such copolymer, however respectively with a different counter ion, to a colony of eschericha coli bacteria as well as to another colony of staphylococcus aureus and to a third colony of proteus mirabilis becteria all as outlined below, both antimicrobial and anti-adhesive properties were recorded. The antimicrobial property was mostly pronounced with iodide as counter ion and decreased from iodide to bromide, chloride, methylsulfate and ethylsulfate. Thus, also the counter-ion of the inventive copolymer contributes to its performance, especially when coated or connected to a surface, thus forming a hydrogel.

Another embodiment of the inventive copolymer identifies monomer B to be a derivative of (meth)acrylic acid. Upon comparing entities of monomer B deriving from acrylic acid and methacrylic acid, both were shown to bring up a copolymer of the invention with the desired properties. However the derivative of methacrylic acid outperformed this one of acrylic acid. Other derivatives of monoethylenically unsaturated carboxylic acid were also tested, but in first results, did not perform as well as monomers B deriving from methacrylic and acrylic acid. However, these results have to be confirmed by further testing.

Another embodiment of the invention favors said at least one cationic and/or cationogenic moiety of monomer B to be an acyclic one. Highly promising results with respect to antimicrobial and anti-adhesive efficacy were obtained with such entities. For instance, it seems to be that the length of the terminal N-alkyl chain of monomer B, which by the invention is to comprise from 6 to 22 carbon atoms, seems not to have this or a somewhat different influence, when connected to a cationic or a cationogenic moiety of a monomer comprising a radically polymerizable α,β-ethylenically unsaturated double bond and said at least one cationic and/or cationogenic moiety, said cationic and/or cationogenic moiety being an imidazole or an imidazolium ion.

In yet another embodiment of the invention the at least one terminal N-alkyl chain of monomer B of the copolymer of the invention is a linear entity. These linear entities, provided they fit with the length as given in claim 1, were shown to give good results with respect to antimicrobial and anti-adhesive activity when incorporated into the copolymer of the invention.

A further design of the invention provides a copolymer with antimicrobial properties comprising 60 to 98 w % of at least one water-soluble monomer selected from the group consisting of cyclic N-vinyl amides, N-vinyl imidazoles, (meth)acrylic esters containing CH₂—CH₂—O— or CH₂—CH—(CH₃)—O— units, and hydroxy(meth)acrylates as monomer A; at least one compound comprising a radically polymerizable α,β-ethylenically unsaturated double bond and at least one cationic and/or cationogenic moiety as monomer B, with the cationic and/or cationogenic moiety thereof bearing at least one terminal N-alkyl chain comprising from 8 to 20 carbon atoms, preferably form 10 to 18 carbon atoms, highly preferably from 12 to 16 carbon atoms, and said monomer B being used in an amount ranging from 2 w % to 25 w %; optionally at least one monoethylenically unsaturated compound as monomer C; the sum of monomers A to C not exceeding 100 w %, with the proviso that the weight ratio of monomer A to monomer B being at least 3, and said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

Great care shall be taken with respect to the amount of monomer B being used in the copolymer of the invention. Good results, viz. likewise antimicrobial as well as anti-adhesive properties of the inventive copolymer are achieved, when monomer B is used in an amount ranging from more than 2 to 25 w %, preferably from more than 2 to less than 25 w %, more preferably from more than 2 to 20 w %, still more preferably in an amount ranging from more than 2 to 17 w %, even more preferably in an amount ranging from more than 2 to 15 w %, still more preferably in an amount ranging from 3 to 12.5 w %, further preferred in an amount ranging from 4 to 12.5 w % and most preferably in an amount ranging from 5 to 12.5 w %. Beyond these ranges the required properties cannot be properly achieved thus leading to copolymers which, when applied to a surface, exhibit either only antimicrobial or only anti-adhesive properties or none of both.

But not only the amount of monomer B is crucial. Attention should likewise be paid with respect to the weight ratio between monomer A and monomer B. Said weight ratio in an embodiment showing likewise good antimicrobial and anti-adhesive properties, is to be at least 7, more preferably at least 7 and at most 49 and most preferably ranging from 7 to 19. Otherwise the copolymer of the invention becomes either highly hydrophobic or highly hydrophilic which both reduces the performance of the inventive copolymers, the inventive copolymer preparations or the inventive hydrogels. Viz. provided said copolymer of the invention is too hydrophobic, no proper anti-adhesive behavior is to be obtained. On the other hand, once the inventive copolymer being to hydrophilic, this reduces the amount of charges and alkyl groups on the copolymer or inventive copolymer coated surface due to a depletion of the amount of monomer B, thus hampering the copolymer's ability to act as antimicrobial means.

In a further embodiment the inventive copolymer is free of any compound comprising a radically polymerizable α.β-ethylenically unsaturated double bond and at least one cationogenic moiety, said cationogenic moiety bearing only terminal N-alkyl chains comprising less than 4 carbon atoms, preferably less than 5 carbon atoms, more preferably less than 6 carbon atoms, even more preferably less than 7 carbon atoms and most preferably less than 8 carbon atoms. As already outlined earlier, the cationic moiety and/or the cationogenic moiety of monomer B is to bear a terminal N-alkyl chain comprising a minimum amount of carbon atoms. Elsewhere a lesser anti-adhesive and/or antimicrobial effect is observed. This embodiment shows more the length of the terminal alkyl chain of the cationogenic moiety of monomer B increases, more it is likely to get good results with respect to poor adherence as well as to good antimicrobial activity.

Provided monomer B comprises a cationic moiety, likewise, the length of the terminal N alkyl chain is to be observed. The copolymer of the invention in this embodiment viz. monomer B thereof is to be free of any compound comprising a radically polymerizable α.β-ethylenically unsaturated double bond and at least one cationic moiety, said cationic moiety bearing only terminal N-alkyl chains comprising less than 3 carbon atoms, preferably less than 4 carbon atoms, more preferably less than 5 carbon atoms and most preferably less than 6 carbon atoms.

Otherwise similar problems will occur as outlined in the previous paragraph.

Another extended embodiment of the invention discloses a copolymer, preferably as previously mentioned comprising monomer A, monomer B, at least one polymerizable photocrosslinker as monomer D and optionally at least one monomer C. Including a polymerizable photocrosslinker into a copolymer, in particular into a copolymer as previously outlined, will confer to this embodied copolymer of the invention not only the previously indicated properties, but will also allow it to be covalently bound to any kind of surface exhibiting C—H bonds. By doing so, a hydrogel can form on top of said surface in the presence of humidity. It is to be understood that the polymerizable photocrosslinker in this embodiment comprises a polymerizable entity and in addition a residue suited for photoactivation.

The polymerizable photocrosslinker as monomer D is selected from the group consisting of monomers comprising a radically polymerizable, olefinically unsaturated double bond and an entity adapted to insert in whatever C—H-bond. “Olefinically” unsaturated means any kind of olefinic and non-aromatic double bound located in monomer D however, not necessarily in proximity or vicinity to said entity adapted to insert in whatever C—H-bond.

The polymerizable photocrosslinker as monomer D is also selected from the group consisting of monomers comprising a radically polymerizable olefinically unsaturated double bond and an entity adapted to proceed for an intermolecular abstraction of a hydrogen atom from whatever H-bearing compound. Also for this monomer D, the term “olefinically” has the same meaning as given supra.

In a highly preferred embodiment of the invention the at least one polymerizable photocrosslinker as monomer D is selected from the group consisting of compounds as outlined by the following formula (IV)

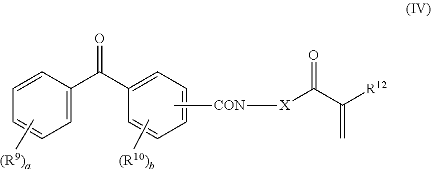

with R⁹ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
“a” being an integer ranging von 0 to 5,
R¹⁰ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
b being an integer ranging from 0 to 4,
X being a bond, oxygen or a group of formula NR¹¹, with R¹¹ being hydrogen or a moiety with 1 to 6 carbon atoms,
R¹² being hydrogen, methyl or ethyl, preferably hydrogen or methyl,
CON being a bond or a connecting group,
said connecting group CON being selected from the group consisting of
entities containing from 1 to 2000 carbon atoms, preferably from 1 to 1000 carbon atoms and more preferably containing from 1 to 500 carbon atoms;
diamines, said diamines being selected from the group comprising, preferably consisting of ethylene diamine, 1,2-propylenediamine, α,ω-diaminoalkanes in particular 1,3-diaminopropane, 1,4-diaminobutane, 1,6-diaminohexane, 1,8-diaminooctane, 1,10-diaminodecane, 1,12-diaminododecane; 1,2-diamino-cyclohexane, 1,3-diamino-cyclohexane, 1,4-diamino-cyclohexane, 3,3′-dimethyl-4,4′diamino-dicyclohexylmethane, 4,4′-diaminodicyclohexylmethane, Baxxodur® ECX 210 which is a mixture of 2-methylcyclohexane-1,3-diamine [CAS registration no. 13897-56-8] and 4-methylcyclohexane-1,3-diamine [CAS registration no. 13897-55-7], isophorone diamine, 2,2-dimethylpropane-1,3-diamine, 1,2-phenylenediamine, 1,3-phenylenediamine, 1,4-phenylenediamine, 2,4-diaminotoluene, 2,6-diaminotoluene, 2,4-diaminopyridine, 2,6-diaminopyridine, diaminodiphenylmethane;
entities of formula (V)

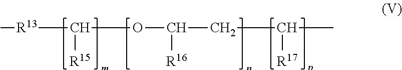

with R¹³ being a bond, an oxygen or sulfur atom or a group of the formula NR¹⁴, with R¹⁴ being an alkyl group comprising from 1 to 6 carbon atoms; R¹³ further being an O—CO—O— group, an NH—CO—O— group, an HN—CO—NH-group or a connecting alkyl group comprising from 1 to 20 carbon atoms,
R¹⁵, R¹⁶ and R¹⁷ being respectively hydrogen, methyl or ethyl,
m and p being an integer ranging from 0 to 2 respectively,
n being an integer ranging from 0 to 200, preferably from 1 to 100 and more preferably ranging from 1 to 50.

In another highly preferred embodiment, of the invention the at least one polymerizable photocrosslinker as monomer D is selected from the group consisting of compounds as outlined by the following formula (VI)

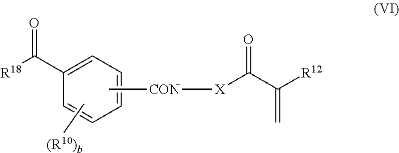

with R¹⁸ being selected from the group consisting of C₁-C₂₀ alkyl, viz. an alkyl moiety containing from 1 to 20 carbon atoms, aryl, heteroaryl, in particular methyl and ethyl, and of C₁-C₂₀-alkyloxy particularly methoxy and ethoxy;
R¹⁰ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
b being an integer ranging from 0 to 4,
X being a bond or oxygen or a group of formula NR¹¹, with R¹¹ being hydrogen or a moiety with 1 to 6 carbon atoms,
R¹² being hydrogen, methyl or ethyl, preferably hydrogen or methyl,
CON being a bond or a connecting group,
said connecting group CON being selected from the group consisting of
entities containing from 1 to 2000 carbon atoms, preferably from 1 to 1000 carbon atoms and more preferably containing from 1 to 500 carbon atoms;
diamines, said diamines being selected from the group comprising, preferably consisting of ethylene diamine, 1,2-propylenediamine, α,ω-diaminoalkanes in particular 1,3-diaminopropane, 1,4-diaminobutane, 1,6-diaminohexane, 1,8-diaminooctane, 1,10-diaminodecane, 1,12-diaminododecane; 1,2-diamino-cyclohexane, 1,3-diamino-cyclohexane, 1,4-diamino-cyclohexane, 3,3′-dimethyl-4,4′diamino-dicyclohexylmethane, 4,4′-diaminodicyclohexylmethane, Baxxodur® ECX 210 which is a mixture of 2-methylcyclohexane-1,3-diamine [CAS registration no. 13897-56-8] and 4-methylcyclohexane-1,3-diamine [CAS registration no. 13897-55-7], isophorone diamine, 2,2-dimethylpropane-1,3-diamine, 1,2-phenylenediamine, 1,3-phenylenediamine, 1,4-phenylenediamine, 2,4-diaminotoluene, 2,6-diaminotoluene, 2,4-diaminopyridine, 2,6-diaminopyridine, diaminodiphenylmethane;
entities of formula (V)

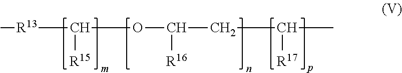

with R¹³ being a bond, an oxygen or sulfur atom or a group of the formula NR¹⁴, with R¹⁴ being an alkyl group comprising from 1 to 6 carbon atoms, R¹³ further being an O—CO—O— group, an NH—CO—O— group, an HN—CO—NH-group or a connecting alkyl group comprising from 1 to 20 carbon atoms,
R¹⁵, R¹⁶ and R¹⁷ being respectively hydrogen, methyl or ethyl,
m and p being an integer ranging from 0 to 2 respectively,
n being an integer ranging from 0 to 200, preferably from 1 to 100 and more preferably ranging from 1 to 50.

Besides to the indications given for monomers A, B and C, the following definitions apply for the polymerizable photocrosslinker as monomer D as well as for the non-polymerizable photocrosslinker E:

“C₁-C₂₀-alkoxy” is understood to consist of at least one of the moieties methoxy, ethoxy, propoxy, isopropoxy, n-butoxy, sec-butoxy, tert.-butoxy, n-pentoxy, 2-methyl-butoxy, 1,1-dimethyl-pentoxy, 2,2-dimethyl-pentoxy, 1,2-dimethyl-pentoxy, n-hexoxy, 1-methyl-pentoxy, 2-methyl pentoxy, 3-methyl-pentoxy, 1,1-dimethyl-butoxy, 1,2-dimethyl-butoxy, 1,3-dimethyl-butoxy, 2,3-dimethyl-butoxy, 1-ethyl-butoxy, 2-ethylbutoxy, 3-ethyl-butoxy, n-heptoxy, 1-methyl-hexoxy, 2-methyl-hexoxy, 3-methyl-hexoxy, 4-methyl-hexoxy, 5-methyl-hexoxy. 1,1-dimethyl-hexoxy, 1,2-dimethyl-hexoxy, 1,3-dimethyl-hexoxy, 1,4-dimethyl-hexoxy, 1,5-dimethyl-hexoxy, 1,1-dimethyl-pentoxy, 1,2-dimethyl-pentoxy, 1,3-dimethyl-pentoxy, 1,4-dimethyl-pentoxy, 2,2-dimethyl-pentoxy, 2,3-dimethyl-pentoxy, 2,4-dimethyl-pentoxy, 3,3-dimethyl-pentoxy, 1,1-methy,ethyl-butoxy, 1-methyl-2-ethyl-butoxy, 2-methyl-1-ethyl-butoxy, 1-methyl-3-ethyl-butoxy, 1-ethyl-3-methyl-butoxy, 4-ethyl-4-methyl-butoxy, 2-methyl-3-ethyl-butoxy, 2-ethyl-3-methyl-butoxy, 2-ethyl-2-methyl-butoxy, 3-ethyl-2-methyl-butoxy, 3-methyl-4-ethyl-butoxy, 4-methyl-3-ethyl-butoxy, n-octoxy, n-nonoxy, n-decaoxy, n-undecaoxy, n-duodecaoxy, lauryloxy, tridecyloxy, tetradecyloxy, myristyloxy, pentadecyloxy, hexadecyloxy, palmityloxy, heptadecyloxy, margaryloxy, octadecyloxy, stearyloxy, nonadecyloxy, eichosanyloxy, or eicosyloxy.
“C₁-C₂₀-alkyl”, viz. an alkyl moiety containing from 1 to 20 carbon atoms comprises, in a non-exhaustive recitation and preferably consists of at least one of the following moieties, C₁-C₂₀-alkyl, C₁-C₂₀-alkylthio, C₂-C₂₀-alkenyl, cycloalkyl, aryl, heteroaryl or heterocyclyl, with the cycloalkyl, aryl, heteroaryl or heterocyclyl moieties including unsubstituted entities or entities being substituted up to three times and in case of fluorine up to the maximum number of identical or different substituents. C₁-C₂₀-alkyl, C₂-C₂₀-alkenyl moieties are also understood to comprise such entities with non-adjacent saturated carbon atoms to be replaced by heteroatoms, such as oxygen or sulfur. Likewise C₁-C₂₀-alkyl, C₂-C₂₀-alkenyl moieties also comprise entities having a three- to six-membered ring, which is either substituted or unsubstituted with up to three substituents selected from the group consisting of hydroxyl (—OH), carboxyl (—COOH), formyl, cyano (—CN), sulfonate (SO₃H), halogen, aryl, aryloxy, arylthio, C₃-C₈-cycloalkoxy, C₃-C₈-cycloalkylthio, heterocyclyl, heterocyclyloxy or C₁-C₂-alkoxycarbonyl, the latter comprising methoxycarbonyl or ethoxycarbonyl.

In a preferred embodiment the term “C₁-C₂₀-alkyl” consists of at least one unbranched or branched hydrocarbon moiety having from 1 to 20 carbon atoms. It comprises in particular hydrocarbon moieties selected from the group consisting of methyl, ethyl, propyl, isopropyl, n-butyl, 2-butyl, 2-methylpropyl and tert-butyl, pentyl, 2-methylbutyl, 1,1-dimethylpropyl, hexyl, capryl, heptyl, oenanthyl, octyl, caprylyl, 1,1,3,3-tetramethylbutyl, nonyl, pelargonyl, 1-decyl, 2-decyl, undecyl, dodecyl, lauryl, tridecyl, tetradecyl, myristyl, pentadecyl, hexadecyl, palmityl, heptadecyl, margaryl, octadecyl, stearyl, nonadecyl, eichosanyl, or eicosyl.

The term “C₁-C₂₀-alkylthio” consists of at least one of the moieties mentioned in the last para., however, each of which being respectively connected to a sulfur atom.

The term “C₂-C₂₀-alkenyl” consists of at least one of the moieties mentioned in the penultimate para., however, each of which comprising one olefinically unsaturated double bound. In a particular preferred embodiment the term “C₂-C₂₀-alkenyl” is understood to comprise at least one member selected from the group consisting of vinyl, allyl, 2-methyl-2-propenyl, 2-butenyl, 2-pentenyl, 2-decenyl, 2-eicosenyl.

The term “cycloalkyl” is understood to comprise preferably to consist of C₃-C₈-cycloalkoxy and C₃-C₈-cycloalkylthio moieties. C₃-C₈-cycloalkoxy moieties comprise preferably consist of at least one entity selected from the group consisting of cyclopropyl, cyclobutyl, cyclopentyl, cyclohexyl, cycloheptyl or cyclooctyl, each of which respectively being linked via an oxygen. C₃-C₈-cycloalkylthio moieties comprise preferably consist of at least one entity selected from the group consisting of cyclopropyl, cyclobutyl, cyclopentyl, cyclohexyl, cycloheptyl or cyclooctyl, each of which respectively being linked via a sulfur atom.

The term “aryl” within this specification means an isocyclic aromatic moiety having from 6 to 14, preferably from 6 to 12 carbon atoms, such as phenyl, benzyl, naphthyl, biphenylyl, with phenyl to be preferentially used.

“aryloxy” is meant to consist of an aryl as previously mentioned, said aryl being connected to an oxygen atom and preferably comprises the entities phenoxy, benzyloxy, 1- or 2-naphthyloxy
“arylthio” within this specification has the meaning as given in the last para., however, the entities not being connected to an oxygen, but to a sulfur atom, thus preferably comprising the entities phenylthio, benzylthio, 1- or 2-naphthylthio.

The term “heteroaryl” within this specification means an aromatic moiety having from 4 to 14, preferably from 4 to 12 carbon atoms, and at least one heteroatom within the cycle like for instance pyridyl.

The term “heterocyclyl” consists of a heteroaliphatic or heteroaromatic ring system.

The “heteroaromatic ring system” within this specification is an aryl moiety in which at least one CH group is replaced by N and/or at least two adjacent CH groups are replaced by S, NH or O. The “heteroaromatic ring system” is understood to comprise at least one of the entities thiophene, furan, pyrrole, thiazole, oxazole, imidazole, isothiazole, isoxazole, pyrazole, 1,3,4-oxadiazole, 1,3,4-thiadiazole, 1,3,4-triazole, 1,2,4-oxadiazole, 1,2,4-thiadiazole, 1,2,4-triazole, 1,2,3-triazole, 1,2,3,4-tetrazole, benzothiophene, benzofuran, indole, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, pyrazine, pyrimidine, pyridazine, 1,3,5-triazine, 1,2,4-triazine, 1,2,4,5-triazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or 4H-quinolizine.

The “heteroaliphatic ring system” comprises at least one of the entities mentioned in the last para., however, in an entirely hydrogenated form.

“Heterocyclyloxy” within this specification denotes for the heteroaliphatic or heteroaromatic ring system given supra, however with each entity thereof being respectively bound to another part of a compound in particular of compound (IV) or (VI) via an oxygen, viz. via an ether linkage.

Another embodiment of the invention describes a copolymer, preferably as previously disclosed comprising monomer A, monomer B, at least one polymerizable photocrosslinker as monomer D, optionally at least one monomer C. with said at least one polymerizable photocrosslinker D being used in an amount ranging from 0.01 to 30% by weight, preferably in an amount ranging from 0.1 to 20% by weight, even more preferably in an amount ranging from 0.5 to 15% by weight, in particular ranging from 1 to 10% by weight and especially ranging from 3 to 7% by weight, based on the overall weight of the copolymer contained in the copolymer preparation. Provided one uses the polymerizable photocrosslinker D in an amount exceeding 30% by weight, photocrosslinking is very intense thus reducing the antimicrobial and anti-adhesive properties of the inventive copolymer.

In yet another highly preferred embodiment of the invention the at least one polymerizable photocrosslinker as monomer D is selected from the group consisting of compounds as outlined by the following formula (VII)

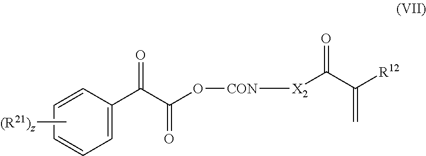

with each R²¹ being independently selected from halogen, cyano, azido, nitro, —SCN, —SF₅, C₁-C₄-alkyl, C₁-C₄-haloalkyl, C₃-C₈-cycloalkyl, C₃-C₈-halocycloalkyl, C₂-C₄-alkenyl, C₂-C₄-haloalkenyl, C₂-C₄-alkynyl, C₂-C₄-haloalkynyl, OR²⁴, S(O)_{¥}R²⁴, S(O)₃⁻(M^{a+})_{1/a}, NR²²R²³, C(O)R²⁵, C(O)OR²⁴, C(O)NR²²R²³, OC(O)R²⁵, NR²²C(O)R²⁵, phenyl which may be substituted by 1, 2, 3, 4 or 5 radicals R²⁶, and a 3-, 4-, 5-, 6-7- or 8-membered saturated, partially unsaturated or maximally unsaturated heterocyclic ring containing 1, 2, 3 or 4 heteroatoms or heteroatom groups selected from N, O, S, NO, SO and SO₂ as ring members, where the heterocyclic ring may be substituted by one or more radicals R²⁶;
R²² and R²³, independently of each other and independently of each occurrence, being selected from hydrogen, C₁-C₄-alkyl, C₁-C₄-haloalkyl, C₃-C₈-cycloalkyl, C₃-C₈-halocycloalkyl, C₁-C₄-alkoxy, C₁-C₄-haloalkoxy, C(O)R²⁵, C(O)OR²⁴, phenyl and benzyl;
each R²⁴ being independently selected from hydrogen, C₁-C₄-alkyl, C₁-C₄-haloalkyl, C₃-C₈-cycloalkyl, C₃-C₈-halocycloalkyl, phenyl and benzyl;
each R²⁵ being independently selected from hydrogen, C₁-C₄-alkyl, phenyl and benzyl;
each R²⁶ being independently selected from halogen, cyano, C₁-C₄-alkyl, C₁-C₄-haloalkyl, C₁-C₄-alkoxy and C₁-C₄-haloalkoxy;
(M^{a+})_{1/a} being a metal equivalent or an optionally substituted ammonium cation;
z being 0, 1, 2, 3, 4 or 5;
¥ being 0, 1, 2 or 3;
   X₂ being a bond or oxygen or a group of formula NR¹¹, with R¹¹ being hydrogen or a moiety with 1 to 6 carbon atoms,
   R¹² being hydrogen, methyl or ethyl, preferably hydrogen or methyl,
   CON being a bond or a connecting group,
   said connecting group CON being selected from the group consisting of
entities containing from 1 to 2000 carbon atoms, preferably from 1 to 1000 carbon atoms and more preferably containing from 1 to 500 carbon atoms;
diamines, said diamines being selected from the group comprising, preferably consisting of ethylene diamine, 1,2-propylenediamine, α,ω-diaminoalkanes in particular 1,3-diaminopropane, 1,4-diaminobutane, 1,6-diaminohexane, 1,8-diaminooctane, 1,10-diaminodecane, 1,12-diaminododecane; 1,2-diamino-cyclohexane, 1,3-diamino-cyclohexane, 1,4-diamino-cyclohexane, 3,3′-dimethyl-4,4′diamino-dicyclohexylmethane, 4,4′-diaminodicyclohexylmethane, Baxxodur® ECX 210 which is a mixture of 2-methylcyclohexane-1,3-diamine [CAS registration no. 13897-56-8] and 4-methylcyclohexane-1,3-diamine [CAS registration no. 13897-55-7], isophorone diamine, 2,2-dimethylpropane-1,3-diamine, 1,2-phenylenediamine, 1,3-phenylenediamine, 1,4-phenylenediamine, 2,4-diaminotoluene, 2,6-diaminotoluene, 2,4-diaminopyridine, 2,6-diaminopyridine, diaminodiphenylmethane;
entities of formula (V)

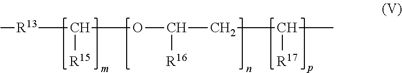

with R¹³ being a bond, an oxygen or sulfur atom or a group of the formula NR¹⁴, with R¹⁴ being an alkyl group comprising from 1 to 6 carbon atoms, an O—CO—O— group, an NH—CO—O— group, an HN—CO—NH-group or a connecting alkyl group comprising from 1 to 20 carbon atoms,
R¹⁵, R¹⁶ and R¹⁷ being respectively hydrogen, methyl or ethyl,
m and p being an integer ranging from 0 to 2 respectively,
n being an integer ranging from 0 to 200, preferably from 1 to 100 and more preferably ranging from 1 to 50.

Further polymerizable photocrosslinkers as monomer D are those of formula (IV, VI), wherein the at least one moiety being connected from the left side to the entity “X” or to the entity “CON” is selected from the group comprising, preferably consisting of acetophenone, benzophenone, antraquinone, anthrone, fluorenone, acridone, xanthone, thioxanthone, or their ring substituted derivatives, diphenoxybenzophenone, 4,4′-bis(dimethylamino)benzophenone, 2,4,6-trimethylbenzophenone, 4-methylbenzophenone, 4-chlorobenzophenone, 4-phenylbenzophenone, 4,4′-bis(diethylamino)benzophenone, methyl-2-benzoylbenzoate, 3,3′-dimethyl-4-methoxybenzophenone, 4-(4-methylphenylthio)benzophenone, 2,4,6-trimethyl-4′-phenylbenzophenone, 3-methyl-4′-phenyl-benzophenone, 2-methylbenzophenone, 2-methoxycarbonylbenzophenone, 4-chlorobenzophenone, 4-phenylbenzophenone, 4,4′-bis(dimethylamino)benzophenone, 3,3′-dimethyl-4-methoxybenzophenone, 4-(4-methylphenylthio)benzophenone, as well as camphor chinone, 1,2-diphenylethane-1,2-dione also referred to as benzil, 1-phenylpropane-1,2-dione, diphenyl-2,4,6-trimethylbenzoylphosphinoxide, bis(2,4,6-trimethylbenzoyl)-phenylphosphinoxide, bis(2,6-dimethoxybenzoyl)-2,4,4-trimethylpentylphosphinoxide, 1-hydroxycyclohexylphenylketone, 2-hydroxy-2-methyl-1-phenyl-1-propanone, 2-hydroxy-1-[4-(2-hydroxyethoxy)phenyl]-2-methyl-1-propanone, 2-methyl-1-[4-(methylthio)phenyl]-2-(4-morpholinyl)-1-propanone, benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanon and 2-benzyl-2-(dimethylamino)-1-[3,4-dimethoxyphenyl]-1 butanone.

Likewise highly preferred polymerizable photocrosslinkers as monomer D are also those of formula (VII), wherein the cyclic moiety neighboring the carbonyl group is selected from the group consisting of phenyl, toluyl and cyclohexyl.

The molecules given in the last to paras. are adapted, since they readily insert in whatever C—H-bond under mild conditions viz. simply by timely application of electromagnetic irradiation, preferably UV-light. Likewise they are adapted to proceed for an intermolecular abstraction of a hydrogen atom from whatever H-bearing compound under the same mild conditions.

Besides being covalently bound or in addition to be covalently bound to the copolymer of the invention as monomer D, the photocrosslinker in an alternative embodiment is just mixed with the copolymer providing a copolymer preparation comprising a copolymer, preferably as previously outlined, comprising monomer A, monomer B, optionally monomer C, optionally monomer D and at least one non-polymerizable photocrosslinker E. Such copolymer preparations are particularly useful if one wants to adjust the degree of crosslinking. This is easily done simply by adding an appropriate amount of non-polymerizable photocrosslinker E to the copolymer thus giving the copolymer preparation. Said copolymer either bears already a photocrosslinker D covalently bound to it or is free thereof.

In a highly preferred embodiment the at least one non-polymerizable photocrosslinker E is selected from the group of compounds represented by formula (VIII)

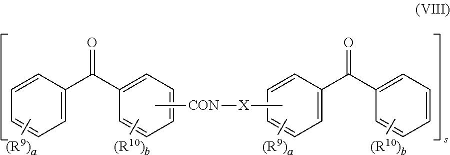

with R⁹ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
“a” being an integer ranging von 0 to 5,
R¹⁰ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
b being an integer ranging from 0 to 4,
X being a bond, oxygen or a group of formula NR¹¹, with R¹¹ being hydrogen or a moiety with 1 to 6 carbon atoms,
s having the numerals 1, 3/2, 2, 5/2, 3, 7/2, 4, 9/2, 5, 11/2, 6, 13/2 and 7,
CON being a bond or a connecting group,
said connecting group CON being selected from the group consisting of
entities containing from 1 to 2000 carbon atoms, preferably from 1 to 1000 carbon atoms and more preferably containing from 1 to 500 carbon atoms;
diamines, said diamines being selected from the group comprising, preferably consisting of ethylene diamine, 1,2-propylenediamine, α,ω-diaminoalkanes in particular 1,3-diaminopropane, 1,4-diaminobutane, 1,6-diaminohexane, 1,8-diaminooctane, 1,10-diaminodecane, 1,12-diaminododecane; 1,2-diamino-cyclohexane, 1,3-diamino-cyclohexane, 1,4-diamino-cyclohexane, 3,3′-dimethyl-4,4′diamino-dicyclohexylmethane, 4,4′-diaminodicyclohexylmethane, Baxxodur® ECX 210 which is a mixture of 2-methylcyclohexane-1,3-diamine [CAS registration no. 13897-56-8] and 4-methylcyclohexane-1,3-diamine [CAS registration no. 13897-55-7], isophorone diamine, 2,2-dimethylpropane-1,3-diamine, 1,2-phenylenediamine, 1,3-phenylenediamine, 1,4-phenylenediamine, 2,4-diaminotoluene, 2,6-diaminotoluene, 2,4-diaminopyridine, 2,6-diaminopyridine, diaminodiphenylmethane;
entities of formula (V)

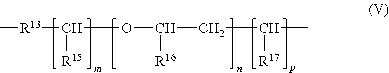

with R¹³ being a bond, an oxygen or sulfur atom or a group of the formula NR¹⁴, with R¹⁴ being an alkyl group comprising from 1 to 6 carbon atoms; R¹³ further being an O—CO—O— group, an NH—CO—O— group, an HN—CO—NH-group or a connecting alkyl group comprising from 1 to 20 carbon atoms,
R¹⁵, R¹⁶ and R¹⁷ being respectively hydrogen, methyl or ethyl,
m and p being an integer ranging from 0 to 2 respectively,
n being an integer ranging from 0 to 200, preferably from 1 to 100 and more preferably ranging from 1 to 50.

In order to further clarify the meaning of s, said index s having the numeral 3/2 is understood to represent an entity having 3 benzophenone moieties. The numeral s being 4 is understood to represent an entity having 8 benzophenone moieties and if s equals 9/2, this is meant to represent an entity having 9 benzephenone moieties, respectively each of the previously mentioned benzophenone moieties being connected via the group —CON—X— to an adjacent benzophone moiety.

Such entities were shown to insert into as many different C—H-bonds as photoactivable entities like for instance benzophenone are present in the non-polymerizable photocrosslinker E, simply by exciting it by means of one distinct wavelength of electromagnetic irradiation only.

In another preferred embodiment the at least one non-polymerizable photocrosslinker E is selected from the group of compounds represented by formula (IX)

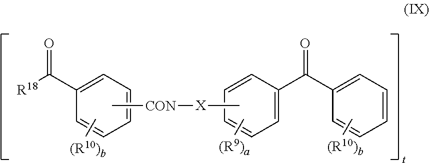

with R¹⁸ being selected from the group consisting of C₁-C₂₀ alkyl, viz. an alkyl moiety containing from 1 to 20 carbon atoms, aryl, heteroaryl, in particular methyl and ethyl, and of C₁-C₂₀-alkyloxy particularly methoxy and ethoxy;
R⁹ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
“a” being an integer ranging von 0 to 5,
R¹⁰ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
b being an integer ranging from 0 to 4,
X being a bond, oxygen or a group of formula NR¹¹, with R¹¹ being hydrogen or a moiety with 1 to 6 carbon atoms,
t having the numerals 1, 3/2, 2, 5/2, 3, 7/2, 4, 9/2, 5, 11/2, 6, 13/2 and 7, with the numerals 3/2, 5/2, 7/2, 9/2, 11/2, 13/2 meaning, that to each formula (IX) with t being an integer, there is connected either the entity on the right side of CON in formula (IX) with CON included or the entity on the left side of X in formula (IX) with X included,
CON being a bond or a connecting group,
said connecting group CON being selected from the group consisting of
entities containing from 1 to 2000 carbon atoms, preferably from 1 to 1000 carbon atoms and more preferably containing from 1 to 500 carbon atoms,
diamines, said diamines being selected from the group comprising, preferably consisting of ethylene diamine, 1,2-propylenediamine, α,ω-diaminoalkanes in particular 1,3-diaminopropane, 1,4-diaminobutane, 1,6-diaminohexane, 1,8-diaminooctane, 1,10-diaminodecane, 1,12-diaminododecane; 1,2-diamino-cyclohexane, 1,3-diamino-cyclohexane, 1,4-diamino-cyclohexane, 3,3′-dimethyl-4,4′diamino-dicyclohexylmethane, 4,4′-diaminodicyclohexylmethane, Baxxodur® ECX 210 which is a mixture of 2-methylcyclohexane-1,3-diamine [CAS registration no. 13897-56-8] and 4-methylcyclohexane-1,3-diamine [CAS registration no. 13897-55-7], isophorone diamine, 2,2-dimethylpropane-1,3-diamine, 1,2-phenylenediamine, 1,3-phenylenediamine, 1,4-phenylenediamine, 2,4-diaminotoluene, 2,6-diaminotoluene, 2,4-diaminopyridine, 2,6-diaminopyridine, diaminodiphenylmethane;
entities of formula (V)

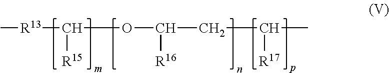

with R¹³ being a bond, an oxygen or sulfur atom or a group of the formula NR¹⁴, with R¹⁴ being an alkyl group comprising from 1 to 6 carbon atoms; R¹³ further being an O—CO—O— group, an NH—CO—O— group, an HN—CO—NH-group or a connecting alkyl group comprising from 1 to 20 carbon atoms,
R¹⁵, R¹⁶ and R¹⁷ being respectively hydrogen, methyl or ethyl,
m and p being an integer ranging from 0 to 2 respectively,
n being an integer ranging from 0 to 200, preferably from 1 to 100 and more preferably ranging from 1 to 50.

In order to further clarify the meaning of t, said index t having the numeral 3/2 is understood to represent an entity having one benzophenone moiety and two acetophenone moieties or two benzophenone moieties and one acetopheone moiety. The numeral t being 4 is understood to represent an entity having 4 benzophenone moieties and 4 acetophenone moieties. If t equals 9/2, this is meant to represent an entity having either 5 benzephenone moieties and 4 acetophenone moieties or 5 acetophenone moieties and 4 benzophenone moieties, respectively each of the previously mentioned benzophenone and/or acetophenone moieties being connected via the group —CON—X— to an adjacent benzophone moiety or acetopheonone moiety.

Said embodiment is particularly useful in case one wants to proceed for at least two consecutive crosslinking events. For the first step one selected wavelength of electromagnetic irradiation is taken in order to crosslink only the left part of formula (IX) with adjacent C—H-bonds or to insert only the left part of formula (IX) into adjacent C—H-bonds. In the second step a further distinct wavelength of electromagnetic irradiation is taken in order the proceed for an insertion of the right part into further distinct C—H-bonds.

In yet another preferred embodiment of the invention the at least one non-polymerizable photocrosslinker E is selected from the group of compounds represented by formula (X)

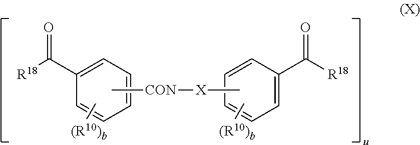

with R¹⁸ being selected from the group consisting of C₁-C₂₀ alkyl, viz. an alkyl moiety containing from 1 to 20 carbon atoms, aryl, heteroaryl, in particular methyl and ethyl, and of C₁-C₂₀-alkyloxy particularly methoxy and ethoxy;
R¹⁰ being hydrogen, halide, hydroxy and/or C₁-C₂₀-alkyl, viz. an alkyl moiety containing from 1 to 20 carbon atoms, C₁-C₂₀-alkyloxy as for instance methoxy or ethoxy,
b being an integer ranging from 0 to 4,
X being a bond, oxygen or a group of formula NR¹¹, with R¹¹ being hydrogen or a moiety with 1 to 6 carbon atoms,
u having the numerals 1, 3/2, 2, 5/2, 3, 7/2, 4, 9/2, 5, 11/2, 6, 13/2 and 7,
CON being a bond or a connecting group,
said connecting group CON being selected from the group consisting of
entities containing from 1 to 2000 carbon atoms, preferably from 1 to 1000 carbon atoms and more preferably containing from 1 to 500 carbon atoms.
diamines, said diamines being selected from the group comprising, preferably consisting of ethylene diamine, 1,2-propylenediamine, α,ω-diaminoalkanes in particular 1,3-diaminopropane, 1,4-diaminobutane, 1,6-diaminohexane, 1,8-diaminooctane, 1,10-diaminodecane, 1,12-diaminododecane; 1,2-diamino-cyclohexane, 1,3-diamino-cyclohexane, 1,4-diamino-cyclohexane, 3,3′-dimethyl-4,4′diamino-dicyclohexylmethane, 4,4′-diaminodicyclohexylmethane, Baxxodur® ECX 210 which is a mixture of 2-methylcyclohexane-1,3-diamine [CAS registration no. 13897-56-8] and 4-methylcyclohexane-1,3-diamine [CAS registration no. 13897-55-7], isophorone diamine, 2,2-dimethylpropane-1,3-diamine, 1,2-phenylenediamine, 1,3-phenylenediamine, 1,4-phenylenediamine, 2,4-diaminotoluene, 2,6-diaminotoluene, 2,4-diaminopyridine, 2,6-diaminopyridine, diaminodiphenylmethane;
entities of formula (V)

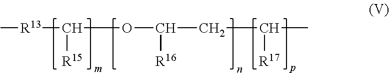

with R¹³ being a bond, an oxygen or sulfur atom or a group of the formula NR¹⁴, with R¹⁴ being an alkyl group comprising from 1 to 6 carbon atoms; R¹³ further being an O—CO—O— group, an NH—CO—O— group, an HN—CO—NH-group or a connecting alkyl group comprising from 1 to 20 carbon atoms,
R¹⁵, R¹⁶ and R¹⁷ being respectively hydrogen, methyl or ethyl,
m and p being an integer ranging from 0 to 2 respectively,
n being an integer ranging from 0 to 200, preferably from 1 to 100 and more preferably ranging from 1 to 50.

Said embodiment is mostly adapted for achieving a very dense and three-dimensional extended crosslinking or CH-insertion pattern, since the somewhat different sizes of the entities to the left and to the right of each carbonyl group in formula (X) permit to have small distances between crosslinking entities.

In order to further clarify the meaning of u, said index u having the numeral 3/2 is understood to represent an entity having 3 acetophenone moieties. The numeral u being 4 is understood to represent an entity having 8 acetophenone moieties and if u equals 9/2, this is meant to represent an entity having 9 acetophenone moieties, respectively each of the previously mentioned acetophenone moieties being connected via the group —CON—X— to an adjacent acetophone moiety.

Further linear viz. non-branched type non-polymerizable photocrosslinkers E are those of formulas (VIII, IX and X), wherein the at least one moiety being connected to the entity “X” and the at least one moiety being connected to the entity “CON” are respectively selected from the group comprising, preferably consisting of acetophenone, benzophenone, antraquinone, anthrone, fluorenone, acridone, xanthone, thioxanthone, or their ring substituted derivatives, diphenoxybenzophenone, 4,4′-bis(dimethylamino)benzophenone, 2,4,6-trimethylbenzophenone, 4-methylbenzophenone, 4-chlorobenzophenone, 4-phenylbenzophenone, 4,4′-bis(diethylamino)benzophenone, methyl-2-benzoylbenzoate, 3,3′-dimethyl-4-methoxybenzophenone, 4-(4-methylphenylthio)benzophenone, 2,4,6-trimethyl-4′-phenylbenzophenone, 3-methyl-4′-phenyl-benzophenone, 2-methylbenzophenone, 2-methoxycarbonylbenzophenone, 4-chlorobenzophenone, 4-phenylbenzophenone, 4,4′-bis(dimethylamino)benzophenone, 3,3′-dimethyl-4-methoxybenzophenone, 4-(4-methylphenylthio)benzophenone, as well as camphor chinone, 1,2-diphenylethane-1,2-dione also referred to as benzil, 1-phenylpropane-1,2-dione, diphenyl-2,4,6-trimethylbenzoylphosphinoxide, bis(2,4,6-trimethylbenzoyl)-phenylphosphinoxide, bis(2,6-dimethoxybenzoyl)-2,4,4-trimethylpentylphosphinoxide, 1-hydroxycyclohexylphenylketone, 2-hydroxy-2-methyl-1-phenyl-1-propanone, 2-hydroxy-1-[4-(2-hydroxyethoxy)phenyl]-2-methyl-1-propanone, 2-methyl-1-[4-(methylthio)phenyl]-2-(4-morpholinyl)-1-propanone, benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanon and 2-benzyl-2-(dimethylamino)-1-[3,4-dimethoxyphenyl]-1 butanone or mixtures thereof.

Besides the previously mentioned linear non-polymerizable photocrosslinkers E, in another embodiment, the non-polymerizable photocrosslinker E has a branched structure. Branched means that a linking group L, L² or L³ has binding sites for at least three photoactivatable groups.

Thus further crosslinkers E are considered to be those of formula XI,

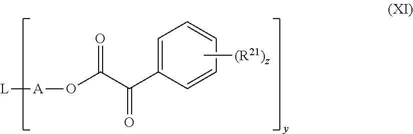

with
L being a linking group;
each A being independently selected from
   a bond;
   an alkylene group which may be interrupted by one or more heteroatoms or heteroatom groups selected from O, S, SO, SO₂ and NR²², where in case that the alkylene group is interrupted by two or more O, these are not adjacent, and/or may carry one or more substituents selected from OR²⁴, NR²²R²³, C(O)R²⁵, C(O)OR²⁴, C(O)NR²²R²³, OC(O)R²⁵, NR²²C(O)R²⁵, SR²⁴, C(S)R²⁵, C(S)SR²⁴ and C(S)NR²²R²³;
   a cycloalkylene group which may carry one or more substituents selected from C₁-C₄-alkyl, OR²⁴, NR²²R²³, C(O)R²⁵, C(O)OR²⁴, C(O)NR²²R²³, OC(O)R²⁵, NR²²C(O)R²⁵, SR²⁴, C(S)R²⁵, C(S)SR²⁴ and C(S)NR²²R²³;
   an arylene group which may carry 1, 2, 3, 4 or 5 substituents selected from C₁-C₄-alkyl, OR²⁴, NR²²R²³, C(O)R²⁵, C(O)OR²⁴, C(O)NR²²R²³, OC(O)R²⁵ and NR²²C(O)R²⁵; and
   a saturated, partially or maximally unsaturated heterocyclylene group containing 1, 2, 3 or 4 heteroatoms or heteroatom groups selected from O, N, S, SO, SO₂, C(O) or C(S) as ring members, where the heterocyclylene group may carry one or more substituents selected from C₁-C₄-alkyl, OR²⁴, NR²²R²³, C(O)R²⁵, C(O)OR²⁴, C(O)NR²²R²³, OC(O)R²⁵ and NR²²C(O)R²⁵;
   where the alkylene, cycloalkylene, arylene or heterocyclylene group A may be bonded to the linking group L via a group O, S, SO, SO₂, NR²², C(O), C(O)O or OC(O);
each R²¹ being independently selected from halogen, cyano, azido, nitro, —SCN, —SF₅, C₁-C₄-alkyl, C₁-C₄-haloalkyl, C₃-C₈-cycloalkyl, C₃-C₈-halocycloalkyl, C₂-C₄-alkenyl, C₂-C₄-haloalkenyl, C₂-C₄-alkynyl, C₂-C₄-haloalkynyl, OR²⁴, —S(O)_{¥}R²⁴, S(O)₃⁻(M^{a+})_{1/a}, NR²²R²³, C(O)R²⁵, C(O)OR²⁴, C(O)NR²²R²³, OC(O)R²⁵, NR²²C(O)R²⁵, phenyl which may be substituted by 1, 2, 3, 4 or 5 radicals R²⁶, and a 3-, 4-, 5-, 6-7- or 8-membered saturated, partially unsaturated or maximally unsaturated heterocyclic ring containing 1, 2, 3 or 4 heteroatoms or heteroatom groups selected from N, O, S, NO, SO and SO₂ as ring members, where the heterocyclic ring may be substituted by one or more radicals R²⁶;
R²² and R²³, independently of each other and independently of each occurrence, being selected from hydrogen, C₁-C₄-alkyl, C₁-C₄-haloalkyl, C₃-C₈-cycloalkyl, C₃-C₈-halocycloalkyl, C₁-C₄-alkoxy, C₁-C₄-haloalkoxy, C(O)R²⁵, C(O)OR²⁴, phenyl and benzyl;
each R²⁴ being independently selected from hydrogen, C₁-C₄-alkyl, C₁-C₄-haloalkyl, C₃-C₈-cycloalkyl, C₃-C₈-halocycloalkyl, phenyl and benzyl;
each R²⁵ being independently selected from hydrogen, C₁-C₄-alkyl, phenyl and benzyl;
each R²⁶ being independently selected from halogen, cyano, C₁-C₄-alkyl, C₁-C₄-haloalkyl, C₁-C₄-alkoxy and C₁-C₄-haloalkoxy;
(M^{a+})_{1/a} being a metal equivalent or an optionally substituted ammonium cation;
z being 0, 1, 2, 3, 4 or 5;
y being from 3 to 8; and
¥ being 0, 1, 2 or 3

L is an n-valent linking group. Preferably, L is the scaffold of an aliphatic, cycloaliphatic, aromatic, mixed aliphatic-cycloaliphatic, aliphatic-aromatic or aromatic-cycloaliphatic molecule. The molecule on which L is based may carry one or more substituents.

To better illustrate the meaning of L, it has to be mentioned that the compound of formula XI is obtainable by reacting a compound L-[A-OH]_{y}, wherein L, A and y are as defined above, with a phenylglyoxylic acid XII

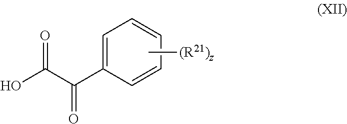

or a derivative thereof.

L is thus derived from a polyol, to be more precise from a polyol of formula L-[A-OH]_{y}, wherein L, A and y are as defined above. Thus, L is the scaffold of a polyol L-[A-OH]_{y}.

Preferably, the polyol L-[A-OH]_{y} is selected from glycerol, trimethylolethane (1,1,1-tris(hydroxymethyl)ethane), trimethylolpropane (1,1,1-tris(hydroxymethyl)propane), pentaerythritol, dipentaerythritol, sugar alcohols and saccharides, wherein a part or all of the OH groups of these compounds may be alkoxylated, preferably ethoxylated. More preferably, the polyol L-[A-OH]ₙ is selected from glycerol, trimethylolethane (1,1,1-tris(hydroxymethyl)ethane), trimethylolpropane (1,1,1-tris(hydroxymethyl)propane), pentaerythritol, dipentaerythritol, sugar alcohols and saccharides, wherein a part or, preferably, all of the OH groups of these compounds are alkoxylated, preferably ethoxylated, preferably each OH group being ethoxylated with 1 to 30, preferably 3 to 30 and in particular with 3 to 10 EO on average.

“Alkoxylated” means that a part or all of the OH groups have reacted with an alkylene oxide, such as ethylene oxide (EO), 1,2-propylene oxide (PO) or 1,2-butylene oxide, preferably with ethylene oxide (EO) or 1,2-propylene oxide (PO) or a mixture of EO and PO, to give the corresponding alcohol ether. In case that EO is used, the resulting compound is called “ethoxylated”. In case that PO is used, the resulting compound is called “propoxylated”.

Sugar alcohols are the reduced forms of saccharides, especially of monosaccharides, in which the aldehyde group is reduced to an alcohol group. Preferred sugar alcohols are selected from erythritol, threitol, arabitol, xylitol, ribitol, sorbitol, mannitol, galactitol, fucitol, iditol and inositol, and specifically from sorbitol.

Saccharides are preferably monosaccharides, both aldoses and ketoses, such as erythrose, threose, ribose, arabinose, xylose, lyxose, allose, altrose, glucose, mannose, gulose, idose, galactose, talose, erythrulose, ribulose, xylulose, fructose, psicose, sorbose or tagatose.

If the polyol L-[A-OH]_{y} has more than three OH groups, for example if y is greater than 3 or if L contains other OH groups not explicitly shown in the above formula, not all of these OH groups need to react with the glyoxylic acid (derivative) XII, however with the proviso that 3 to 8 OH groups (if as much are present) react.

Thus, by way of example, if L-[A-OH]_{y} is glycerol or an alkoxylated derivative thereof (i.e. wherein a part or all of the OH groups are alkoxylated), L (in L-[A-OH]_{y} as well as in compound XI resulting therefrom) is *CH₂—*CH—*CH₂, if L-[A-OH]_{y} is trimethylolethane or an alkoxylated derivative thereof, L is CH₃—C(*CH₂)(*CH₂)(*CH₂), if L-[A-OH]_{y} is trimethylolpropane or an alkoxylated derivative thereof, L is CH₃—CH₂—C(*CH₂)(*CH₂)(*CH₂), if L-[A-OH]_{y} is pentaerythritol or an alkoxylated derivative thereof, L is C(*CH₂)₄ or C(*CH₂)₃(CH₂OH), wherein the OH group may be alkoxylated, if L-[A-OH]_{y} is dipentaerythritol or an alkoxylated derivative thereof, L is O[CH₂CH(*CH₂)₃]₂ or O[CH₂CH(*CH₂)₃][CH₂CH(CH₂OH)₃] or O[CH₂CH(*CH₂)₂(CH₂OH)]₂ or O[CH₂CH(*CH₂)₃][CH₂CH(*CH₂)(CH₂OH)₂] or O[CH₂CH(*CH₂)₃][CH₂CH(*CH₂)₂(CH₂OH)], wherein the OH group(s) may be alkoxylated, if L-[A-OH]_{y} is sorbitol or an alkoxylated derivative thereof, L is *CH₂(*CH)₄*CH₂ or *CH₂(*CH)₂(CHOH)₂CH₂OH or *CH₂(CHOH)(*CH)₂(CHOH)CH₂OH or *CH₂(CHOH)₂(*CH)₂CH₂OH or *CH₂(CHOH)₃(*CH)*CH₂ or *CH₂(CHOH)(*CH)(CHOH)₂*CH₂ or CH₂OH(*CH)₃(CHOH)CH₂OH or CH₂OH(*CH)(CHOH)(*CH)₂CH₂OH, etc., wherein the OH group(s) may be alkoxylated, and so on. The asterisk * denotes the carbon atoms via which L is linked to the y groups A.

More preferably, the polyol compound L-[A-OH]_{y} is selected from glycerol, trimethylolethane, trimethylolpropane, pentaerythritol, dipentaerythritol and sugar alcohols, preferably, the above-listed preferred sugar alcohols, wherein a part or all of the OH groups of these compounds may be alkoxylated, preferably ethoxylated. Even more preferably, the polyol compound L-[A-OH]_{y} is selected from glycerol, trimethylolethane, trimethylolpropane, pentaerythritol, dipentaerythritol and sugar alcohols, preferably, the above-listed preferred sugar alcohols, wherein a part or, preferably, all of the OH groups of these compounds are alkoxylated, preferably ethoxylated, preferably each OH group being ethoxylated with 1 to 20, preferably 3 to 30 and in particular with 3 to 10 EO on average.

In particular, the polyol compound L-[A-OH]_{y} is selected from glycerol and sorbitol, wherein a part or all of the OH groups of these compounds may be alkoxylated, preferably ethoxylated, and specifically from glycerol and sorbitol, wherein the OH groups of these compounds are alkoxylated, preferably ethoxylated, preferably each OH group being ethoxylated with 1 to 20, preferably 3 to 20 and in particular with 3 to 10 EO on average.

Further non-polymerizable photocrosslinkers E are also those of formula (XIII)

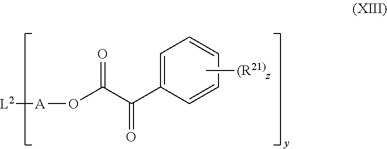

with the moiety L² being selected from the group comprising, preferably consisting of acetophenone, benzophenone, antraquinone, anthrone, fluorenone, acridone, xanthone, thioxanthone, or their ring substituted derivatives, diphenoxybenzophenone, 4,4′-bis(dimethylamino)benzophenone, 2,4,6-trimethylbenzophenone, 4-methylbenzophenone, 4-chlorobenzophenone, 4-phenylbenzophenone, 4,4′-bis(diethylamino)benzophenone, methyl-2-benzoylbenzoate, 3,3′-dimethyl-4-methoxybenzophenone, 4-(4-methylphenylthio)benzophenone, 2,4,6-trimethyl-4′-phenylbenzophenone, 3-methyl-4′-phenyl-benzophenone, 2-methylbenzophenone, 2-methoxycarbonylbenzophenone, 4-chlorobenzophenone, 4-phenylbenzophenone, 4,4′-bis(dimethylamino)benzophenone, 3,3′-dimethyl-4-methoxybenzophenone, 4-(4-methylphenylthio)benzophenone, as well as camphor chinone, 1,2-diphenylethane-1,2-dione also referred to as benzil, 1-phenylpropane-1,2-dione, diphenyl-2,4,6-trimethylbenzoylphosphinoxide, bis(2,4,6-trimethylbenzoyl)-phenylphosphinoxide, bis(2,6-dimethoxybenzoyl)-2,4,4-trimethylpentylphosphinoxide, 1-hydroxycyclohexylphenylketone, 2-hydroxy-2-methyl-1-phenyl-1-propanone, 2-hydroxy-1-[4-(2-hydroxyethoxy)phenyl]-2-methyl-1-propanone, 2-methyl-1-[4-(methylthio)phenyl]-2-(4-morpholinyl)-1-propanone, benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanon and 2-benzyl-2-(dimethylamino)-1-[3,4-dimethoxyphenyl]-1-butanone groups or mixtures thereof and said moiety L² being able to form a bond with 1, 2, 3, 4, 5, 6, 7 or 8 entities of the following structure (XIIIa)

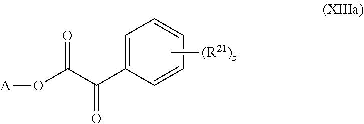

each A being independently selected from
   a bond;
   an alkylene group which may be interrupted by one or more heteroatoms or heteroatom groups selected from O, S, SO, SO₂ and NR²², where in case that the alkylene group is interrupted by two or more O, these are not adjacent, and/or may carry one or more substituents selected from OR²⁴, NR²²R²³, C(O)R²⁵, C(O)OR²⁴, C(O)NR²²R²³, OC(O)R²⁵, NR²²C(O)R²⁵, SR²⁴, C(S)R²⁵, C(S)SR²⁴ and C(S)NR²²R²³;
   a cycloalkylene group which may carry one or more substituents selected from C₁-C₄-alkyl, OR²⁴, NR²²R²³, C(O)R²⁵, C(O)OR²⁴, C(O)NR²²R²³, OC(O)R²⁵, NR²²C(O)R²⁵, SR²⁴, C(S)R²⁵, C(S)SR²⁴ and C(S)NR²²R²³;
   an arylene group which may carry 1, 2, 3, 4 or 5 substituents selected from C₁-C₄-alkyl, OR²⁴, NR²²R²³, C(O)R²⁵, C(O)OR²⁴, C(O)NR²²R²³, OC(O)R²⁵ and NR²²C(O)R²⁵; and
   a saturated, partially or maximally unsaturated heterocyclylene group containing 1, 2, 3 or 4 heteroatoms or heteroatom groups selected from O, N, S, SO, SO₂, C(O) or C(S) as ring members, where the heterocyclylene group may carry one or more substituents selected from C₁-C₄-alkyl, OR²⁴, NR²²R²³, C(O)R²⁵, C(O)OR²⁴, C(O)NR²²R²³, OC(O)R²⁵ and NR²²C(O)R²⁵;
   where the alkylene, cycloalkylene, arylene or heterocyclylene group A may be bonded to the linking group L via a group O, S, SO, SO₂, NR²², C(O), C(O)O or OC(O);
each R²¹ being independently selected from halogen, cyano, azido, nitro, —SCN, —SF₅, C₁-C₄-alkyl, C₁-C₄-haloalkyl, C₃-C₈-cycloalkyl, C₃-C₈-halocycloalkyl, C₂-C₄-alkenyl, C₂-C₄-haloalkenyl, C₂-C₄-alkynyl, C₂-C₄-haloalkynyl, OR²⁴, —S(O)_{¥}R²⁴, S(O)₃⁻(M^{a+})_{1/a}, NR²²R²³, C(O)R²⁵, C(O)OR²⁴, C(O)NR²²R²³, OC(O)R²⁵, NR²²C(O)R²⁵, phenyl which may be substituted by 1, 2, 3, 4 or 5 radicals R²⁶, and a 3-, 4-, 5-, 6-7- or 8-membered saturated, partially unsaturated or maximally unsaturated heterocyclic ring containing 1, 2, 3 or 4 heteroatoms or heteroatom groups selected from N, O, S, NO, SO and SO₂ as ring members, where the heterocyclic ring may be substituted by one or more radicals R²⁶;
R²² and R²³, independently of each other and independently of each occurrence, being selected from hydrogen, C₁-C₄-alkyl, C₁-C₄-haloalkyl, C₃-C₈-cycloalkyl, C₃-C₈-halocycloalkyl, C₁-C₄-alkoxy, C₁-C₄-haloalkoxy, C(O)R²⁵, C(O)OR²⁴, phenyl and benzyl;
each R²⁴ being independently selected from hydrogen, C₁-C₄-alkyl, C₁-C₄-haloalkyl, C₃-C₈-cycloalkyl, C₃-C₈-halocycloalkyl, phenyl and benzyl;
each R²⁵ being independently selected from hydrogen, C₁-C₄-alkyl, phenyl and benzyl;
each R²⁶ being independently selected from halogen, cyano, C₁-C₄-alkyl, C₁-C₄-haloalkyl, C₁-C₄-alkoxy and C₁-C₄-haloalkoxy;
(M^{a+})_{1/a} being a metal equivalent or an optionally substituted ammonium cation;
z being 0, 1, 2, 3, 4 or 5;
y being from 3 to 8; and
¥ being 0, 1, 2 or 3

Yet other non-polymerizable photocrosslinkers of formula E are selected from the molecules represented by formula (XIV)

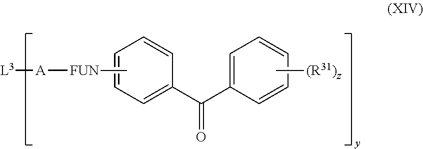

with
L³ being a linking group;
each A being independently selected from
   a bond;
   O, NH, carboxy, oxocarbonyl, amido, carbamato, ureido,
   an alkylene group of 1 to 10 carbon atoms which may be interrupted by one or more heteroatoms or heteroatom groups selected from O, S, SO, SO₂ and NR³², where in case that the alkylene group is interrupted by two or more O, these are not adjacent, and/or may carry one or more substituents selected from OR³⁴, NR³²R³³, C(O)R³⁵, C(O)OR³⁴, C(O)NR³²R³³, OC(O)R³⁵, NR³²C(O)R³⁵, SR³⁴, C(S)R³⁵, C(S)SR³⁴ and C(S)NR³²R³³;
   a cycloalkylene group which may carry one or more substituents selected from C₁-C₄-alkyl, OR³⁴, NR³²R³³, C(O)R³⁵, C(O)OR³⁴, C(O)NR³²R³³, OC(O)R³⁵, NR³²C(O)R³⁵, SR³⁴, C(S)R³⁵, C(S)SR³⁴ and C(S)NR³²R³³;
   an arylene group which may carry 1, 2, 3, 4 or 5 substituents selected from C₁-C₄-alkyl, OR³⁴, NR³²R³³, C(O)R³⁵, C(O)OR³⁴, C(O)NR³²R³³, OC(O)R³⁵ and NR³²C(O)R³⁵; and
   a saturated, partially or maximally unsaturated heterocyclylene group containing 1, 2, 3 or 4 heteroatoms or heteroatom groups selected from O, N, S, SO, SO₂, C(O) or C(S) as ring members, where the heterocyclylene group may carry one or more substituents selected from C₁-C₄-alkyl, OR³⁴, NR³²R³³, C(O)R³⁵, C(O)OR³⁴, C(O)NR³²R³³, OC(O)R³⁵ and NR³²C(O)R³⁵;
   where the alkylene, cycloalkylene, arylene or heterocyclylene group A may be bonded to the linking group L via a group O, S, SO, SO₂, NR³², C(O), C(O)O or OC(O);
FUN being selected from the group comprising, preferably consisting of a bond, C₁-C₄-alkyloxy, viz. methoxy, ethoxy, propoxy, isopropoxy, butoxy, isobutoxy, tert.butoxy, C₁-C₄-alkyl, viz. methyl, ethyl, propoyl, isopropoyl, butyl, isobuty, tert.-butyl, amino, C₁-C₄-alkylamino, viz. methylamino, ethylamino, propylamino, isopropylamino, butylamino, isobutylamino, tert.-butylamino, C₁-C₄-dialkylamino, viz. dimethylamino, methylethylamino, methylpropylamino, methylisopropylamino, methylbutylamino, methylsec.-butylamino, methyltert.-butylamino, diethylamino, ethylpropylamino, ethylisopropylamino, ethyltert.-butylamino, dipropylamino, propylisopropylamino, diisopropylamino, propylbutylamino, propyl-isobutylamino, propyl-tert.butylamino, isopropyl-butylamino, isopropyl-sec.-butylamino, isopropyl-tert.butylamino, dibutylamino, butylsec.-butylamino, butyltert.-butylamino, disec.butylamino, sec.-butyltert.-butylamino, ditert.-butylamino, carboxy, C₁-C₄-alkylcarboxy, viz. methylcarboxy, ethylcarboxy, propylcarboxy, isopropylcarboxy, butylcarboxy, isobutylcarboxy, tert.-butylcarboxy, oxocarbonyl, oxocarbonylalkyl viz. oxocarbonylmethyl, oxocarbonylethyl, oxocarbonylpropyl, oxocarbonylisopropyl, oxocarbonylbutyl, oxocarbonylsec.-butyl, oxocarbonyltert.-butyl, carbonyl, carbonylalkyl viz. carbonylmethyl, carbonylethyl, carbonylpropoyl, carbonylisopropyl, carbonylbutyl, carbonylisobutyl, carbonyltert.-butyl, amido, amidoalkyl viz. amidomethyl, amidoethyl, amidopropyl, amidoisopropyl, amidobutyl, amidosec.-butyl, amidotert.butyl, glycidyl, —CH₂—CH(OH)—CH₂—O—, carbamato meaning the entity H₂N—(C═O)—O— and —HN—(C═O)—O— as well as the O-monoalkylated or N-mono- and dialkylated forms thereof with alkylated to be understood as comprising a methylene, ethylene, propylene, isopropylene, butuylene, isobutylene, tert-butylene or methyl, ethyl propyl, isopropyl, butyl, isobutyl or tert.-butyl moiety,

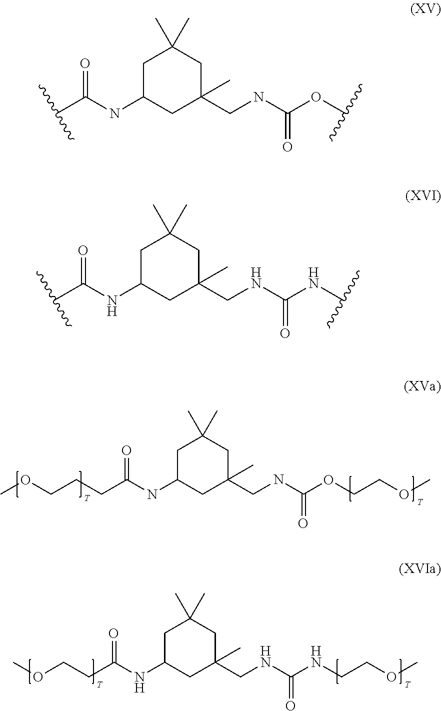

O, S, SO, S0₂, NR³⁷ with R³⁷ being a hydrogen atom or an alkyl, aryl or arylalkyl group.
each R³¹ being independently selected from hydrogen, hydroxy, halogen, cyano, azido, nitro, —SCN, —SF₅, C₁-C₄-alkyl, C₁-C₄-alkylhydroxy, C₁-C₄-alkylamino, C₁-C₄-aminoalkyl, C₁-C₄-haloalkyl, C₃-C₈-cycloalkyl, C₃-C₈-halocycloalkyl, C₂-C₄-alkenyl, C₂-C₄-haloalkenyl, C₂-C₄-alkynyl, C₂-C₄-haloalkynyl, OR³⁴, —S(O)_{¥}R³⁴, S(O)₃⁻(M^{a+})_{1/a}, NR³²R³³, C(O)R³⁵, C(O)OR³⁴, C(O)NR³²R³³, OC(O)R³⁵, NR³²C(O)R³⁵, phenyl which may be substituted by 1, 2, 3, 4 or 5 radicals R³⁶, and a 3-, 4-, 5-, 6-7- or 8-membered saturated, partially unsaturated or maximally unsaturated heterocyclic ring containing 1, 2, 3 or 4 heteroatoms or heteroatom groups selected from N, O, S, NO, SO and SO₂ as ring members, where the heterocyclic ring may be substituted by one or more radicals R³⁶;
R³² and R³³, independently of each other and independently of each occurrence, being selected from hydrogen, C₁-C₄-alkyl, C₁-C₄-haloalkyl, C₃-C₈-cycloalkyl, C₃-C₈-halocycloalkyl, C₁-C₄-alkoxy, C₁-C₄-haloalkoxy, C(O)R³⁵, C(O)OR³⁴, phenyl and benzyl;
each R³⁴ being independently selected from hydrogen, C₁-C₄-alkyl, C₁-C₄-haloalkyl, C₃-C₈-cycloalkyl, C₃-C₈-halocycloalkyl, phenyl and benzyl;
each R³⁵ being independently selected from hydrogen, C₁-C₄-alkyl, phenyl and benzyl;
each R³⁶ being independently selected from halogen, cyano, C₁-C₄-alkyl, C₁-C₄-haloalkyl, C₁-C₄-alkoxy and C₁-C₄-haloalkoxy;
(M^{a+})_{1/a} being a metal equivalent or an optionally substituted ammonium cation;
z being 0, 1, 2, 3, 4 or 5;
y being from 3 to 8; and
¥ being 0, 1, 2 or 3
T respectively being 0 to 30, more preferably 0 to 10 and most preferably being 0, 1, 2, 3, 4 or 5

The linking group L³ is an n-valent linking group. Preferably, L³ is the scaffold of an aliphatic, cycloaliphatic, aromatic, mixed aliphatic-cycloaliphatic, aliphatic-aromatic or aromatic-cycloaliphatic molecule. The molecule on which L³ is based may carry one or more substituents.

To better illustrate the meaning of L³, it has to be mentioned that the compound of formula XIV is obtainable by reacting a compound L³-[A-OH]_{y} or L³-[A-NCO]_{y} or L³-[A-NR^{ψ}R^{φ}]_{y}, or L³-[A-FUN—NCO]_{y} or L³-[A-FUN]_{y} wherein A, FUN and y are as defined above, ψ being selected from the group of H, methyl, ethyl, propyl, isopropyl, butyl, isobutyl or tert.-butyl, φ being selected from the group of H, methyl, ethyl, propyl, isopropyl, butyl, isobutyl or tert.-butyl, with an activated benzophenone of formula XVII or of formula XVIII

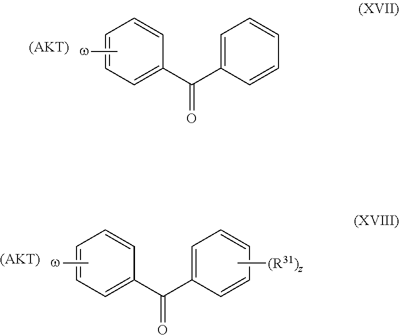

with z and R³¹ as identified supra;
with AKT being an entity selected from the group comprising, preferably consisting of haloalkyl with alkyl meaning methyl or ethyl or propyl or isopropyl or butyl or sec.-butyl, or tert.-butyl, more preferably bromoalkyl and most preferably bromomethyl, bromoethyl, bromopropyl or bromoisopropyl; further carboxyl, chlorocarbonyl, amino, amido, hydroxyl, hydroxymethyl, hydroxyethyl, hydroxypropyl, hydroxyisopropyl, hydroxybutyl, hydroxyisobutyl, hydroxytert.-butyl,
ω being 1, 2, 3, 4 or 5,
or a derivative thereof.

L³ in a first embodiment is thus derived from a polyol, to be more precise from a polyol of formula L³-[A-OH]_{y}, wherein L³, A and y are as defined above. Thus, L³ is the scaffold of a polyol L³-[A-OH]y.

Preferably, the polyol L³-[A-OH]_{y} is selected from glycerol, trimethylolethane (1,1,1-tris(hydroxymethyl)ethane), trimethylolpropane (1,1,1-tris(hydroxymethyl)propane), pentaerythritol, dipentaerythritol, sugar alcohols and saccharides, wherein a part or all of the OH groups of these compounds may be alkoxylated, preferably ethoxylated. More preferably, the polyol L³-[A-OH]_{y} is selected from glycerol, trimethylolethane (1,1,1-tris(hydroxymethyl)ethane), trimethylolpropane (1,1,1-tris(hydroxymethyl)propane), pentaerythritol, dipentaerythritol, sugar alcohols and saccharides, wherein a part or, preferably, all of the OH groups of these compounds are alkoxylated, preferably ethoxylated, preferably each OH group being ethoxylated with 1 to 30, preferably 3 to 30 and in particular with 3 to 10 EO on average.

“Alkoxylated” means that a part or all of the OH groups have reacted with an alkylene oxide, such as ethylene oxide (EO), 1,2-propylene oxide (PO) or 1,2-butylene oxide, preferably with ethylene oxide (EO) or 1,2-propylene oxide (PO) or a mixture of EO and PO, to give the corresponding alcohol ether. In case that EO is used, the resulting compound is called “ethoxylated”. In case that PO is used, the resulting compound is called “propoxylated”.

Sugar alcohols are the reduced forms of saccharides, especially of monosaccharides, in which the aldehyde group is reduced to an alcohol group. Preferred sugar alcohols are selected from erythritol, threitol, arabitol, xylitol, ribitol, sorbitol, mannitol, galactitol, fucitol, iditol and inositol, and specifically from sorbitol.

Saccharides are preferably monosaccharides, both aldoses and ketoses, such as erythrose, threose, ribose, arabinose, xylose, lyxose, allose, altrose, glucose, mannose, gulose, idose, galactose, talose, erythrulose, ribulose, xylulose, fructose, psicose, sorbose or tagatose.

If the polyol L³-[A-OH]_{y} has more than three OH groups, for example if y is greater than 3 or if L³ contains other OH groups not explicitly shown in the above formula, not all of these OH groups need to react with the activated benzophenone of formula XVII or XVIII, however with the proviso that 3 to 8 OH groups (if as much are present) react.

Thus, by way of example, if L³-[A-OH]_{y} is glycerol or an alkoxylated derivative thereof (i.e. wherein a part or all of the OH groups are alkoxylated), L³ (in L³-[A-OH]_{y} as well as in compound XIV resulting therefrom) is *CH₂—*CH—*CH₂, if L³-[A-OH]_{y} is trimethylolethane or an alkoxylated derivative thereof, L³ is CH₃—C(*CH₂)(*CH₂)(*CH₂), if L³-[A-OH]_{y} is trimethylolpropane or an alkoxylated derivative thereof, L³ is CH₃—CH₂—C(*CH₂)(*CH₂)(*CH₂), if L³-[A-OH]_{y} is pentaerythritol or an alkoxylated derivative thereof, L³ is C(*CH₂)₄ or C(*CH₂)₃(CH₂OH), wherein the OH group may be alkoxylated, if L³-[A-OH]_{y} is dipentaerythritol or an alkoxylated derivative thereof, L³ is O[CH₂CH(*CH₂)₃]₂ or O[CH₂CH(*CH₂)₃][CH₂CH(CH₂OH)₃] or O[CH₂CH(*CH₂)₂(CH₂OH)]₂ or O[CH₂CH(*CH₂)₃][CH₂CH(*CH₂)(CH₂OH)₂] or O[CH₂CH(*CH₂)₃][CH₂CH(*CH₂)₂(CH₂OH)], wherein the OH group(s) may be alkoxylated, if L³-[A-OH]_{y} is sorbitol or an alkoxylated derivative thereof, L³ is *CH₂(*CH)₄*CH₂ or *CH₂(*CH)₂(CHOH)₂CH₂OH or *CH₂(CHOH)(*CH)₂(CHOH)CH₂OH or *CH₂(CHOH)₂(*CH)₂CH₂OH or *CH₂(CHOH)₃(*CH)*CH₂ or *CH₂(CHOH)(*CH)(CHOH)₂*CH₂ or CH₂OH(*CH)₃(CHOH)CH₂OH or CH₂OH(*CH)(CHOH)(*CH)₂CH₂OH, etc., wherein the OH group(s) may be alkoxylated, and so on. The asterisk * denotes the carbon atoms via which L³ is linked to the y groups A.

More preferably, the polyol compound L-[A-OH]_{y} is selected from glycerol, trimethylolethane, trimethylolpropane, pentaerythritol, dipentaerythritol and sugar alcohols, preferably, the above-listed preferred sugar alcohols, wherein a part or all of the OH groups of these compounds may be alkoxylated, preferably ethoxylated. Even more preferably, the polyol compound L-[A-OH]_{y} is selected from glycerol, trimethylolethane, trimethylolpropane, pentaerythritol, dipentaerythritol and sugar alcohols, preferably, the above-listed preferred sugar alcohols, wherein a part or, preferably, all of the OH groups of these compounds are alkoxylated, preferably ethoxylated, preferably each OH group being ethoxylated with 1 to 20, preferably 3 to 30 and in particular with 3 to 10 EO on average.

In particular, the polyol compound L-[A-OH]_{y} is selected from glycerol and sorbitol, wherein a part or all of the OH groups of these compounds may be alkoxylated, preferably ethoxylated, and specifically from glycerol and sorbitol, wherein the OH groups of these compounds are alkoxylated, preferably ethoxylated, preferably each OH group being ethoxylated with 1 to 20, preferably 3 to 20 and in particular with 3 to 10 EO on average.

L³ in a second embodiment is thus derived from a polyamine, to be more precise from a polyamine of formula L³-[A-NH₂]y, wherein A and y are as defined above. Thus, L³ is the scaffold of a polyamine L³-[A-NH₂]y.

In particular the polyamine compound L³-[A-NH₂]y is selected from the group consisting of aliphatic oligoamines, in particular diethylenetriamine, dipropylene triamine, N,N-bis-(3-aminopropyl)methylamine, 3-(2-aminoethylamino)propylamine, N,N′-bis-(3-aminopropyl) ethylene diamine, 1,2,3-triaminocyclohexane, 1,2,4-triaminocyclohexane, 4-methylcyclohexane-1,3,5-triamine, polyetheramines, in particular 4,7,10-trioxatridecane-1,13-diamine, 4,9-dioxadodecane-1,12-diamine, polyetheramine T403 having the CAS registration no. 39423-51-3, polyetheramine T5000 having the CAS registration no. 64852-22-8, aromatic amines selected from the group comprising, preferably consisting of 1,2,3-triaminobenzene, 1,2,4-triaminobenzene, 2,4,6,-triaminopyridine, 2,3,6-triaminopyridine, 2,4,6-triaminotoluene, 2,4,6-triaminopyrimidine.

L³ in a third embodiment is derived from a polyisocyanate and in particular from a polyisocyanurate.

In a preferred embodiment deriving from a polyisocyante L³ is represented by formula XIX below.

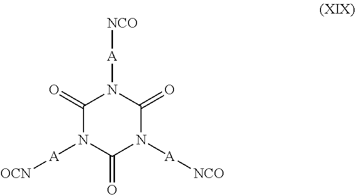

with A as defined previously, preferably being a linear alkylene group of 1 to 10 carbon atoms and most preferably being a hexamethylene group.

In another likewise preferred embodiment, L³ is an entity of formula XIX converted into an oligomer (also named precondensate) by means of partially reacting it with a diol selected from the group comprising, preferably consisting of glycerol, 1,2-propandiol, 1,3-propandiol, 1,4-butandiol, 1,6-hexandiol. Partially reacting is understood to only convert a portion of the NCO groups in the isocyanurate into corresponding urethane moieties.

From all the non-polymerizable photocrosslinkers E previously outlined those of formula VIII, XI and XIV are preferred. Thus in another embodiment of the invention the copolymer preparation comprises a copolymer, preferably an inventive copolymer comprising monomer A, monomer B, optionally monomer C, optionally monomer D and at least one non-polymerizable photocrosslinker E, said non-polymerizable photocrosslinker E being selected from the group consisting of compounds represented by formula VIII, XI and XIV.

In a further characterized embodiment of the invention the copolymer preparation of the invention comprises a copolymer, preferably an inventive copolymer, comprising monomer A, monomer B, optionally monomer C, optionally monomer D and at least one non-polymerizable photocrosslinker E, with said at least one non-polymerizable photocrosslinker E being used in an amount ranging from 0.01 to 30% by weight, preferably in an amount ranging from 0.1 to 20% by weight, even more preferably in an amount ranging from 0.5 to 15% by weight, in particular ranging from 1 to 10% by weight and especially ranging from 3 to 7% by weight, based on the overall weight of the copolymer contained in the copolymer preparation.

Another embodiment of the invention provides a hydrogel comprising an (inventive) copolymer inclusive of monomer D, or an (inventive) copolymer preparation and water, with both the (inventive) copolymer inclusive of monomer D, and the (inventive) copolymer preparation, respectively, being crosslinked.

Copolymers comprising monomer D or copolymer preparations comprising the non-polymerizable photocrosslinker E and optionally monomer D are ready for being applied onto a substrate. This is most convenient in order to obtain another embodiment of the invention. Said embodiment is a hydrogel comprising an (inventive) copolymer inclusive of monomer D, or an (inventive) copolymer preparation, as well as a substrate attached thereto, said substrate having a surface comprising at least one C—H-bond, preferably said surface consisting of C—H-bonds. Once the copolymer comprising monomer D being subjected to the substrate or the copolymer preparation being subjected to the substrate, and photoirradiation by means of UV light being realized, an embodiment will form which exhibits a large surface, since the copolymers per se are crosslinked and they are further attached to the substrate. Said large surface is either prone to instantly adsorb humidity from the air thus forming the hydrogel of the invention or is to be subjected to an aqueous environment in order to get it hydrated thus forming the hydrogel of the invention. Said hydrogel has unique properties since it both exhibits anti-microbial as well as anti-adhesive properties, attributed to the use of the monomers of the inventive copolymer or to the use of the inventive copolymer preparation as well as to the formed hydrogel itself, which exhibits a highly slippery surface for microorganisms.

Parentheses indicate that the inventive copolymer or the inventive copolymer preparation is preferred but not mandatory. Any antimicrobial (co)polymer able to form a hydrogel by photocrosslinking is also understood to be comprised within the term “hydrogel” as claimed.

Thus, in another embodiment of the invention the hydrogel comprising an (inventive) copolymer inclusive of monomer D or an (inventive) copolymer preparation, as well as a substrate attached thereto, said substrate having a surface comprising at least one C—H-bond, preferably said surface consisting of C—H-bonds further comprises water.

Still in another embodiment of the invention the hydrogel comprises an (inventive) copolymer inclusive of monomer D or an (inventive) copolymer preparation, as well as a substrate attached thereto, said substrate having a surface comprising at least one C—H-bond, preferably said surface consisting of C—H-bonds, said C—H-bonds being at least partially converted into carbinols by means of the inventive copolymer or the (inventive) copolymer preparation connected thereto.

Yet another embodiment of the invention provides the hydrogel comprising an (inventive) copolymer inclusive of monomer D or an (inventive) copolymer preparation, as well as a substrate attached thereto, said substrate having a surface comprising at least one C—H-bond, preferably said surface consisting of C—H-bonds, said C—H-bonds being at least partially converted into carbinols by means of the (inventive) copolymer or the (inventive) copolymer preparation connected thereto and further comprising water.

In one embodiment of the hydrogel comprising an (inventive) copolymer inclusive of monomer D, or an (inventive) copolymer preparation, as well as a substrate attached thereto, said substrate having a surface comprising at least one C—H-bond, preferably consisting of C—H-bonds, said substrate being selected from the group consisting of polyvinyls, polyethers, polyesters, polyamides, polyurethanes, polymers of α,β-ethylenically unsaturated mono- and dicarboxylic acids and derivatives thereof, polylactic acid, polyimines, polyolefins, polyethersulfones (PESU), polysulfones (PSU), polyphenylsulfones (PPSU; PPSF), polyetherketones (PEK), polyetheretherketones (PEEK), polyimides, polyetherimides, polyacetals, fluoropolymers, chloropolymers, poly(acrylonitrile), polycarbonates (PC), silicones, natural polymers, mixtures thereof and others.

This is very useful, if one wants to come to a rather cost-effective hydrogel, accepting that the whole substrate is made of a single substance or compound and does not have a coating or laminated structure.

In another embodiment of the hydrogel comprising an (inventive) copolymer inclusive of monomer D, or an (inventive) copolymer preparation, as well as a substrate attached thereto, said substrate having a surface comprising at least one C—H-bond, preferably consisting of C—H-bonds, said aforementioned surface being selected from the group consisting of polyvinyls, polyethers, polyesters, polyamides, polyurethanes, polymers of α,β-ethylenically unsaturated mono- and dicarboxylic acids and derivatives thereof, polylactic acid, polyimines, polyolefins, polyethersulfones (PESU), polysulfones (PSU), polyphenylsulfones (PPSU; PPSF), polyetherketones (PEK), polyetheretherketones (PEEK), polyimides, polyetherimides, polyacetals, fluoropolymers, chloropolymers, poly(acrylonitrile), polycarbonates (PC), silicones, natural polymers, mixtures thereof and others and said surface being attached to the substrate selected from the group consisting of metal, hard plastic, wood, humidity resistant cardboard, or silicones.

Such embodiment is highly adapted to give particular performance characteristics with respect to mechanical stability and partially also for reduced weight.

### Polyvinyls

Polyvinyls are principally all polymers obtained from polymerizing monomers with ethylenically unsaturated C—C double bonds. However, due to their economic importance and huge variety, polyolefins, poly(meth)acrylic acids, poly(meth)acrylates, poly(meth)acrylamides, fluoropolymers, chloropolymers and poly(acrylonitrile), which principally also fall under this definition, are listed separately.

Thus, in the terms of the present invention, polyvinyls are selected form the group consisting of vinylaromatic polymers, vinylheteroaromatic polymers, polyvinyl alcohol (PVA; PVOH), polyvinyl ethers, polyvinyl esters, polyvinyllactams, polyethers, polyesters, polyamides, polyurethanes, polyisocyanates, polyvinylacetals. The latter are the reaction product of polyvinyl alcohol with an aldehyde, for example with formaldehyde (resulting in polyvinylformals (PVFM)) or with butyraldehyde (resulting in polyvinylbutyrals (PVB)).

Polyvinyls are likewise selected from the group consisting of polyolefins, poly(meth)acrylic acids, poly(meth)acrylates, poly(meth)acrylamides, polyimines, polyethersulfones, polysulfones, polyphenylsulfones, polyimides, polyacetals, fluoropolymers, chloropolymers and poly(acrylonitrile), polycarbonates, silicones, natural polymers and other polymers.

### Vinylaromatic Polymers

Vinyl-aromatic monomers used to prepare the vinyl aromatic polymers include styrene, α-methylstyrene, all isomers of vinyltoluene, ethylstyrene, butylstyrene, dimethylstyrene and mixtures thereof. In addition, the vinyl aromatic monomers mentioned above can be copolymerized with other copolymerizable monomers. Examples of these monomers are (meth)acrylic acid, C₁-C₄ alkyl esters of (meth)acrylic acid, such as methyl acrylate, methyl methacrylate, ethyl acrylate, ethyl methacrylate, isopropyl acrylate, butyl acrylate, amides and nitriles of (meth)acrylic acid such as acrylamide, methacrylamide, acrylonitrile, methacrylonitrile, butadiene, ethylene, divinylbenzene, maleic anhydride, phenylmaleinimide and the like. Preferred copolymerizable monomers are acrylonitrile, butadiene, (meth)acrylic acid, (meth)acrylates, maleic anhydride and phenylmaleinimide, in particular acrylonitrile, butadiene, (meth)acrylic acid and (meth)acrylates. Specific examples for vinylaromatic polymers include polystyrene, poly(p-methylstyrene) and poly(α-methylstyrene). Specific examples for vinylaromatic polymers also include copolymers of styrene or α-methylstyrene with dienes or acrylic derivatives, or graft copolymers of styrene or α-methylstyrene such as styrene-acrylonitrile copolymers, α-methylstyrene-acrylonitrile copolymers, styrene-maleicanhydride copolymers, styrene-phenylmaleinimide copolymers, methylmethacrylate-copolymere, styene-methylmethacrylate-acrylonitrile-copolymers, styrene-acrylonitrile-maleic anhydride-copolymers, styrene-acrylonitrile-phenylmaleinimide-copolymers, α-methylstyrene-acrylonitrile-methyl methacrylate-copolymers, α-methylstyrene-acrylonitrile-t-butyl methacrylate-copolymers, styrene-acrylonitrile-t-butyl methacrylate-copolymers, preferably acrylonitrile styrene acrylate copolymers (ASA), acrylonitrile butadiene styrole copolymers (ABS) and styrene acrylonitrile copolymers (SAN).

### Vinylheteroaromatic Polymers

Vinylheteroaromatic polymers are for example polyvinylimidazole (e.g. poly(1-vinylimidazole)) and polyvinylpyridine (e.g. poly(2- or 4-vinylpyridine)) and copolymers thereof with other ethylenically unsaturated comonomers, such as olefins, the above- and below mentioned vinyl monomers, (meth)acrylic acid, derivatives thereof, maleic acid, derivatives thereof etc.

### Polyvinyl Ethers

Polyvinylethers are for example homopolymers of methyl vinyl ether, ethyl vinyl ether, n-propyl vinyl ether, isopropyl vinyl ether, n-butyl vinyl ether, isobutyl vinyl ether, tert-butyl vinyl ether, n-pentyl vinyl ether, n-hexyl vinyl ether, n-heptyl vinyl ether, n-octyl vinyl ether, 1,1,3,3-tetramethyl butyl vinyl ether, ethylhexyl vinyl ether, n-nonyl vinyl ether, n-decyl vinyl ether, n-undecyl vinyl ether, tridecyl vinyl ether, myristyl vinyl ether, pentadecyl vinyl ether, palmityl vinyl ether, heptadecyl vinyl ether, octadecyl vinyl ether, nonadecyl vinyl ether, arrachinyl vinyl ether, behenyl vinyl ether, lignocerenyl vinyl ether, cerotinyl vinyl ether, melissinyl vinyl ether, palmitoleinyl vinyl ether, oleyl vinyl ether, linolyl vinyl ether, linolenyl vinyl ether, stearyl vinyl ether, lauryl vinyl, or copolymers thereof with other ethylenically unsaturated comonomers, such as other vinylethers, olefins, the above- and below mentioned vinyl monomers, (meth)acrylic acid, derivatives thereof, maleic acid, derivatives thereof etc.

### Polyvinyl Esters

Polyvinyl esters are for example polyvinyl acetate (PVAc) as well as its partially or completely hydrolysed form, namely polyvinyl acetate-polyvinyl alcohol or polyvinylalcohol, if used in an non-aqueous environment prior to crosslinking, and copolymers of esters of vinyl alcohol with C₁-C₃₀ monocarboxylic acids, such as vinyl formate, vinyl acetate, vinyl propionate, vinyl butyrate, vinyl laurate, vinyl stearate, vinyl propionate, Versatic acid vinyl esters and the like or mixtures thereof with ethylene or higher olefins and/or (meth)acrylates.

### Polyvinyllactams

Polyvinyllactams are for example poly(N-vinylpyrrolidone) (PVP), poly(N-vinylpiperidone), poly(N-vinylcaprolactam) poly(N-vinyl-5-methyl-2-pyrrolidone), poly(N-vinyl-5-ethyl-2-pyrrolidone), poly(N-vinyl-6-methyl-2-piperidone), poly(N-vinyl-6-ethyl-2-piperidone), poly(N-vinyl-7-methyl-2-caprolactam), poly(N-vinyl-7-ethyl-2-caprolactam) etc. and copolymers thereof with other ethylenically unsaturated comonomers, such as olefins, the above- and below mentioned vinyl monomers, (meth)acrylic acid, derivatives thereof, maleic acid, derivatives thereof etc.

### Polyethers

Polyethers are for example polyethylene glycol (PEG), polypropylene glycol (PPG), mixed EO/PO-polyethers, polytetramethylene glycol (PTMEG; polytetrahydrofuran), mixed polyethers of EO or PO with polyols, such as glycerol, 1,1,1-trimethylolpropane (TMP), aminopolyethylene glycols, pentaerythritol or sorbitol. PEG, PPG and mixed EO/PO polyethers are typically obtained from the corresponding epoxide (ethylene oxide or propylene oxide or mixtures thereof), while polytetramethylene glycol is typically obtained by acid-catalyzed ring-opening reaction of THF.

### Polyesters

Suitable polyesters and copolyesters are described, for example, in EP-A-0678376, EP-A-0 595 413, and U.S. Pat. No. 6,096,854. Polyesters are condensation products of one or more polyols and one or more polycarboxylic acids or the corresponding lactones. In linear polyesters, the polyol is a diol and the polycarboxylic acid a dicarboxylic acid. The diol component may be selected from ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, and 1,3-cyclohexanedimethanol. Also suitable are diols whose alkylene chain is interrupted one or more times by nonadjacent oxygen atoms. These include diethylene glycol, triethylene glycol, dipropylene glycol, tripropylene glycol, and the like. In general the diol comprises 2 to 18 carbon atoms, preferably 2 to 8 carbon atoms. Cycloaliphatic diols can be used in the form of their cis or trans isomers or as an isomer mixture. The acid component may be an aliphatic, alicyclic or aromatic dicarboxylic acid. The acid component of linear polyesters is generally selected from terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, and mixtures thereof. It will be appreciated that the functional derivatives of the acid component can also be employed, such as esters, examples being the methyl esters, or anhydrides or halides, preferably chlorides. Preferred polyesters are polyalkylene terephthalates, and polyalkylene naphthalates, which are obtainable by condensing terephthalic acid or naphthalenedicarboxylic acid, respectively, with an aliphatic diol.

Preferred polyalkylene terephthalates are polyethylene terephthalates (PET), which are obtained by condensing terephthalic acid with diethylene glycol. PET is also obtainable by trans-esterifying dimethyl terephthalate with ethylene glycol, with elimination of methanol, to form bis(2-hydroxyethyl) terephthalate, and subjecting the product to polycondensation, releasing ethylene glycol. Further preferred polyesters are polybutylene terephthalates (PBT), which are obtainable by condensing terephthalic acid with 1,4-butanediol, polyalkylene naphthalates (PAN) such as polyethylene 2,6-naphthalates (PEN), poly-1,4-cyclohexanedimethylene terephthalates (PCT), and also copolyesters of polyethylene terephthalate with cyclohexanedimethanol (PDCT), copolyesters of polybutylene terephthalate with cyclohexanedimethanol. Also preferred are copolymers, transesterification products, and physical mixtures (blends) of the aforementioned polyalkylene terephthalates. Particularly suitable polymers are selected from polycondensates and copolycondensates of terephthalic acid, such as poly- or copolyethylene terephthalate (PET or CoPET or PETG), poly(ethylene 2,6-naphthalate)s (PEN) or PEN/PET copolymers and PEN/PET blends. Said copolymers and blends, depending on their preparation process, may also comprise fractions of transesterification products.

### Polyamides

Polyamides (abbreviated code PA) have as key structural elements amide groups in the main polymer chain. Polyamide polymers are herein to be understood as being homopolymers, copolymers, blends and grafts of synthetic long-chain polyamides having recurring amide groups in the polymer main chain as an essential constituent. Polyamides can be prepared, for example, by polycondensation from diamines and dicarboxylic acids or their derivatives, such as aminocarbonitriles, aminocarboxamides, aminocarboxylate esters or aminocarboxylate salts. Examples of suitable diamines include alkyldiamines such as C₂-C₂₀-alkyldiamines, e.g., hexamethylenediamine, or aromatic diamines, such as C₆-C₂₀-aromatic diamines, e.g., m-, o- or p-phenylenediamine or m-xylenediamine. Suitable dicarboxylic acids comprise aliphatic dicarboxylic acids or their derivatives, chlorides for example, such as C₂-C₂₀-aliphatic dicarboxylic acids, e.g., sebacic acid, decanedicarboxylic acid or adipic acid, or aromatic dicarboxylic acids, examples being C₆-C₂₀-aromatic dicarboxylic acids or their derivatives, chlorides for example, such as 2,6-naphthalenedicarboxylic acid, isophthalic acid or terephthalic acid. Examples of polyamides of this kind are poly-2,4,4-trimethylhexamethyleneterephthalamide or poly-m-phenyleneisophthalamide, PA 66 (nylon-6,6; polyhexamethyleneadipamide), PA 46 (nylon-4,6; polytetramethyleneadipamide), PA 69 (nylon-6,9; polycondensation product of 1,6-hexamethylenediamine and azelaic acid), PA 610 (nylon-6,10; polyhexamethylenesebacamide; polycondensation product of 1,6-hexamethylene diamine and 1,10-decanedioic acid), PA 612 (nylon-6,12; polycondensation product of 1,6-hexamethylenediamine and 1,12-dodecanedioic acid), PA 1010 (nylon 10,10; polycondensation product of 1,10-decamethylenediamine and 1,10-decanedicarboxylic acid), PA 1012 (polycondensation product of 1,10-decamethylenediamine and dodecanedicarboxylic acid) or PA 1212 (polycondensation product of 1,12-dodecamethylenediamine and dodecanedicarboxylic acid); the first number in each case indicating the number of carbon atoms in the diamine and the second number the number of carbon atoms in the dicarboxylic acid. Further examples are PA 6T (polycondensation product of hexamethylenediamine and terephthalic acid) and PA 9T (polycondensation product of nonamethylenediamine and terephthalic acid).

Polyamides are likewise obtainable by polycondensation from amino acids, examples being C₂-C₂₀-amino acids such as 6-aminocaproic acid, 11-aminoundecanoic acid or by ring-opening polymerization from lactams, ε-caprolactam being the most prominent example. Examples of polyamides of this kind are PA 4 (synthesized from 4-aminobutyric acid), PA 6 (nylon-6; polycaprolactam; synthesized from ε-caprolactam or 6-aminohexanoic acid), PA 7 (nylon-7; polyenantholactam or polyheptanoamide), PA 10 (nylon-10, polydecanoamide) PA 11 (nylon-11; polyundecanolactam), PA 12 (nylon-12; polydodecanolactam). In the case of polyamides which, as in this case, are synthesized only from one monomer, the number after the abbreviation PA indicates the number of carbon atoms in the monomer.

Polyamide copolymers may comprise the polyamide building blocks in various ratios. Examples of polyamide copolymers are nylon 6/66 and nylon 66/6 (PA 6/66, PA 66/6, copolyamides made from PA 6 and PA 66 building blocks, i.e. made from caprolactam, hexamethylenediamine and adipic acid). PA 66/6 (90/10) may contain 90% of PA 66 and 10% of PA 6. Further examples are PA 66/610 (nylon-66/610, made from hexamethylenediamine, adipic acid and sebacic acid) and PA 6/66/136 (polycondensation product of caprolactam, hexamethyleneaminadipate and 4,4-diaminodicyclohexylmethanadipate).

Polyamides further include partially aromatic polyamides. The partially aromatic polyamides are usually derived from aromatic dicarboxylic acids such as terephthalic acid or isophthalic acid and a linear or branched aliphatic diamine. Examples are PA 9T (formed from terephthalic acid and nonanediamine), PA 6T/61 (formed from hexamethylenediamine, terephthalic acid and isophthalic acid), PA 6T/6, PA 6T/61/66 and PA 6T/66.

Polyamides further include aromatic polyamides such as poly-meta-phenyleneisophathalamides (Nomex®) or poly-para-phenylene-terephthalamide (Kevlar®).

Polyamides further include copolymers made of polyamides and of a further segment, for example taking the form of a diol, polyester, ether, etc., in particular in the form of polyesteramides, polyetheresteramides or polyetheramides. For example, in polyetheramides, the polyamide segment can be any commercial available polyamide, preferably PA 6 or PA 66 and the polyether is usually polyethylene glycol, polypropylene glycol or polytetramethylene glycol.

Polyamides can if appropriate be prepared with an elastomer as modifier. Examples of suitable copolyamides are block copolymers of the aforementioned polyamides with polyolefins, olefin copolymers, ionomers or chemically bonded or grafted elastomers; or with polyethers, such as with polyethylene glycol, polypropylene glycol or polytetramethylene glycol. Also suitable are EPDM- or ABS-modified polyamides or copolyamides, and polyamides condensed during processing (RIM polyamide systems).

### Polyurethanes

Polyurethanes are generally synthesized from at least one polyisocyanate and at least one compound having at least two groups per molecule that are reactive toward isocyanate groups. Thermoplastic polyurethane is usually produced by reacting (a) organic and/or modified polyisocyanates with (b) at least one relatively high-molar-mass compound having hydrogen atoms reactive toward isocyanate, (c) if appropriate, low-molar-mass chain extenders in the presence of (d) a catalyst and, if desired, (e) one or more further additives.

The polyisocyanates (a) used can be selected from aliphatic, cycloaliphatic, araliphatic and aromatic diisocyanates and mixtures thereof. Preferred polyisocyanates are diisocyanates. Preferred aromatic and araliphatic polyisocyanates are selected from the following individual polyisocyanates: toluylene 2,4-diisocyanate, toluylene 2,6-diisocyanate, mixtures composed of toluylene 2,4- and 2,6-diisocyanate, diphenylmethane 4,4′-diisocyanate, diphenylmethane 2,4′-diisocyanate, diphenylmethane 2,2′-diisocyanate, mixtures composed of diphenylmethane 2,4′- and 4,4′-diisocyanate, urethane-modified liquid diphenylmethane 4,4′- and/or 2,4-diisocyanates, 4,4′-diisocyanato-1,2-diphenylethane, naphthylene 1,5-diisocyanate and mixtures thereof. Suitable aliphatic and cycloaliphatic diisocyanates used are conventional aliphatic and/or cycloaliphatic diisocyanates. Preferably, they are selected from trimethylene diisocyanate, tetramethylene diisocyanate, pentamethylene diisocyanate, hexamethylene diisocyanate, heptamethylene diisocyanate, octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4-diisocyanate, 1-methylcyclohexane 2,6-diisocyanate, dicyclohexylmethane 4,4′-diisocyanate, dicyclohexylmethane 2,4′-diisocyanate, dicyclohexylmethane 2,2′-diisocyanate, tetramethylxylylene diisocyanate (MXDI) and mixtures thereof. MXDI is generally termed an aliphatic diisocyanate because the isocyanate groups are bound to the (aliphatic) CH₂ groups. It is preferable that the polyisocyanate (a) used is selected from hexamethylene 1,6-diisocyanate (hexamethylene diisocyanate, HDI), diphenylmethane 4,4′-, 2,4′-, or 2,2′-diisocyanate (MDI) and mixtures thereof.

Relatively high-molar-mass compounds (b) used having hydrogen atoms reactive toward isocyanates are the well known compounds reactive toward isocyanates, for example polyesterols, polyetherols, and/or polycarbonatediols, which are usually subsumed under the term “polyols”, with molar masses from 500 to 8000, preferably from 600 to 6000, in particular from 800 to less than 3000, and preferably with average functionality toward isocyanates of from 1.8 to 2.3, preferably from 1.9 to 2.2, in particular 2.

Examples are polyether polyols such as those based on well known starter substances and on conventional alkylene oxides, e.g. ethylene oxide, propylene oxide, and/or butylene oxide, preference being given to polyetherols based on propylene 1,2-oxide and ethylene oxide, and in particular polyoxytetramethylene glycols.

Polyesterols can be polyesters based on diacids and on diols. Diols preferably comprise diols having from 2 to 10 carbon atoms, e.g. ethanediol, butanediol, or hexanediol, in particular 1,4-butanediol, or a mixture thereof. Diacids can comprise any of the known diacids, for example linear or branched-chain diacids having from four to 12 carbon atoms, or a mixture thereof. Adipic acid is preferably used as diacid.

Chain extenders (c) used comprise well known aliphatic, araliphatic, aromatic, and/or cycloaliphatic compounds with molar mass of from 50 to 499, preferably difunctional compounds, such as diamines and/or alkanediols having from 2 to 10 carbon atoms in the alkylene radical, in particular 1,3-propanediol, 1,4-butanediol, 1,6-hexanediol, and/or di-, tri-, tetra-, penta-, hexa-, hepta-, octa-, nona-, and/or decaalkylene glycols having from 3 to 8 carbon atoms, and preferably corresponding oligo- and/or polypropylene glycols, and it is also possible here to use a mixture of the chain extenders. The ratio by weight of the relatively high-molar-mass compound (b) having hydrogen atoms reactive toward isocyanates to chain extender (c) can be from 0.5:1 to 20:1, preferably from 1.5:1 to 13:1, and a higher proportion of chain extender here gives a hard product.

Suitable catalysts (d) which in particular accelerate the reaction between the NCO groups of the diisocyanates (a) and the hydroxy groups of the structural components (b) and (c) are the tertiary amines which are conventional and known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane, and the like, and also in particular organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, or the like. The amounts usually used of the catalysts are from 0.0001 to 0.1 part by weight per 100 parts by weight of polyhydroxy compound (b).

Optional additives (e) correspond to those mentioned below and are in particular selected from blowing agents, surfactants, nucleating agents, lubricants and mold-release agents, dyes, pigments, antioxidants, e.g. with respect to hydrolysis, light, heat, or discoloration, metal deactivators, inorganic and/or organic fillers, reinforcing agents, and plasticizers.

Polymers of α,β-ethylenically unsaturated mono- and dicarboxylic acids and derivatives thereof α,β-ethylenically unsaturated monocarboxylic acids are for example acrylic acid, methacrylic acid, ethacrylic acid, crotonic acid and α-chloroacrylic acid. Homopolymers of α,β-ethylenically unsaturated monocarboxylic acids are thus, for example, polyacrylic acid (PAA), polymethacrylic acid (PMAA) and polyethacrylic acid. Copolymers of these acids typically contain one or more of the above- or below-mentioned ethylenically unsaturated comonomers, such as olefins, vinylesters, vinyllactams, α,β-ethylenically unsaturated mono- and dicarboxylic acid esters, α,β-ethylenically unsaturated mono- and dicarboxylic amides, maleic anhydride and the like. α,β-Ethylenically unsaturated dicarboxylic acids are for example maleic acid, fumaric acid, itaconic acid, citraconic acid, mesaconic acid and glutaconic acid. Homopolymers of these dicarboxylic acids are not very common; they are generally used in copolymers. Copolymers of these acids typically contain one or more of the above- or below-mentioned ethylenically unsaturated comonomers, such as olefins, vinylesters, vinyllactams, α,β-ethylenically unsaturated mono- and dicarboxylic acid esters, α,β-ethylenically unsaturated mono- and dicarboxylic amides, maleic anhydride and the like.

The acids of the α,β-ethylenically unsaturated mono- and dicarboxylic acids may be also used in form of their salts, in particular as the sodium, potassium and ammonium salts, and the salts with amines.

Suitable derivatives of α,β-ethylenically unsaturated mono- and dicarboxylic acids are typically their esters, amides and anhydride (especially maleic anhydride).

Examples for esters of α,β-ethylenically unsaturated monocarboxylic acids are methyl (meth)acrylate, methyl ethacrylate, ethyl (meth)acrylate, ethyl ethacrylate, n-propyl (meth)acrylate, isopropyl (meth)acrylate, n-butyl (meth)acrylate, sec-butyl (meth)acrylate, tert-butyl (meth)acrylate, tert-butyl ethacrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachidyl (meth)acrylate, behenyl (meth)acrylate, lignoceryl (meth)acrylate, cerotinyl (meth)acrylate, melissinyl (meth)acrylate, palmitoleyl (meth)acrylate, oleyl (meth)acrylate, linolyl (meth)acrylate, linolenyl (meth)acrylate, stearyl (meth)acrylate, lauryl (meth)acrylate and the like. Thus, homopolymers thereof are polymethyl acrylate, polymethyl methacrylate (PMMA), polymethyl ethacrylate, polyethyl acrylate, polyethyl methacrylate etc. Copolymers of these esters typically contain one or more of the above- or below-mentioned ethylenically unsaturated comonomers, such as olefins, vinylesters, vinyllactams, α,β-ethylenically unsaturated mono- and dicarboxylic acids, α,β-ethylenically unsaturated mono- and dicarboxylic amides, maleic anhydride and the like.

Examples for esters of α,β-ethylenically unsaturated dicarboxylic acids are methylmaleate, dimethylmaleate, ethylmaleate, diethylmaleate, propylmaleate, dipropylmaleate, isopropylmaleate, butylmaleate, dibutylmaleate, methylfumarate, dimethylfumarate, ethylfumarate, diethylfumarate, propylfumarate, dipropylfumarate, isopropylfumarate, diisopropylfumarate, butylfumarate, dibutylfumarate, methylitaconate, dimethylitaconate, ethylitaconate, diethylitaconate, propylitaconate, dipropylitaconate, isopropylitaconate, diisopropylitaconate, butylitaconate, dibutylitaconate and the like. Homopolymers of these dicarboxylic esters are not very common; they are generally used in copolymers. Copolymers of these acids typically contain one or more of the above- or below-mentioned ethylenically unsaturated comonomers, such as olefins, vinylesters, vinyllactams, α,β-ethylenically unsaturated mono- and dicarboxylic acids, α,β-ethylenically unsaturated mono- and dicarboxylic amides, maleic anhydride and the like. Suitable esters of α,β-ethylenically unsaturated mono- and dicarboxylic acids are also esters with amino alcohols, which may be mono- or dialkylated on the amine nitrogen, and where the amino group may be protonized or quaternized (protonization and quaternization generally taking place after polymerization or esterification. Examples of aminoalcohols are C₂-C₁₂-amino alcohols which are C₁-C₈-mono- or -dialkylated on the amine nitrogen. Examples of such esters are N-methylaminoethyl (meth)acrylate, N-ethylaminoethyl (meth)acrylate, N-(n-propyl)aminoethyl (meth)acrylate, N-(tert-butyl)aminoethyl (meth)acrylate, N,N-dimethylaminomethyl (meth)acrylate, N,N-dimethylaminoethyl (meth)acrylate, N,N-diethylaminomethyl (meth)acrylate, N,N-diethylaminoethyl (meth)acrylate, N,N-dimethylaminopropyl (meth)acrylate, N,N-diethylaminopropyl (meth)acrylate and N,N-dimethylaminocyclohexyl (meth)acrylate.

Suitable acids for the protonation are, for example, mineral acids, such as hydrochloric acid, sulfuric acid or phosphoric acid, and carboxylic acids and hydroxycarboxylic acids, such as lactic acid. Suitable quaternizing agents are C₁-C₄-alkyl halides or sulfates, such as ethyl chloride, ethyl bromide, methyl chloride, methyl bromide, dimethyl sulfate and diethyl sulfate.

These esters with aminoalcohols may be used as homopolymers, but more common are their copolymers. Copolymers of these esters typically contain one or more of the above- or below-mentioned ethylenically unsaturated comonomers, such as olefins, vinylesters, vinyllactams, α,β-ethylenically unsaturated mono- and dicarboxylic acids, α,β-ethylenically unsaturated mono- and dicarboxylic esters, α,β-ethylenically unsaturated mono- and dicarboxylic amides, maleic anhydride and the like.

Suitable esters of α,β-ethylenically unsaturated mono- and dicarboxylic acids are also esters with diols. These include 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, etc.

These esters with diols may be used as homopolymers as well as copolymers. Copolymers of these esters typically contain one or more of the above- or below-mentioned ethylenically unsaturated comonomers, such as olefins, vinylesters, vinyllactams, α,β-ethylenically unsaturated mono- and dicarboxylic acids, α,β-ethylenically unsaturated mono- and dicarboxylic esters, α,β-ethylenically unsaturated mono- and dicarboxylic amides, maleic anhydride and the like.

Examples for amides of α,β-ethylenically unsaturated monocarboxylic acids are N-alkyl- and N,N-dialkylamides of α,β-ethylenically unsaturated monocarboxylic acids, such as N-methyl(meth)acrylamide, N-ethyl(meth)acrylamide, N-propyl(meth)acrylamide, N-isopropyl(meth)acrylamide, N-(n-butyl)(meth)acrylamide, N-tert-butyl(meth)acrylamide, n-pentyl(meth)acrylamide, n-hexyl(meth)acrylamide, n-heptyl(meth)acrylamide, N,N-dimethyl(meth)acrylamide, N,N-diethyl(meth)acrylamide, piperidinyl(meth)acrylamide, morpholinyl(meth)acrylamide, n-octyl(meth)acrylamide, 1,1,3,3-tetramethylbutyl(meth)acrylamide, ethylhexyl(meth)acrylamide, n-nonyl(meth)acrylamide, n-decyl(meth)acrylamide, n-undecyl(meth)acrylamide, tridecyl(meth)acrylamide, myristyl(meth)acrylamide, pentadecyl(meth)acrylamide, palmityl(meth)acrylamide, heptadecyl(meth)acrylamide, nonadecyl(meth)acrylamide, arachinyl(meth)acrylamide, behenyl(meth)acrylamide, lignocerenyl(meth)acrylamide, cerotinyl(meth)acrylamide, melissinyl(meth)acrylamide, palmitoleinyl(meth)acrylamide, oleyl(meth)acrylamide, linolyl(meth)acrylamide, linolenyl(meth)acrylamide, stearyl(meth)acrylamide, lauryl(meth)acrylamide, N-methyl-N-(n-octyl)(meth)acrylamide, N,N-di(n-octyl)(meth)acrylamide and mixtures thereof.

Amides of α,β-ethylenically unsaturated mono- and dicarboxylic acids may be also derived from aminoalcohols. These include 2-hydroxyethylacrylamide, 2-hydroxyethylmethacrylamide, 2-hydroxyethylethacrylamide, 2-hydroxypropylacrylamide, 2-hydroxypropylmethacrylamide, 3-hydroxypropylacrylamide, 3-hydroxypropylmethacrylamide, 3-hydroxybutylacrylamide, 3-hydroxybutylmethacrylamide, 4-hydroxybutylacrylamide, 4-hydroxybutylmethacrylamide, 6-hydroxyhexylacrylamide, 6-hydroxyhexylmethacrylamide, 3-hydroxy-2-ethylhexylacrylamide and 3-hydroxy-2-ethylhexylmethacrylamide.

The amides may be used as homopolymers as well as copolymers. Copolymers of these esters typically contain one or more of the above- or below-mentioned ethylenically unsaturated comonomers, such as olefins, vinylesters, vinyllactams, α,β-ethylenically unsaturated mono- and dicarboxylic acids, α,β-ethylenically unsaturated mono- and dicarboxylic esters, α,β-ethylenically unsaturated mono- and dicarboxylic amides, maleic anhydride and the like.

Maleic anhydride is generally used in copolymers, typically in copolymers with one or more of the above- or below-mentioned ethylenically unsaturated comonomers, such as olefins, vinylesters, vinyllactams, α,β-ethylenically unsaturated mono- and dicarboxylic acids, α,β-ethylenically unsaturated mono- and dicarboxylic esters, α,β-ethylenically unsaturated mono- and dicarboxylic amides, and the like, especially with olefins, vinylesters and/or α,β-ethylenically unsaturated mono- and dicarboxylic esters, such as poly(ethylene-maleic anhydride) (PEMA), poly(octadecene-maleic anhydride) (POMA) or ethylene/maleic anhydride/vinylacetate terpolymers.

Polyetherketones (PEK) are polymers having alternating ether and keto groups in their backbone. Most common are polyaryletherketones (PAEK) having between the functional groups 1,4-bound aryl groups.

A specific form is polyetheretherketone (PEEK). This is strictly speaking the formal condensation product of 4,4′-dihydroxybenzophenone and hydroquinone. However, in the terms of the present invention, polyetheretherketones encompass polyaryleneetheretherketones in general, i.e. polymers containing arylene groups which are linked by ether groups and keto groups, with twice as much ether groups as keto groups. Suitable arylene groups are for example phenylene, naphthylene, anthracenediyl and phenanthrenediyl; these may carry one or more substituents, e.g. halogen atoms, OH groups, alkyl groups, e.g. C₁-C₄-alkyl groups, alkoxy groups, e.g. C₁-C₄-alkoxy groups, sulfonic acid or sulfonate groups and the like.

### Polyolefins:

For the purposes of the present invention the term “polyolefin” comprises all polymers composed of olefins without further functionality, such as polyethylene, polypropylene, polybut-1-ene or polyisobutylene, poly-4-methylpent-1-ene, polyisoprene, polybutadiene, polymers of cycloolefins, such as of cyclopentene or norbornene, and also copolymers of monoolefins or diolefins, such as ethylene-propylene copolymers or ethylene-butadiene-copolymers.

### Ethylene Polymers:

Suitable polyethylene (PE) homopolymers, classed according to density, are for example:
PE-ULD (ULD=ultralow density), PE-VLD (VLD=very low density); copolymers and terpolymers of ethylene with up to 10% octene, 4-methylpent-1-ene, and occasionally propylene; density between 0.91 and 0.88 g/cm³; barely crystalline, transparent
PE-LD (LD=low density), obtainable, for example, by the high-pressure process (ICI) at 1000 to 3000 bar and 150 to 300° C. with oxygen or peroxides as catalysts in autoclaves or tube reactors. Highly branched with branches of different length, crystallinity 40 to 50%, density 0.915 to 0.935 g/cm³, average molar mass up to 600 000 g/mol.
PE-LLD (LLD=linear low density), obtainable with metal complex catalysts in the low-pressure process from the gas phase, from a solution (e.g., benzine), in a suspension or with a modified high-pressure process. Slight branching with side chains which are themselves unbranched, molar masses higher than for PE-LD.
PE-MD (MD=middle density); the density between 0.93 and 0.94 g/cm³; can be prepared by mixing PE-LD and PE-HD or directly as a copolymeric PE-LLD.
PE-HD (HD=high density), obtainable by the medium-pressure (Phillips) and low-pressure (Ziegler) processes. By Phillips at 30 to 40 bar, 85 to 180° C., chromium oxide catalyst, molar masses about 50 000 g/mol. By Ziegler at 1 to 50 bar, 20 to 150° C., titanium halides, titanium esters or aluminum alkyls as catalysts, molar mass about 200 000 to 400 000 g/mol. Execution in suspension, solution, gas phase or bulk. Very slight branching, crystallinity 60% to 80%, density 0.942 to 0.965 g/cm³.
PE-HD-HMW (HMW=high molecular weight), obtainable by Ziegler, Phillips or gas-phase method. High density and high molar mass.
PE-HD-UHMW (UHMW=ultra high molecular weight) obtainable with modified Ziegler catalyst, molar mass 3 000 000 to 6 000 000 g/mol.

Suitable ethylene copolymers are all commercial ethylene copolymers, examples being Luflexen® grades (LyondellBasell), Nordel® and Engage® (The Dow Chemical Company). Examples of suitable comonomers include α-olefins having 3 to 10 carbon atoms, especially propylene, but-1-ene, hex-1-ene, 4-methylpent-1-ene, hept-1-ene and oct-1-ene, and also alkyl acrylates and methacrylates having 1 to 20 carbon atoms in the alkyl radical, especially butyl acrylate. Further suitable comonomers are dienes such as butadiene, isoprene, and octadiene, for example. Further suitable comonomers are cycloolefins, such as cyclopentene, norbornene, and dicyclopentadiene.

The ethylene copolymers are typically random copolymers or block or impact copolymers. Suitable block or impact copolymers of ethylene and comonomers are, for example, polymers for which in the first stage a homopolymer of the comonomer or a random copolymer of the comonomer is prepared, containing up to 15% by weight of ethylene, and then in the second stage a comonomer-ethylene copolymer with ethylene contents of 15% to 80% by weight is polymerized on. Ordinarily, sufficient of the comonomer-ethylene copolymer is polymerized on for the copolymer produced in the second stage to have a fraction of 3% to 60% by weight in the end product.

### Propylene Polymers:

Polypropylene should be understood below to refer both to homopolymers and to copolymers of propylene. Copolymers of propylene comprise minor amounts of monomers copolymerizable with propylene, examples being C₂-C₈-alk-1-enes such as ethylene, but-1-ene, isobutene, pent-1-ene or hex-1-ene, among others, and dienes, such as butadiene. It is also possible to use two or more different comonomers.

Suitable polypropylenes include homopolymers of propylene or copolymers of propylene with up to 50% by weight of copolymerized other alk-1-enes having up to 8 C atoms. The copolymers of propylene are in this case random copolymers or block or impact copolymers. Where the copolymers of propylene are of random construction they generally comprise up to 15% by weight, preferably up to 6% by weight, of other alk-1-enes having up to 8 C atoms, especially ethylene, but-1-ene or a mixture of ethylene and but-1-ene.

### Other Polyolefins

Other suitable polyolefins are homopolymers of higher alkenes or dienes, such as but-1-ene, isobutylene, 4-methyl-1-pentene, butadiene or isoprene, and copolymers thereof, such as isobutylene/isoprene copolymers.

### Other Olefin Copolymers

The polyolefin may also be selected from copolymers of mono-olefins or diolefins with vinyl monomers and mixtures thereof. These include, for example, ethylene/alkyl acrylate copolymers, ethylene/alkyl methacrylate copolymers, ethylene/vinyl acetate copolymers, and copolymers thereof with carbon monoxide, or ethylene/acrylic acid copolymers and their salts (ionomers).

### Polyimines

Polyimines are especially polyethyleneimines. Polyethyleneimine (PEI) or polyaziridine is a polymer with repeating unit composed of the amine group and a CH₂CH₂ spacer. Linear polyethyleneimines contain all secondary amines, in contrast to branched PEIs which contain primary, secondary and tertiary amino groups.

### Polyethersulfones

Strictly speaking, polyethersulfone (PESU or PES) is poly(oxy-1,4-phenylsulfonyl-1,4-phenyl). However, in the terms of the present invention, polyethersulfones encompass polyarylenethersulfones in general, i.e. polymers containing arylene groups which are at least partly linked by ether groups and sulfonyl groups. Suitable arylene groups are for example phenylene, naphthylene, anthracenediyl and phenanthrenediyl; these may carry one or more substituents, e.g. halogen atoms, OH groups, alkyl groups, e.g. C₁-C₄-alkyl groups, alkoxy groups, e.g. C₁-C₄-alkoxy groups, sulfonic acid or sulfonate groups and the like. Apart from the mandatory O and SO₂ linking groups, the arylene groups may be linked by single bonds (in which case the polyethersulfones could also be termed polyphenylsulfones), S, S═O, C═O, —N═N— and/or —CR^{a}R^{b}— linking groups, where R^{a} and R^{b} are independently of each other hydrogen, C₁-C₁₂-alkyl, C₁-C₁₂-alkoxy- or C₆-C₁₈-aryl (—CR^{a}R^{b}— being especially —CH₂—, —C(CH₃)₂— (in which case the polyethersulfones could also be termed polysulfones) or —C(CF₃)₂—).

### Polysulfones

Strictly speaking, polysulfone (PSU) is obtained by polycondensation of bisphenol A and 4,4′-dichlorodiphenylsulfone. However, in the terms of the present invention, polysulfones encompass polyarylensulfones in general, i.e. polymers containing arylene groups which are at least partly linked by ether groups, sulfonyl groups and propan-2,2-diyl (—C(CH₃)₂—) groups. Suitable arylene groups are for example phenylene, naphthylene, anthracenediyl and phenanthrenediyl; these may carry one or more substituents, e.g. halogen atoms, OH groups, alkyl groups, e.g.

C₁-C₄-alkyl groups, alkoxy groups, e.g. C₁-C₄-alkoxy groups, sulfonic acid or sulfonate groups and the like. Apart from the mandatory O, SO₂ and propan-2,2-diyl (—C(CH₃)₂—) linking groups, the arylene groups may be linked by single bonds (in which case the polysulfones could also be termed polyphenylsulfones), S, S═O, C═O, —N═N— and/or —CR^{a}R^{b}— linking groups, where R^{a} and R^{b} are independently of each other hydrogen, C₁-C₁₂-alkyl, fluorinated C₁-C₁₂-alkyl, C₁-C₁₂-alkoxy or C₆-C₁₈-aryl (—CR^{a}R^{b}— being especially —CH₂— or —C(CF₃)₂—).

### Polyphenylsulfones

Strictly speaking, polyphenylsulfone (PPSU or PPSF) is obtained by polycondensation of biphenyl-4-4′-diol and 4,4′-dichlorodiphenylsulfone. However, in the terms of the present invention, polyphenylsulfones encompass in general polymers containing arylene and biarylene groups which are at least partly linked by ether groups and sulfonyl. Suitable arylene groups are for example phenylene, naphthylene, anthracenediyl and phenanthrenediyl; these may carry one or more substituents, e.g. halogen atoms, OH groups, alkyl groups, e.g. C₁-C₄-alkyl groups, alkoxy groups, e.g. C₁-C₄-alkoxy groups, sulfonic acid or sulfonate groups and the like. Suitable biarylene groups are for example biphenylene and binaphthylene; these may carry one or more substituents, e.g. halogen atoms, OH groups, alkyl groups, e.g. C₁-C₄-alkyl groups, alkoxy groups, e.g. C₁-C₄-alkoxy groups, sulfonic acid or sulfonate groups and the like. Apart from the mandatory O, SO₂ and single bond linking groups, the arylene groups may be linked by S, S═O, C═O, —N═N— and/or —CR^{a}R^{b}— linking groups, where R^{a} and R^{b} are independently of each other hydrogen, C₁-C₁₂-alkyl, fluorinated C₁-C₁₂-alkyl, C₁-C₁₂-alkoxy or C₆-C₁₈-aryl (—CR^{a}R^{b}— being especially —CH₂—, —C(CH₃)₂— (in which case the polyphenylsulfones could also be termed polysulfones) or —C(CF₃)₂—).

### Polyimides

Polyimides (PI) are characterized by imide groups in the backbone. They are usually obtained by reaction between a dianhydride, e.g. pyromellitic dianhydride or naphthalene tetracarboxylic dianhydride, and a diamine or, less common, a diisocyanate to form polyamic acid, abbreviated as PAA, and then react into polyimide under high temperature, imidization and dehydration. Examples are polybismaleinimide (PBMI), polyimidesulfone (PISO) and polymethacrylimide (PMI).

Polyimides containing ether groups in the backbone are called polyetherimides (PEI).

### Polyacetals

Polyacetals comprise both homopolymers as well as copolymers of polyacetals with cyclic ethers, and polyacetals modified with thermoplastic polyurethanes, acrylates or methyl acrylate/butadiene/styrene copolymers. Polyacetals are produced by the polymerization of aldehydes or of cyclic acetals. One industrially significant polyacetal is polyoxymethylene (POM), which is obtainable through cationic or anionic polymerization of formaldehyde or trioxane, respectively. Modified POM is obtained, for example, by copolymerization with cyclic ethers such as ethylene oxide or 1,3-dioxolane. Combination of POM with thermoplastic polyurethane elastomers produces POM-based polymer blends. Unreinforced POM is notable for very high stiffness, strength, and toughness. POM is used preferably for constructing household appliances and for constructing apparatus, vehicles, and machinery, and in sanitary and installation engineering.

### Fluoropolymers

Fluoropolymers are for example fluorinated ethylene propylene polymers (FEP), poly(vinyl fluoride) and poly(vinylidene fluoride).

### Chloropolymers

Chloropolymers are for example poly(vinylidene chloride) and poly(vinyl chloride).

### Polycarbonates

Polycarbonates are prepared, for example, through condensation of phosgene or carbonic esters such as diphenyl carbonate or dimethyl carbonate with dihydroxy compounds. Suitable dihydroxy compounds are aliphatic or aromatic dihydroxy compounds. As aromatic dihydroxy compounds mention may be made for example of bisphenols such as 2,2-bis(4-hydroxyphenyl)propane (bisphenol A), tetraalkylbisphenol A, 4,4-(meta-phenylenediisopropyl)diphenol (bisphenol M), 4,4-(para-phenylenediisopropyl)diphenol, 1,1-bis(4-hydroxyphenyl)-3,3,5-trimethylcyclohexane (BP-TMC), 2,2-bis(4-hydroxyphenyl)-2-phenylethane, 1,1-bis(4-hydroxyphenyl)cyclohexane (bisphenol Z), and also, if appropriate, mixtures thereof. The polycarbonates may be branched by using small amounts of branching agents. Suitable branching agents include phloroglucinol, 4,6-dimethyl-2,4,6-tri(4-hydroxyphenyl)hept-2-ene, 4,6-dimethyl-2,4,6-tri(4-hydroxyphenyl)heptane; 1,3,5-tri(4-hydroxyphenyl)benzene; 1,1,1-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane, 2,2-bis[4,4-bis(4-hydroxyphenyl)cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenylisopropyl)phenyl)ortho-terephthalic esters; tetra(4-hydroxyphenyl)methane; tetra(4-(4-hydroxyphenylisopropyl)phenoxy)methane; α,α′,α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole, 1,4-bis(4′,4″-dihydroxytriphenyl)methyl)benzene, and, in particular, 1,1,1-tri(4-hydroxyphenyl)ethane and bis(3-methyl-4-hydroxyphenyl)-2-oxo-2,3-dihydroindole. Examples of compounds suitable for chain termination include phenols such as phenol, alkylphenols such as cresol and 4-tert-butylphenol, chlorophenol, bromophenol, cumylphenol, or mixtures thereof. The fraction of chain terminators is generally 1 to 20 mol %, per mole of dihydroxy compound.

### Silicones

Silicones are more precisely called polymerized siloxanes or polysiloxanes. They are mixed inorganic-organic polymers with the chemical formula [R₂SiO]ₙ, where R is an organic group such as methyl, ethyl, or phenyl. These materials consist of an inorganic silicon-oxygen backbone ( . . . —Si—O—Si—O—Si—O— . . . ) with organic side groups attached to the silicon atoms, which are four-coordinate. In some cases, organic side groups are used to link two or more of these —Si—O— backbones together. By varying the —Si—O— chain lengths, side groups, and crosslinking, silicones can be synthesized with a wide variety of properties and compositions. They can vary in consistency from liquid to gel to rubber to hard plastic.

### Natural Polymers

Natural polymers are for example oligo- and polysaccharides, polypeptides (especially proteins), lipids and nucleic acids and crosslinked polyisoprenes also referred to as rubber. Polysaccharides are long carbohydrate molecules of monosaccharide units, such as glucose, fructose, or glyceraldehyde, joined together by glycosidic bonds. They range in structure from linear to highly branched. Oligosaccharides are shorter-chained than polysaccharides, the distinction between the two terms not being strict. Some examples for this large class are disaccharides, amylose, glycogen, starch, hemicellulose, cellulose, chitin, amylopectin, pectin, callose, laminarin, chrysolaminarin, xylan, arabinoxylan, mannan, fucoidan, galactomannan, xanthan gum, dextran, dextran sulfate, chitosan, welan gum, gellan gum, diutan gum, pullulan, heparin, hyaluronic acid, alginic acid, to name just a few. In the present invention the term “oligo- and polysaccharides” also encompasses synthetic derivatives of the natural polymers, such as hydroxymethyl cellulose, hydroxyethyl cellulose, hydroxyl propyl cellulose, carboxymethyl cellulose, nitrocellulose, cellulose acetate, or cellulose butyrate.

A polypeptide is a single linear polymer chain of amino acids bonded together by peptide bonds between the carboxyl and amino groups of adjacent amino acid residues.

A protein results from one or more polypeptide chains not only characterized by their primary structure (i.e. the specific sequence of amino acids), but also by the secondary, tertiary and also quaternary structure. A few examples of this large class of polymers are antibodies, antithrombotic agents, albumin, attachment proteins/peptides, collagen, enzymes, extracellular matrix proteins/peptides, growth factors, hirudin and thrombolytic proteins.

Lipids constitute a group of naturally occurring molecules that include fats, waxes, sterols, fatsoluble vitamins (such as vitamins A, D, E, and K), monoglycerides, diglycerides, triglycerides, phospholipids, and others. Examples are fatty acids, such as isobutyric acid (2-methylpropanoic acid), butyric acid, isovaleric acid (3-methylbutanoic acid), valeric acid, caprylic acid, capric acid, lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid and docosahexaenoic acid, the mono-, di- and triglycerides thereof, phospholipids, prostaglandins and leukotrienes.

Nucleic acids are for example DNA, RNA, nucleosides and nucleotides.

### Other Polymers

Other polymers are, for example, polyvinyllactams, especially poly(N-vinylpyrrolidone) (PVP) and copolymers of N-vinylpyrrolidone with rather hydrophilic comonomers, such as (meth)acrylic acid, especially in form of its salts, (meth)acrylic acid esters, especially with aminoalcohols, especially if the amino groups are quaternized, and (meth)acrylamides, especially with ammonia or monoamines with short alkyl or hydroxyalkyl substituents; poly(meth)acrylic acids, especially in partly or completely neutralized form (i.e. at least partially in form of the salt), polyethers especially polyethylene glycol (PEG) and also mixed EO/PO-polyethers if based on at least 50% by weight of EO, polylactic acid, polyethyleneimine, poly(ethyloxazoline), poly(propyloxazoline), poly(butyloxazoline), poly(ethylimidazole), poly(propylimidazole), poly(butylimidazole), poly(ethylimidazolium), poly(propylimidazolium), poly(butylimidazolium), the latter three being neutralized with various counteranions, such as chloride, sulfate, acetate etc., oligo- and polysaccharides, proteins and nucleic acids.

In a further elaborated embodiment the inventive hydrogel comprises an (inventive) copolymer inclusive of monomer D, or an (inventive) copolymer preparation, as well as a substrate attached thereto, said substrate having a surface comprising at least one C—H-bond, preferably consisting of C—H-bonds, said substrate being selected from the group consisting of the listing under “Plastics, pp. 462-464, in Concise Encyclopedia of Polymer Science and Engineering, Kroschwitz, ed., John Wiley and Sons, 1990, the entire disclosure of which is incorporated herein by reference.

Yet another embodiment of the invention discloses a hydrogel comprising an (inventive) copolymer inclusive of monomer D, or an (inventive) copolymer preparation, as well as a substrate attached thereto, said substrate having a surface comprising at least one C—H-bond, preferably consisting of C—H-bonds, said aforementioned surface being selected from the group consisting of the listing under “Plastics, pp. 462-464, in Concise Encyclopedia of Polymer Science and Engineering, Kroschwitz, ed., John Wiley and Sons, 1990, the entire disclosure of which is incorporated herein by reference and said surface being attached to the substrate selected from the group consisting of metal, hard plastic, wood, humidity resistant cardboard, or silicones.

In still another embodiment of the inventive hydrogel comprising an (inventive) copolymer inclusive of monomer D, or an (inventive) copolymer preparation, as well as a substrate attached thereto, said substrate having a surface comprising at least one C—H-bond, preferably consisting of C—H-bonds, said substrate being selected from the group consisting of noble metals like titanium, gold, silver, palladium, platinum, highly oxidation resistive steel, all of which being coated with a film or foil comprising, preferably consisting of C—H-bonds.

Still a further advanced embodiment of the hydrogel comprises an (inventive) copolymer inclusive of monomer D, or an (inventive) copolymer preparation, as well as a substrate attached thereto, said substrate having a surface comprising at least one C—H-bond, preferably consisting of C—H-bonds, said substrate being selected from the group consisting of polyvinyls, polyethers, polyesters, polyamides, polyurethanes, polymers of α,β-ethylenically unsaturated mono- and dicarboxylic acids and derivatives thereof, polylactic acid, polyimines, polyolefins, polyethersulfones (PESU), polysulfones (PSU), polyphenylsulfones (PPSU; PPSF), polyetherketones (PEK), polyetheretherketones (PEEK), polyimides, polyetherimides, polyacetals, fluoropolymers, chloropolymers, poly(acrylonitrile), polycarbonates (PC), silicones, natural polymers, noble metals like titanium, gold, silver, palladium, platinum, as well as highly oxidation resistive steel mixtures thereof.

A highly advanced embodiment of the inventive hydrogel comprises an (inventive) copolymer inclusive of monomer D, or an (inventive) copolymer preparation, as well as a substrate attached thereto, said substrate having a surface comprising at least one C—H-bond, preferably consisting of C—H-bonds, said substrate being selected from the group consisting of noble metals like titanium, gold, silver, palladium, platinum, highly oxidation resistive steel, coated with a film or foil comprising, preferably consisting of C—H-bonds and said film or foil being selected from the group of polymers consisting of polyvinyls, polyethers, polyesters, polyamides, polyurethanes, polymers of α,β-ethylenically unsaturated mono- and dicarboxylic acids and derivatives thereof, polylactic acid, polyimines, polyolefins, polyethersulfones (PESU), polysulfones (PSU), polyphenylsulfones (PPSU; PPSF), polyetherketones (PEK), polyetheretherketones (PEEK), polyimides, polyetherimides, polyacetals, fluoropolymers, chloropolymers, poly(acrylonitrile), polycarbonates (PC), silicones, natural polymers and mixtures thereof.

Such hydrogels likewise can be realized in a very thin manner and are able to be readily connected or sealed to further devices for instance chirugical tools, probes, catheters for the bladder emptying or intracardiac catheters, stents and any embodiment which is suited for intercorporal use. Such hydrogels can also directly be generated onto the devices serving as a type of substrate.

Thus a further embodiment of the invention is a hydrogel comprising an (inventive) copolymer inclusive of monomer D, or an (inventive) copolymer preparation, as well as a substrate attached thereto, said substrate having a surface comprising at least one C—H-bond, preferably said surface consisting of C—H-bonds and said substrate being selected from the group comprising, preferably consisting of chirugical tools, probes, catheters for the bladder emptying or intracardiac catheters, stents as well as any embodiment which is suited for intercorporal use or belongs to the group of medical articles, said articles being specified below.

The hydrogel of the invention in yet another embodiment comprises the copolymer according to claim 13 or the copolymer preparation according to claim 14, and water. It maintains itself without being connected to the substrate.

Said hydrogel is obtained by bringing the copolymer inclusive of monomer D, or the (inventive) copolymer preparation, or a mixture of the components of the copolymer inclusive of monomer D, or of the copolymer preparation into contact with water. Bringing into contact is to be carried out by any suitable means, such as immersing, dipping, pouring, coating, spraying and the like. Water can be used in less than equivalent amounts, in equivalent amounts, or in excess.

Preferably, water is used in an amount of at least 20% by weight, more preferably at least 50% by weight, in particular at least 80% by weight, based on the amount of crosslinked polymer used Protection is also sought for a process of making an inventive hydrogel, wherein the copolymer inclusive of monomer D, or the (inventive) copolymer preparation, or a mixture of the components of the copolymer inclusive of monomer D, or of the copolymer preparation is applied to the substrate or to the surface thereof, solvents or solvent residues, if remaining, are removed, the copolymer, or the copolymer preparation, or the mixture of the components of the copolymer or of the copolymer preparation respectively is subjected to UV-light, non-crosslinked copolymers or the non-crosslinked copolymer preparation or non-crosslinked distinct compounds thereof are removed by extraction and the hydrogel obtained is hydrated by subjecting it to ambient conditions or by soaking it in an aqueous medium.

Said process provides a rather simple and cost-effective way to obtain hydrogels, which are to exhibit both anti-microbial and anti-adhesive properties.

“non-crosslinked” within this application is understood to comprise entities having C—H-bonds into which no insertion event by means of a photocrosslinker D or E of the invention took place.

“extraction” means applying a solvent of a distinct polarity into which “non-crosslinked” entities dissolve, whereas crosslinked entities do not, to the (inventive) copolymer inclusive of monomer D, or to the (inventive) copolymer preparation respectively after UV-irradiation, incubating and shaking and removing the solvent.

“ambient conditions” is understood to be room temperature and humidity as found on average in middle Europe.

In one embodiment of the process of making the inventive hydrogel, the copolymer inclusive of monomer D, or the copolymer preparation, or a mixture of the components of the copolymer inclusive of monomer D, or of the copolymer preparation is applied to the substrate by means of at least one technique selected from the group comprising, preferably consisting of dip-coating, dispersing, spray-coating, application in solution, knife-coating, roller-coating; solvents or solvent residues, if remaining, are removed, the copolymer, or the copolymer preparation, or the mixture of the components of the copolymer or of the copolymer preparation respectively is subjected to UV-light, non-crosslinked copolymers or the non-crosslinked copolymer preparation or non-crosslinked distinct compounds thereof are removed by extraction and the hydrogel obtained is hydrated by subjecting it to ambient conditions or by soaking it in an aqueous medium.

“Dip-coating” means immersing the substrate or the surface into a solution of the (inventive) copolymer or into a solution of the (inventive) copolymer preparation and removing it therefrom. This yields rather homogeneous copolymer/copolymer preparation films or surfaces and thus after UV-photoirradiation a highly crosslinked copolymer film or surface. Highly crosslinked is to be understood, that crosslinking between copolymer or copolymer preparation per se as well as between copolymer or copolymer preparation and substrate or surface is highly pronounced.

Similar results are obtained when preparing a dispersion of the copolymer (of the invention) inclusive of monomer D, or of the copolymer preparation and applying said dispersion to the substrate or to the surface. Said technique is rather used for more hydrophobic copolymers or copolymer preparations (of the invention).

“Spray coating” is understood to apply the copolymer (of the invention) inclusive of monomer D or the copolymer preparation as a drizzle or mist of fine droplets to the substrate or to the surface. This yields films or foils on the substrate/surface having a very low thickness.

“application in solution” is understood to apply the dissolved copolymer inclusive of monomer D (of the invention) or the copolymer preparation (of the invention) onto the substrate or surface by means of a brush or a roller immersed in said copolymer solution or copolymer preparation solution.

“knife-coating” finally is understood to apply the copolymer (of the invention) inclusive of monomer D or the copolymer preparation in form of a powder or paste onto a blade of a knife and to slowly move the thus charged knife over the substrate or the surface to realize a layer of (inventive) copolymer or (inventive) copolymer preparation thereon.

Protection is also sought for a process of making a hydrogel. It comprises the steps applying the copolymer (of the invention) inclusive of monomer D, or the copolymer preparation (of the invention) or a mixture of the components of the (inventive) copolymer inclusive of monomer D, or a mixture of the components of the copolymer preparation, to the substrate or to the surface thereof; removing solvents or solvent residues, if remaining; subjecting the copolymer or the copolymer preparation or the mixture of the components of the copolymer or of the copolymer preparation respectively to UV-light; removing by extraction non-crosslinked copolymers or copolymer preparation or non-crosslinked distinct compounds thereof; and hydrating the hydrogel obtained by subjecting it to ambient conditions or by soaking it in an aqueous/alcoholic medium. Such hydrogels likewise provide the antimicrobial and anti-adhesive properties and are suited for being mounted on tools in particular onto medical devices or surgical apparatus.

This inventive process yields hydrogels having a rather homogenous distribution of copolymers of the invention onto the substrate's surface, however said hydrogel being thin. In order to obtain a somewhat ticker hydrogel, one has to refer to another embodiment of the inventive process.

This process of making an inventive hydrogel comprises the steps of applying the copolymer (of the invention) inclusive of monomer D, or the copolymer preparation (of the invention) or a mixture of the components of the (inventive) copolymer inclusive of monomer D, or a mixture of the components of the copolymer preparation, to the substrate or to the surface thereof; removing solvents or solvent residues, if remaining; subjecting the copolymer or the copolymer preparation or the mixture of the components of the copolymer or of the copolymer preparation respectively to UV-light; removing by extraction non-crosslinked copolymers or copolymer preparation or non-crosslinked distinct compounds thereof; applying a second time the copolymer (of the invention) inclusive of monomer D, or the copolymer preparation (of the invention) or a mixture of the components of the (inventive) copolymer inclusive of monomer D, or a mixture of the components of the copolymer preparation, to the substrate or to the surface thereof; removing solvents or solvent residues, if remaining; subjecting the copolymer or the copolymer preparation or the mixture of the components of the copolymer or of the copolymer preparation respectively to UV-light preferably of a distinct wavelength; removing by extraction non-crosslinked copolymers or copolymer preparation or non-crosslinked distinct compounds thereof; and hydrating the hydrogel obtained by subjecting it to ambient conditions or by soaking it in an aqueous medium.

Yet another embodiment of the inventive process repeats φ times steps a. to d. thereof, with φ being an integer selected from 2 to 20, prior to hydrating the hydrogel obtained by subjecting it to ambient conditions or by soaking it in an aqueous medium.

In doing so, one obtains somewhat thicker hydrogels on a substrate, which might be necessary for stability purposes or a longer lasting lifetime of the hydrogel.

This previous embodiment of the inventive process is even advanced such that it repeats φ times steps a. to d. thereof, with φ being an integer selected from 2 to 20, and subjects in each step c or each second step c the copolymer or the copolymer preparation or the mixture of the components of the copolymer or of the copolymer preparation respectively to UV-light having a different wavelength with respect to previous step c., prior to hydrating the hydrogel obtained by subjecting it to ambient conditions or by soaking it in an aqueous medium.

This embodiment provides the opportunity to realize different photocrosslinking events at different stages by simply using different monomers D or photocrosslinkers E or different (inventive) copolymers or copolymer preparations at each time φ, the steps a. through d. are realized.

Still further protection is sought for a copolymer (of the invention), or an (inventive) copolymer preparation or an inventive hydrogel for use in a therapeutic process for removing and/or killing and/or preventing adhesion of microorganisms. Said embodiment is also construed to be understood as a method for using a copolymer of the invention, or a copolymer preparation of the invention or an inventive hydrogel in a therapeutic process for removing and/or killing and/or preventing adhesion of microorganisms.

Still further protection is sought for a copolymer (of the invention), or an (inventive) copolymer preparation or an inventive hydrogel for use in a therapeutic process for removing and/or killing and/or preventing adhesion of microorganisms, said microorganisms being selected from the group consisting of the genera staphylococcus, eschericha and proteus and preferably of the species staphylococcus aureus, eschericha coli and proteus mirabilis.

This means in a further elaborated embodiment a copolymer, or a copolymer preparation or a hydrogel for use in a therapeutic process for removing and/or killing and/or preventing adhesion of microorganisms on medical articles. Said embodiment is also construed to be understood as a method for using a copolymer of the invention, or a copolymer preparation of the invention or an inventive hydrogel in a therapeutic process for removing and/or killing and/or preventing adhesion of microorganisms on medical articles.

Such medical articles are selected from the group consisting of catheters, urinary catheters, vascular catheters of the peripheral type, central vascular catheters, single lumen central venous catheters, multiple lumen central venous catheters, peripherally inserted central venous catheters, emergency infusion catheters, percutaneous sheath introducer systems, thermodilution catheters, including the hubs and ports of such vascular catheters, wound drainage tubes, arterial grafts, soft tissue patches, shunts, stents, tracheal catheters, guide wires, protetic devices, heart valves, LVAD's, leads to electronic devices such as pacemakers, defibrillators, artificial hearts, and implanted biosensors, wound dressings, sutures, gloves.

In order to extend protection in particular to pathogenic entities another embodiment covers an (inventive) copolymer or an (inventive) copolymer preparation or a hydrogel of the invention for therapeutic use against pathogenic microorganisms. This embodiment is also construed to be understood as a method of employing a copolymer or a copolymer preparation or a hydrogel for therapeutic use against pathogenic microorganisms.

A more advanced embodiment thereof seeks for protection for an (inventive) copolymer or an (inventive) copolymer preparation or a hydrogel of the invention for therapeutic use against pathogenic microorganisms, said microorgansims being selected from the group consisting of the genera staphylococcus, eschericha and proteus and preferably of the species staphylococcus aureus, eschericha coli and proteus mirabilis.

Said microorganisms are in general inoffensive commensals. However, some strains are highly aggressive and can often be found in hospital environments. Once proliferating in the human body, they can easily lead to a sepsis and are the origin of letality especially for weakend hospitalized individuals. However, by using instruments subjected with the inventive copolymers, copolymer preparations or hydrogels, colonization or film formation of said microorganisms can be largely reduced as will be shown below.

Yet another embodiment of the invention discloses the non-therapeutic use of the inventive copolymer or of the inventive copolymer preparation or of the hydrogel of the invention as antimicrobial and/or anti-adhesive means. This embodiment is also construed to be understood as a method of using in a non-therapeutic fashion the copolymer of the invention or the inventive copolymer preparation or the hydrogel of the invention as antimicrobial and/or anti-adhesive means

Non-therapeutic use is understood to mean each use, which is not to serve therapeutic or medical purposes.

In particular non-therapeutic use means the use of the inventive copolymer or of the inventive copolymer preparation or of the hydrogel of the invention as antimicrobial and/or anti-adhesive means on surfaces of microscope slides and chips for biomolecule immobilization.

The invention will now be further detailed by means of examples:

### EXAMPLE 1

General procedure for preparing of an inventive copolymer comprising monomers A, B and optionally monomer C, viz. reaction of polymerization of N-vinylpyrrolidone (NVP) with dimethylaminoethylmethacrylate quaternized with lauryliodide (Q7).

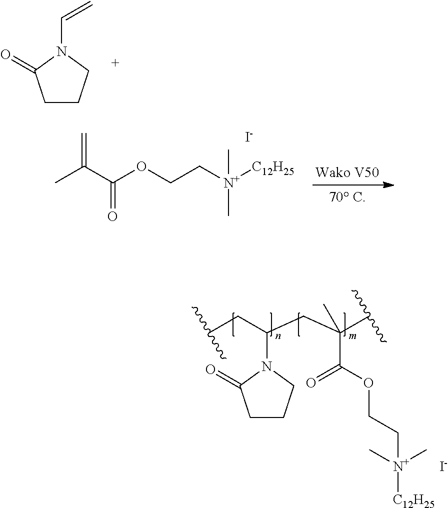

Monomers with corresponding weight percentages were prepared in respective dosage bottles: Dosage 1: NVP and Dosage 2: Q7 in acetone (20 g). The various monomer solutions were purged with nitrogen gas for 15 min prior to the reaction.

Deionized water (60 g) was added into a 250-mL reactor flask and the pH was adjusted to 7-8 with ammonium hydroxide solution. The set up was then purged with nitrogen gas for 15 min. The polymerization initiator Wako V50 (solution 0.1 mL, 5 wt % in deionized water) was added into the reaction flask and the inner temperature of reaction set up was then increased to 70° C. under N₂ environment. Dosing of monomers started once the inner temperature hit 60° C. and it was carried out over 3 h.

Wako V50 solution (0.15 mL, 5 wt % in deionized water) was added 1, 2 and 3 h after the start of reaction each time. Once the addition of monomers ended, the reaction was left to stir at 70° C. for another 1.5 h. Upon cooling, the viscous polymer solution was diluted with deionized water accordingly and was precipitated in acetone to remove unreacted monomers to obtain a yellow solid with 90-92% yield.

### EXAMPLE 2

Preparing of an inventive copolymer comprising monomers A and 25 w % of monomer B, viz. reaction of polymerization of N-vinylpyrrolidone (NVP) with 25 w % of dimethylaminoethylmethacrylate quaternized with lauryliodide (Q7).

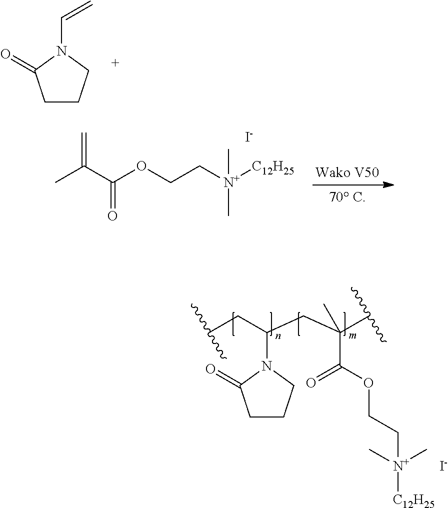

Monomers were prepared separately in two separate dosage bottles.—Dosage 1: NVP (22.5 g, 75 wt %) and Dosage 2: Q7 (7.5 g, 25 wt %) in acetone (20 g). They were purged with nitrogen gas for 15 min prior to the reaction.

Deionized water (60 g) was added into a 250-mL reactor flask and the pH was adjusted to 7-8 with ammonium hydroxide solution. The set up was then purged with nitrogen gas for 15 min. Wako V50 solution (0.1 mL, 5 wt % in deionized water) was added into the reaction flask and the inner temperature of reaction set up was then increased to 70° C. under N₂ environment. Dosing of monomers started once the inner temperature hit 60° C. and it was carried out over 3 h.

Wako V50 solution (0.15 mL, 5 wt % in deionized water) was added 1, 2 and 3 h after the start of reaction each time. Once the addition of monomers ended, the reaction was left to stir at 70° C. for another 1.5 h. Upon cooling, the viscous polymer solution was diluted with deionized water accordingly and was precipitated in acetone to remove unreacted monomer(s) to obtain a yellow solid with 90-92% yield.

Like these copolymers several others were synthesized as given in the table I below. Based on compound Q7 on examples 1 and 2, the length of the terminal N-alkyl chain, the type of counter ion and the type of ethylenically unsaturated moiety (methacrylate, acrylate, vinyl) were changed in examples 3 through 17 (Q1-Q15).

TABLE I

| | Q1 | Q2 | Q3 | Q4 | Q5 | Q6 | Q7 | Q8 | Q9 | Q10 | Q11 | Q12 | Q13 | Q14 | Q15 |
|---|---|---|---|---|---|---|---|---|---|---|---|---|---|---|---|
| N | 1 | 1 | 1 | 1 | 1 | 8 | 12 | 8 | 3 | 10 | 22 | 8 | 12 | 12 | 8 |
| Ion | Cl⁻ | Cl⁻ | Cl⁻ | MeSO₄⁻ | Cl⁻ | Br⁻ | I⁻ | I⁻ | I⁻ | I⁻ | I⁻ | I⁻ | I⁻ | Br⁻ | Cl⁻ |
| EUM | MA | AC | VN | VN | DA | MA | MA | MA | MA | MA | MA | VN | VN | MA | MA |

“N” denotes for the length of the terminal N-alkyl chain of monomer B, which e.g. is 12 for Q7, wich is to say consists of 12 carbon atoms.
“Ion” gives the counter ion of monomer B
“EUM” is the ethylenically unsaturated moiety of monomer B, which is selected from acrylate (AC), methacrylate (MA), vinyl (VN) and diallyl (DA) stemming from DADMAC (diallyldime-thylammonium chloride).

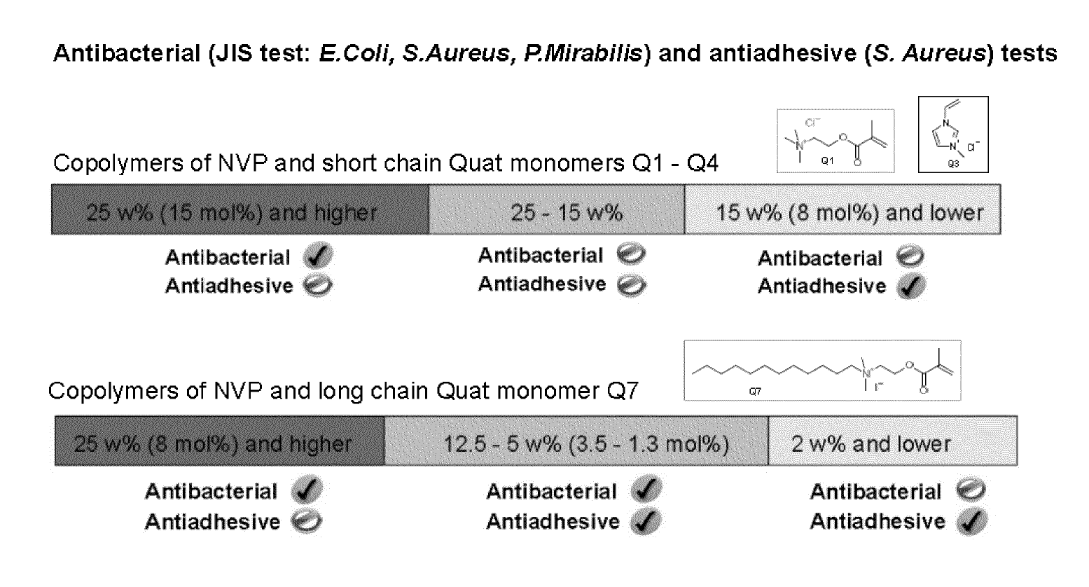

Also the concentration of the respective monomer B (Q1 through Q15) was assessed to influence on the behavior of the copolymer obtained to simultaneously act as ant-adhesive and as antimicrobial means (cf. FIG. 1).

Most striking effects with respect to simultaneously acting as antimicrobial as well as anti-adhesive agent were determined for the N alkyl chain length of the inventive copolymer as can be seen from FIG. 1. The percentage values given are those for the amount of monomer B used.

One realizes that for simultaneously observing the copolymer synthesized to act as an anti-adhesive as well as an antimicrobial agent, monomer B is to be used within a range of 2 to 25 w % and gives particular good results for concentration values ranging from 5 to 12.5 w %. It is further required to have the cationic and/or cationogenic moiety thereof bearing at least one terminal N-alkyl chain comprising from 6 to 22 carbon atoms. This particularly holds, if the copolymer formed is completely in a cationic form.

### EXAMPLE 18

Testing of antimicrobial activity is realized by means of the JIS-test according to ISO 22196 and translated and published by Japanese Standards Association under JIS Z 2801: 2000 Antimicrobial products-Test for antimicrobial activity and efficacy. ICS 07.100.10; 11.100, Reference number: JIS Z 2801: 2000 (E), the contents of which is fully incorporated by reference into this specification. A synthesized copolymer is considered to expose an antimicrobial behavior when the amount of bacteria experiences a reduction of >log 3 according to the test indicated supra after being exposed to the inventive copolymer.

### EXAMPLE 19

### Anti-Adhesive Properties are Tested as Follows

A culture medium of tryptic soy broth was prepared. A washing medium of 0.85 w % saline was prepared. 10 ml of tryptic soy broth were inoculated with eschericha coli bacteria, staphylococcus aureus bacteria and proteus mirabilis becteria respectively and incubated at 35° C. to 37° C. for 16 to 24 hours under shaking conditions. The respective over night culture was diluted in 5% tryptic soy broth and adjusted to a OD₆₀₀ of approximately 1. A live/dead fluorescent stain comprising a 1:1 ratio of Syto9 and propidium iodine was added to the diluted over night culture such that a final concentration of 1.5 μl Syto9+1.5 μl propidium iodine per ml of culture was obtained. Microscopic slides of 75 mm×25 mm were coated with a solution of the inventive copolymer and dried (sample). An uncoated slide was used as control. Each sample was prepared in triple. Samples were placed in a handmade bacterial adhesion titer plate of several wells with one sample per well. Each well was exposed to 1 ml of the stained over night culture indicated supra. The titer plate was incubated for 1 hour at 37° C. and thereafter washed 10 times with 1 ml of 0.85 w % sterile saline. Samples were than visualized on an inverted fluorescent microscope and compared with an uncoated slide exposed to the stained over night culture as well as to a coated slide not being exposed. Zeiss cell counting software was used to generate quantitative data. Copolymers were considered to have an anti-adhesive property if the reduction of the amount of adhered bacteria compared to the reference was >99%.

### EXAMPLE 20

General procedure for preparing of an inventive copolymer comprising monomers A, B, optionally monomer C, and monomer D, viz. reaction of polymerization of N-vinylpyrrolidone (NVP) with dimethylaminoethylmethacrylate quaternized with lauryliodide (Q7) and the compound P13 as monomer D.

In particular synthesis of PVP-based polymers with 2 wt % PI3 and 12.5 wt % Q7

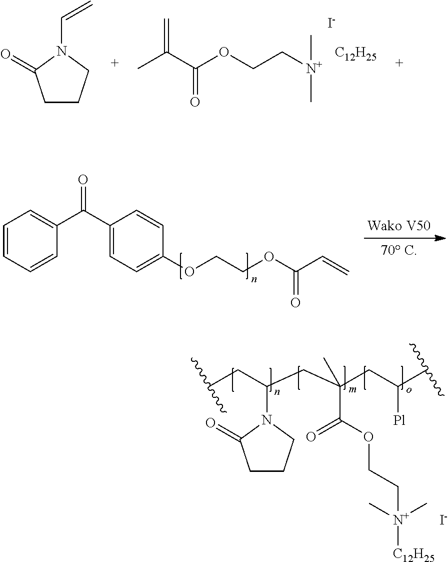

PI is the photocrosslinker comprising benzophenone, which was not sketched in the product for purpose of clarity. n in PI3 denotes for 10.

The various dosage mixtures of various monomer weight percentages were prepared. Dosage 1: NVP (25.65 g) and PI3 (0.6 g, 2 wt %) and Dosage 2: Q7 (3.75 g, 12.5 wt %) in acetone (20 g) respectively. They were purged with nitrogen gas for 15 min prior to the reaction.

Deionized water (60 g) was added into a 250-mL reactor flask and the pH was adjusted to 7-8 with ammonium hydroxide solution. The set up was then purged with nitrogen gas for 15 min. Wako V50 solution (0.1 mL, 5 wt % in deionized water) was added into the reaction flask and the inner temperature of reaction set up was then increased to 70° C. under N₂ environment. Dosage of monomers started once the inner temperature hit 60° C. and it was carried out over 3 h.

Wako V50 solution (0.15 mL, 5 wt % in deionized water) was added 1, 2 and 3 h after the start of reaction each time. Once the addition of monomers was completed, the reaction was left to stir at 70° C. for another 1.5 h. Upon cooling, the viscous polymer solution was diluted with deionized water accordingly and was precipitated in acetone to remove unreacted monomer(s) to obtain a yellow solid with 91% yield.

### EXAMPLE 21

General procedure for preparing of an inventive copolymer comprising monomers A, B, optionally monomer C, and monomer D, viz. reaction of polymerization of N-vinylpyrrolidone (NVP) with dimethylaminoethylmethacrylate quaternized with octyliodide (Q8) and the compound PI3 as monomer D

In particular synthesis of PVP-based polymers with 2 wt % PI3 and 12.5 w % Q8

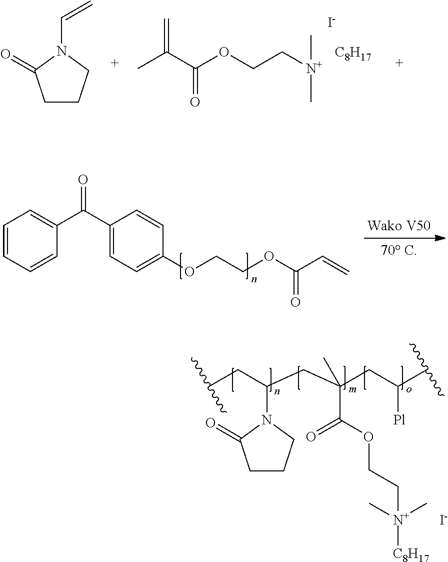

PI is the photocrosslinker comprising benzophenone, which was not sketched in the product for purpose of clarity. n in PI3 denotes for 10.

The respective dosage mixtures of various monomer weight percentages were prepared: Dosage 1: NVP and PI3 and Dosage 2: Q8 in acetone or water (20 g). They were purged with nitrogen gas for 15 min prior to the reaction.

Deionized water (60 g) was added into a 250-mL reactor flask and the pH was adjusted to 7-8 with ammonium hydroxide solution. The set up was then purged with nitrogen gas for 15 min. Wako V50 solution (0.1 ml, 5 wt % in deionized water) was added into the reaction flask and the inner temperature of reaction set up was then increased to 70° C. under N₂ environment. Dosage of monomers started once the inner temperature hit 60° C. and it was carried out over 3 h.

Wako V50 solution (0.15 ml, 5 wt % in deionized water) was added 1, 2 and 3 h after the start of reaction each time. Once the addition of monomers was completed, the reaction was left to stir at 70° C. for another 1.5 h. Upon cooling, the viscous polymer solution was diluted with deionized water accordingly and was precipitated in acetone to remove unreacted monomer(s) to obtain a yellow solid with 90-92% yield.

### EXAMPLE 22

### Synthesis of a Non-Polymerizable Photocrosslinker E

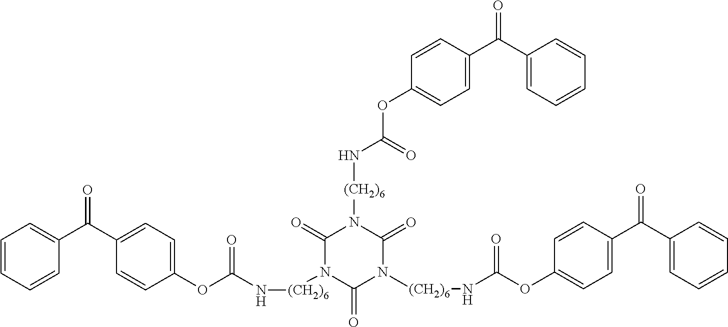

470 parts by weight of 4-Hydroxybenzophenone and 400 parts by weight of Basonat® HI100 (BASF, an isocyanurated hexamethylene diisocyanate) were mixed and heated to 60° C. 0.1 parts by weight of dibutyl tin dilaurate (DBTL) were added and the mixture was heated to 85° C. for 6 hours. Then the mixture was heated to 105° C. for 4 hours. The NCO content after reaction was below 0.3%.

### EXAMPLE 23

### Synthesis of Another Non-Polymerizable Photocrosslinker E

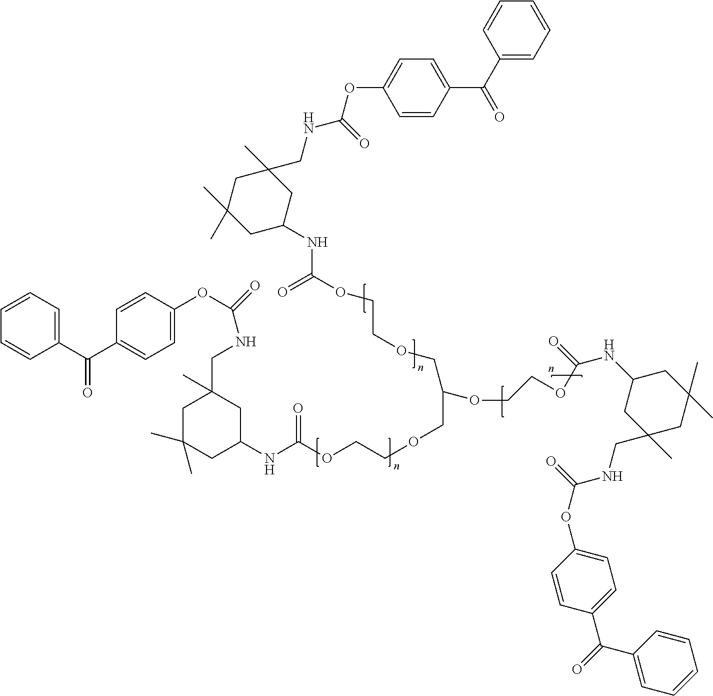

with n in average being 7

223 parts by weight of glycerol ethoxylate (Aldrich, average Mₙ ˜1,000) was mixed with 0.05 parts by weight of dibutyl tin dilaurate (DBTL) at room temperature. 150 parts by weight of Iso-phorondiisocyanat (IPDI) was added within 10 min. Then the mixture was heated to 105° C. for 90 min. The NCO content was 6.9%. Then, 134 parts by weight of 4-hydroxybenzophenone were added and the mixture was heated for another 6 hours to 105° C. The NCO content was below 0.5%.

### EXAMPLE 24

### Hydrogel Preparation, Pretreatment of Substrates

Poly(dimethyl siloxane) (PDMS) is commercially known as silicone. Experiments were conducted using flat silicone substrates. Silicone slabs (Elastosil® R401/70) were sourced from Wacker As obtained, Elastosil® was already cured with an agent called C6, which is 1.2 wt % of 45% paste of 2,5-bis-(t-butylperoxy)-2,5-dimethyl hexane in silicone rubber. Additionally, Pt-cured medical grade silicone sheeting was used. The silicone slabs were cut to 5 cm×6 cm sizes, and a hole was made on the top center of each substrate using a regular office punch. The primer 3-methacryloxypropyl trimethoxysilane (98%, abbr. TMPSM) was obtained from ABCR.

The general procedure for the substrate pre-treatment will be referred to as ‘silanization’ henceforth. The silanization parameters were altered to identify the most optimal procedure for the best adhesion of the coating. However, the general steps in the silanization procedure included plasma treatment, immersion of substrates in TMPSM solution, methanol rinse, drying on hot plate and vacuum oven, toluene wash, drying on hot plate and vacuum oven. The conditions used for plasma surface treatment chamber (Diener Electronic) were 50% airflow rate and 26 W power with an exposure time of 5 min. The silanization bath consisted of 0.1 M TMPSM solution in toluene, heated to 700° C. using a water bath. Eight 5 cm×6 cm substrates were suspended by cotton threads, in 1 I TMPSM solution. The substrates were rinsed with methanol (three times, followed by purging with N₂) after they were removed from the TMPSM solution. This was followed by drying on a hot plate at 1200° C. to remove the solvents and curing in vacuum oven at X° C. (X=50, 100 or 1500° C.). Once the substrates cooled down to room temperature, they were washed in toluene (2 substrates in 100 mL toluene). The substrates were dried on hot plate at 1200° C. and then at 500° C. in a vacuum oven.

### EXAMPLE 25

### Hydrogel Preparation, Reacting of Pretreated Substrate with Copolymer

The silanized flat substrates were coated only on one side for ease of handling. For spin-coating (Laurell Technologies spin-coater), 5-10 wt % copolymer solutions of the examples 20 or 21 or or 21 together with the non-polymerizable photocrosslinkers of examples 22, 23 were used.

Sufficient amounts of the polymer solution (about 4 mL) was spread on the substrate, incubated for 30 s and spun at 750 rpm for 30 s. However, most of the substrates were dip-coated. An adhesive tape was pasted on the backside of the substrate to make sure only one side was coated. A semi-automatic dip-coater was used (MTI CorporationDesktop model) with manual immersion and a withdrawal speed of 140 mm/min or 0.23 cm/s. Substrates were dip-coated from 110 ml of 8-12 wt % copolymer solution in a 125 mL beaker. Coated substrates were dried on hot plate at 80° C. for 20 min, and in oven at 50° C. for 1 h. This was followed by UV-curing for 10 min in a Honlé UVASpot UV chamber. Non-crosslinked copolymers were removed by soaking the hydrogel in aqueous or aqueous/alcoholic solution.

The hydrogels formed were assayed for antimicrobial and anti-adhesive properties by means of the procedures given in examples 18 and 19.

One realizes that important inventive embodiments are a copolymer exhibiting both antimicrobial and anti-adhesive properties as well as a hydrogel. Said hydrogel is obtained from the inventive copolymer and a substrate. Another part of the invention is a process for making the hydrogel, as well as different uses of the inventive copolymer as well as of the hydrogel.

1.-19. (canceled)

20. A copolymer with antimicrobial properties comprising
a) 60 to 98 w % of at least one water-soluble monomer selected from the group consisting of cyclic N-vinyl amides, N-vinyl imidazoles, (meth)acrylic esters containing CH₂—CH₂—O— and/or CH₂—CH—(CH₃)—O— units, and hydroxy(meth)acrylates as monomer A;
b) at least one compound comprising a radically polymerizable α,β-ethylenically unsaturated double bond and at least one cationic and/or cationogenic moiety as monomer B,
with the cationic and/or cationogenic moiety thereof bearing at least one terminal N-alkyl chain comprising from 6 to 22 carbon atoms and
said monomer B being used in an amount ranging from 2 w % to 25 w %;
c) optionally at least one monoethylenically unsaturated compound as monomer C;
the sum of monomers A to C not exceeding 100 w %, with the proviso that
the weight ratio of monomer A to monomer B is at least 3, and
said copolymer being free of any compound comprising a radically polymerizable α.β-ethylenically unsaturated double bond and at least one cationogenic moiety, said cationogenic moiety bearing only terminal N-alkyl chains comprising less than 3 carbon atoms.

21. The copolymer according to claim 20, wherein it is entirely cationized.

22. The copolymer according to claim 20, wherein monomer A is N-vinyl-2-pyrrolidone and/or N-vinyl caprolactam.

23. The copolymer according to claim 20, wherein monomer B is entirely in a cationized form.

24. The copolymer according to claim 20, wherein monomer B comprises a counter ion, said counter ion being selected from the group consisting of iodide, bromide, chloride, hydrogensulfate, methyl sulfate and ethyl sulfate.

25. The copolymer according to claim 20, wherein monomer B is a derivative of (meth)acrylic acid.

26. The copolymer according to claim 20, wherein said at least one cationic and/or cationogenic moiety of monomer B is an acyclic one.

27. The copolymer according to claim 20, wherein said at least one terminal N-alkyl chain of monomer B is a linear entity.

28. The copolymer according to claim 20, wherein monomer B is used in an amount ranging from more than 2 to 25 w %.

29. The copolymer according to claim 20, wherein the weight ratio of monomer A to monomer B is at least 7.

30. The copolymer according to claim 20, wherein the copolymer is free of any compound comprising a radically polymerizable α.β-ethylenically unsaturated double bond and at least one cationogenic moiety, said cationogenic moiety bearing only terminal N-alkyl chains comprising less than 4 carbon atoms.

31. The copolymer according to claim 20, w herein the copolymer is free of any compound comprising a radically polymerizable α.β-ethylenically unsaturated double bond and at least one cationic moiety, said cationic moiety bearing only terminal N-alkyl chains comprising less than 3 carbon atoms.

32. The copolymer according to claim 20, comprising
i. monomer A,
ii. monomer B,
iii. at least one polymerizable photocrosslinker as monomer D
iv. optionally at least one monomer C.

33. A copolymer preparation comprising
A. the copolymer according to claim 20, comprising
i. monomer A,
ii. monomer B,
iii. optionally monomer C,
iv. optionally monomer D and
B. at least one non-polymerizable photocrosslinker E.

34. A hydrogel comprising the copolymer according to claim 32, as well as a substrate attached thereto, said substrate having a surface comprising at least one C—H-bond.

35. A process of making the hydrogel according to claim 34, comprising
a. applying the copolymer to the substrate or to the surface thereof,
b. removing solvents or solvent residues, if remaining,
c. subjecting the copolymer to UV-light,
d. removing non-crosslinked copolymers by extraction and
e. hydrating the hydrogel obtained by subjecting it to ambient conditions or by soaking it in an aqueous medium.

36. The copolymer according to claim 20 for use in a therapeutic process for removing and/or killing and/or preventing adhesion of microorganisms.

37. The copolymer according to claim 20 for therapeutic use against pathogenic microorganisms.

38. An antimicrobial or anti-adhesive comprising the copolymer according to claim 20.

39. The copolymer according to claim 20, wherein the copolymer is entirely quaternized.
